(19) United States
(12) Patent Application Publication
(10) Pub. No.: US 2020/0233166 A1
(43) Pub. Date: Jul. 23, 2020

(54) ACTIVE OPTICAL CABLE, METHOD OF CONTROLLING ACTIVE OPTICAL CABLE, AND METHOD OF WIRING ACTIVE OPTICAL CABLE

(71) Applicant: FUJIKURA LTD., Tokyo (JP)

(72) Inventors: Hiroki Shimizu, Chiba (JP); Shinya Abe, Chiba (JP)

(73) Assignee: FUJIKURA LTD., Tokyo (JP)

(21) Appl. No.: 16/617,946

(22) PCT Filed: May 29, 2018
(86) PCT No.: PCT/JP2018/020612

§ 371 Date: Nov. 27, 2019

(30) Foreign Application Priority Data
May 29, 2017 (JP) 2017-105695

(51) Int. Cl. G02B 6/44; H04B 10/80; H04B 10/073

(52) U.S. Cl. CPC G02B 6/4416; H04B 10/073; H04B 10/808

(57) ABSTRACT

An active optical cable includes: a first connector; a second connector; an optical fiber cord that connects the first connector to the second connector; and a power supply line that connects the first connector to the second connector power. The first connector includes a control circuit that carries out a fault test for the optical fiber cord when the first connector or the second connector is in an unconnected state at a time point of commencement of supply of power to the first connector and the second connector.

### TECHNICAL FIELD

The present invention relates to an active optical cable. The present invention also relates to a method of controlling an active optical cable. The present invention also relates to a method of wiring for an active optical cable.

### BACKGROUND

Active optical cables (AOC) are widely used as an alternative to metal cables. An active optical cable is a cable which has connectors at both ends, the connectors each having a light emitting element and a light receiving element. A data signal which is inputted in the form of an electric signal into a first connector is transmitted in the form of an optical signal to a second connector and then outputted in the form of an electric signal from the second connector.

When wiring is being carried out with use of an active optical cable, the active optical cable may be, for example, inserted and passed through piping, and incorporated in a device. In such cases, stresses are applied to the active optical cable due to, for example, bending and lateral pressure. As a result, there may be a break in the optical fiber cord in rare cases. There are also cases in which an initial fault occurs in a light emitting element or light receiving element included in the active optical cable.

Patent Literature 1 discloses an active optical cable which connects a head-mounted display to a controller. The active optical cable carries out fault diagnostics periodically or non-periodically (for example, immediately after the display is powered on). The existence or absence of a fault is determined by transmitting data having a fixed pattern and then determining whether data having the fixed pattern is received.

### PATENT LITERATURE

[Patent Literature 1]

Japanese Patent Application Publication Tokukai No. 2016-167794 (Publication Date: Sep. 15, 2016)

In the active optical cable of Patent Literature 1, the fault diagnostics are carried out after a first connector and a second connector have been connected to their respective devices, i.e., after wiring has been completed. As such, in a case where it is determined that there has been a fault such as a break, time and effort is required to remove the cable. In order to actually complete the removal of the cable, both the first connector and the second connector must be disconnected from their respective devices. In a case where, for example, the active optical cable is used to connect servers on different racks in a data center, the time and effort for removing the active optical cable in this manner can lead to a great decrease in work efficiency.

Furthermore, in the active optical cable of Patent Literature 1, the fault diagnostics are carried out after a first connector and a second connector have been connected to a device, i.e., when there is a possibility that an optical fiber cord will be used for communications. As such, it is necessary to provide to the first connector and the second connector a component for multiplexing the optical signal for fault diagnostics (the fixed pattern data) into an optical signal for communications. This increases the complexity of the structure of the first connector and the second connector.

### SUMMARY

One or more embodiments of the present invention provide an active optical cable which (i) in comparison to conventional art, requires less time and effort to remove in a case where a fault such as a break has been found and (ii) does not require complexification of the structure for connectors such as in conventional art.

An active optical cable in accordance with one or more embodiments of the present invention includes: a first connector; a second connector; an optical fiber cord which connects the first connector to the second connector, the optical fiber cord being for communication; and a power supply line which connects the first connector to the second connector, the power supply line being for supplying power, the first connector including a control circuit configured to carry out a fault test in a case where the first connector or the second connector is in an unconnected state at a time point of commencement of supply of power to the first connector and the second connector.

A control method in accordance with one or more embodiments of the present invention is a method of controlling an active optical cable including (i) a first connector, (ii) a second connector, (iii) an optical fiber cord which connects the first connector to the second connector, the optical fiber cord being for communication, and (iv) a power supply line which connects the first connector to the second connector, the power supply line being for supplying power, the method including: a control step in which the first connector carries out a fault test in a case where the first connector or the second connector is in an unconnected state at a time point of commencement of supply of power to the first connector and the second connector.

One or more embodiments of the present invention provide an active optical cable which (i) in comparison to conventional art, requires less time and effort to remove in a case where a fault such as a break has been found and (ii) in comparison to conventional art, has a simpler configuration in that the active optical cable obviates the need for a configuration for multiplexing an optical signal for fault diagnostics into an optical signal for communication.

### BRIEF DESCRIPTION OF DRAWINGS

FIG. 1 is a block diagram illustrating a configuration of an active optical cable in accordance with one or more embodiments of the present invention.

FIG. 2 is a block diagram illustrating an internal structure of a first connector of the active optical cable illustrated in FIG. 1.

FIG. 3 is a block diagram illustrating an internal structure of a second connector of the active optical cable illustrated in FIG. 1.

FIG. 4 is a flowchart indicating operations of the first connector illustrated in FIG. 2 during a fault test.

FIG. 5 is a flowchart indicating operations of the second connector illustrated in FIG. 3 during a fault test.

FIG. 6 is a block diagram illustrating a variation of the first connector illustrated in FIG. 2.

FIG. 7 is a block diagram illustrating a variation of the active optical cable illustrated in FIG. 1.

FIG. 8 is a block diagram illustrating another variation of the first connector illustrated in FIG. 2.

FIG. 9 is a flowchart indicating operations of the first connector of the variation illustrated in FIG. 6 or FIG. 8 during a fault test.

FIG. 10 is a block diagram illustrating a configuration of an active optical cable in accordance with one or more embodiments of the present invention.

FIG. 11 is a block diagram illustrating an internal structure of a first connector of the active optical cable illustrated in FIG. 10.

FIG. 12 is a block diagram illustrating an internal structure of a second connector of the active optical cable illustrated in FIG. 10.

FIG. 13 is a flowchart indicating operations of the first connector illustrated in FIG. 11 during a fault test.

FIG. 14 is a flowchart indicating operations of the second connector illustrated in FIG. 12 during a fault test.

FIG. 15 is a block diagram illustrating a variation of the first connector illustrated in FIG. 11.

FIG. 16 is a block diagram illustrating a variation of the active optical cable illustrated in FIG. 10.

FIG. 17 is a block diagram illustrating another variation of the first connector illustrated in FIG. 11.

FIG. 18 is a flowchart indicating operations of the first connector of the variation illustrated in FIG. 15 or FIG. 17 during a fault test.

FIG. 19 is a block diagram illustrating a configuration of an active optical cable in accordance with one or more embodiments of the present invention.

FIG. 20 is a block diagram illustrating an internal structure of a first connector of the active optical cable illustrated in FIG. 19.

FIG. 21 is a block diagram illustrating an internal structure of a second connector of the active optical cable illustrated in FIG. 19.

FIG. 22 is a flowchart indicating operations of the first connector illustrated in FIG. 20 during a fault test.

FIG. 23 is a flowchart indicating operations of the second connector illustrated in FIG. 21 during a fault test.

FIG. 24 is a block diagram illustrating a configuration of an active optical cable system in accordance with one or more embodiments of the present invention.

FIG. 25 is a flowchart indicating a wiring method for the active optical cable system illustrated in FIG. 24.

FIG. 26 is a block diagram illustrating a variation of the second connector illustrated in FIG. 3.

FIG. 27 is a block diagram illustrating a configuration of an active optical cable in accordance with one or more embodiments of the present invention.

FIG. 28 is a block diagram illustrating an internal structure of a first connector of the active optical cable illustrated in FIG. 27.

FIG. 29 is a block diagram illustrating an internal structure of a second connector of the active optical cable illustrated in FIG. 27.

FIG. 30 is a flowchart indicating operations of the first connector illustrated in FIG. 28 during a fault test.

FIG. 31 is a flowchart indicating operations of the second connector illustrated in FIG. 29 during a fault test.

FIG. 32 is a block diagram illustrating a configuration of an active optical cable in accordance with one or more embodiments of the present invention.

FIG. 33 is a block diagram illustrating an internal structure of a first connector of the active optical cable illustrated in FIG. 32.

FIG. 34 is a block diagram illustrating an internal structure of a second connector of the active optical cable illustrated in FIG. 32.

FIG. 35 is a flowchart indicating operations of the first connector illustrated in FIG. 33 during a fault test.

FIG. 36 is a flowchart indicating operations of the second connector illustrated in FIG. 34 during a fault test.

FIG. 37 is a block diagram illustrating a configuration of an active optical cable in accordance with one or more embodiments of the present invention.

FIG. 38 is a block diagram illustrating an internal structure of a first connector of the active optical cable illustrated in FIG. 37.

FIG. 39 is a block diagram illustrating an internal structure of a second connector of the active optical cable illustrated in FIG. 37.

FIG. 40 is a flowchart indicating operations of the first connector illustrated in FIG. 38 during a fault test.

FIG. 41 is a flowchart indicating operations of the second connector illustrated in FIG. 39 during a fault test.

FIG. 42 is a block diagram illustrating a configuration of an active optical cable in accordance with one or more embodiments.

FIG. 43 is a block diagram illustrating an internal structure of a first connector of the active optical cable illustrated in FIG. 42.

FIG. 44 is a block diagram illustrating an internal structure of a second connector of the active optical cable illustrated in FIG. 42.

FIG. 45 is a flowchart indicating operations of the first connector illustrated in FIG. 43 during a fault test.

FIG. 46 is a flowchart indicating operations of the second connector illustrated in FIG. 44 during a fault test.

FIG. 47 is a block diagram illustrating a configuration of an active optical cable in accordance with one or more embodiments.

FIG. 48 is a block diagram illustrating an internal structure of a first connector of the active optical cable illustrated in FIG. 47.

FIG. 49 is a block diagram illustrating an internal structure of a second connector of the active optical cable illustrated in FIG. 47.

FIG. 50 is a flowchart indicating operations of the first connector illustrated in FIG. 48 during a fault test.

FIG. 51 is a flowchart indicating operations of the second connector illustrated in FIG. 49 during a fault test.

### DETAILED DESCRIPTION

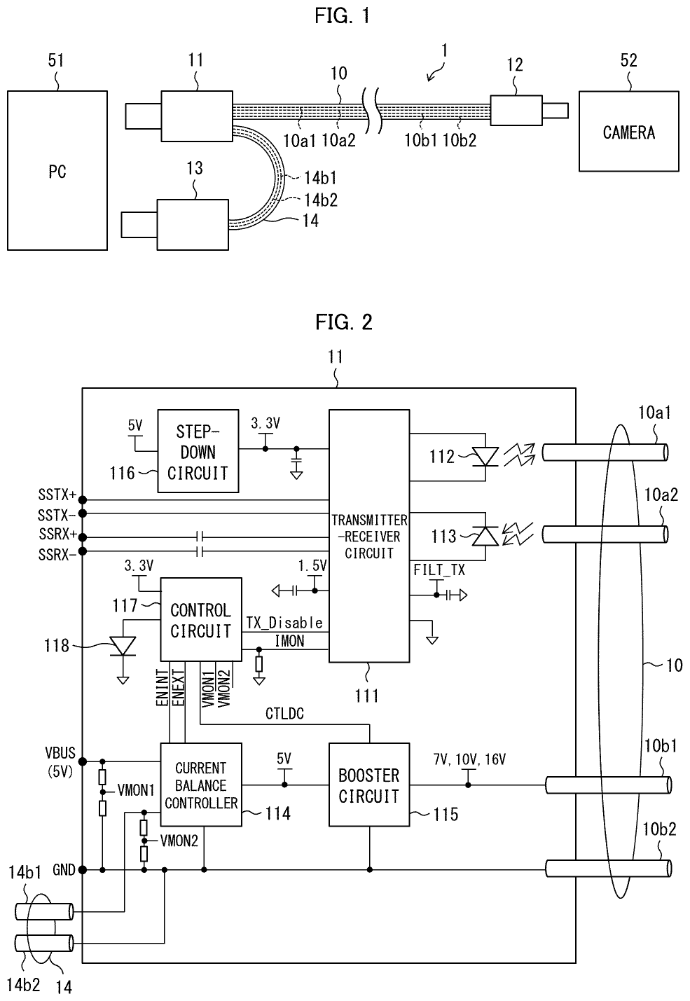

The following description will discuss an active optical cable in accordance with one or more embodiments of the present invention with reference to FIGS. 1 to 9.

Configuration of Active Optical Cable

With reference to FIG. 1, the following description will discuss a configuration of an active optical cable 1 in accordance with one or more embodiments. FIG. 1 is a block diagram illustrating a configuration of the active optical cable 1.

The active optical cable 1 is a cable for achieving bidirectional communication between two devices. The active optical cable 1 includes a composite cable 10, a first connector 11, a second connector 12, an auxiliary connector 13 (an example of the “first auxiliary connector” recited in the claims), and an auxiliary cable 14. In one or more embodiments, the active optical cable 1 is embodied as a universal serial bus (USB) cable. Here, a device to which the first connector 11 is connected is referred to as a “host device” 51, and a device to which the second connector 12 is connected is referred to as a “client device” 52. The present discussion assumes that the host device 51 is a device which does not require power supply from the active optical cable 1. One possible example is a personal computer (PC). Furthermore, it is assumed that the client device 52 is a device which does require power supply from the active optical cable 1. One possible example is a camera.

The first connector 11 is provided at a first end of the composite cable 10 and is for electrically connecting the active optical cable 1 to the host device 51. The first connector 11 converts into an optical signal an electric signal obtained from the host device 51, and sends that optical signal to the second connector 12. The first connector 11 also converts into an electric signal an optical signal received from the second connector 12, and provides that electric signal to the host device 51. The first connector 11 also serves to connect a power supply line 10b1 and a ground line 10b2, each included in the composite cable 10, to a power supply and a ground of the host device 51, respectively. Note that in one or more embodiments, the first connector 11 is embodied as a Standard-A-type connector in conformance with USB standards. An internal configuration of the first connector 11 will be described below with reference to a different diagram.

The second connector 12 is provided at a second end of the composite cable 10 and is for electrically connecting the active optical cable 1 to the client device 52. The second connector 12 converts into an optical signal an electric signal obtained from the client device 52, and sends that optical signal to the first connector 11. The second connector 12 also converts into an electric signal an optical signal received from the first connector 11, and provides that electric signal to the client device 52. The second connector 12 also serves to connect the power supply line 10b1 and the ground line 10b2, each included in the composite cable 10, to a load and a ground of the client device 52, respectively. Note that in one or more embodiments, the second connector 12 is embodied as a Micro-B-type connector in conformance with USB standards. An internal configuration of the second connector 12 will be described below with reference to a different diagram.

The auxiliary connector 13 is provided at the first end of the composite cable 10 and is for electrically connecting the active optical cable 1 to the host device 51. The auxiliary connector 13 also serves to connect an auxiliary power supply line 14b1 (an example of the “first auxiliary power supply line” recited in the claims) and an auxiliary ground line 14b2, each included in the auxiliary cable 14, to the power supply and the ground of the host device 51, respectively. Note that in the first connector 11, the auxiliary power supply line 14b1 and the auxiliary ground line 14b2 of the auxiliary cable 14 are connected to the power supply line 10b1 and the ground line 10b2 of the composite cable 10, respectively. In one or more embodiments, the auxiliary connector 13 is embodied as a Standard-A-type connector in conformance with USB standards. However, the auxiliary connector 13 need only be a connector in conformance with standards suitable for the device which supplies power. For example, the auxiliary connector 13 may be a Micro-B-type connector in conformance with USB standards, or a connector in conformance with some standard other than USB standards.

The composite cable 10 includes therein a first optical fiber cord 10a1 and a second optical fiber cord 10a2, in addition to the power supply line 10b1 and the ground line 10b2. The first optical fiber cord 10a1 is for transmitting to the second connector 12 an optical signal sent by the first connector 11. The second optical fiber cord 10a2 is for transmitting to the first connector 11 an optical signal sent by the second connector 12. The power supply line 10b1 is connected to the power supply of the host device 51 via the first connector 11 and/or the auxiliary connector 13. The power supply line 10b1 is connected to the load of the client device 52 via the second connector 12. The ground line 10b2 is connected to the ground of the host device 51 via the first connector 11 and/or the auxiliary connector 13. The ground line 10b2 is connected to the ground of the client device 52 via the second connector 12.

Once the first connector 11 or the auxiliary connector 13 is connected to the host device 51, supply of power from the host device 51 to the first connector 11 and to the second connector 12 is commenced. Once the supply of power to the first connector 11 and the second connector 12 is commenced, control circuits in each of the first connector 11 and the second connector 12 are initialized, and operation of the active optical cable 1 is commenced. At this time, the active optical cable 1 will be in one of state 1 through state 6 as indicated in the following Table 1, depending one (1) whether or not the first connector 11 has been connected to the host device 51, (2) whether or not the second connector 12 has been connected to the client device 52, and (3) whether or not the auxiliary connector 13 has been connected to the host device 51.

TABLE 1

| | State | | | | | |
|---|---|---|---|---|---|---|
| | State 1 | State 2 | State 3 | State 4 | State 5 | State 6 |
| First | Connected | Connected | Connected | Connected | Unconnected | Unconnected |
| connector | | | | | | |
| Second | Connected | Unconnected | Connected | Unconnected | Connected | Unconnected |
| connector | | | | | | |
| Auxiliary | Connected | Connected | Unconnected | Unconnected | Connected | Connected |
| connector | | | | | | |

In a case where the state at commencement of operation is state 1 or state 3 as indicated in Table 1, there is a possibility that, immediately after commencement of operation, communication will be carried out between the host device 51 and the client device 52. As such, depending on the state at commencement of operation, there are cases where a fault test cannot be carried out for the first optical fiber cord 10a1 and the second optical fiber cord 10a2 immediately after commencement of operation. The active optical cable 1 in accordance with one or more embodiments carries out a fault test for the first optical fiber cord 10a1 and the second optical fiber cord 10a2 only in a case where the state at commencement of operation is the state 5 or state 6 as indicated in Table 1.

Note that although the present discussion utilizes an example where the auxiliary connector 13 is connected to the host device 51, this example is merely for convenience of explanation and does not serve to limit how the active optical cable 1 is used. In other words, the auxiliary connector 13 may be connected to the host device 51 or to some device other than the host device 51 which is capable of supplying power to the active optical cable 1.

Internal Structure of First Connector

Next, with reference to FIG. 2, the following description will discuss an internal structure of the first connector 11 of the active optical cable 1 in accordance with one or more embodiments. FIG. 2 is a block diagram illustrating an internal structure of the first connector 11.

The first connector 11 includes a transmitter-receiver circuit 111, a light emitting element 112, a light receiving element 113, a current balance controller 114, a booster circuit 115, a step-down circuit 116, a control circuit 117, and an indicator 118.

The transmitter-receiver circuit 111 converts, into a current signal, a differential voltage signal inputted as a transmission signal into the first connector 11 from the host device 51 via SSTX+/SSTX− terminals. This current signal is inputted into the light emitting element 112. The light emitting element 112 converts this current signal into an optical signal. The optical signal is sent to the second connector 12 via the first optical fiber cord 10a1. Note that each of the signal lines in the host device 51 which are connected to the SSTX+/SSTX− terminals have a capacitor (not illustrated) interposed therein. As such, the differential voltage signal supplied from the host device 51 via the SSTX+/SSTX− terminals is an AC component of the transmission signal outputted from the host device 51.

The light receiving element 113 converts, into a current signal, an optical signal received from the second connector 12 via the second optical fiber cord 10a2. This current signal is supplied to the transmitter-receiver circuit 111. The transmitter-receiver circuit 111 converts this current signal into a differential voltage signal. The differential voltage signal is outputted as a received signal, to the host device 51, from the first connector 11 and via SSRX+/SSRX− terminals. Note that a capacitor is interposed between the transmitter-receiver circuit 111 and each of the SSRX+/SSRX− terminals. As such, the differential voltage signal outputted from the first connector 11 via the SSRX+/SSRX− terminals is an AC component of the differential voltage signal obtained by the transmitter-receiver circuit 111.

In one or more embodiments, a vertical cavity surface emitting laser (VCSEL) is used as the light emitting element 112. In one or more embodiments, a photodiode (PD) is used as the light receiving element 113. In one or more embodiments, used as the transmitter-receiver circuit 111 is an integrated circuit (IC) in which the following are integrated: a VCSEL driver that converts a voltage signal (transmission signal) into a current signal (driving current) to be supplied to the light emitting element 112; and a transimpedance amplifier (TIA) which converts a current signal (photocurrent) supplied from the light receiving element 113 into a voltage signal (received signal). Note also that the transmitter-receiver circuit 111 includes therein a current mirror circuit (not illustrated) which copies the current signal obtained by the light receiving element 113. The current signal obtained by the current mirror circuit is supplied to the control circuit 117 as a monitor signal IMON.

The current balance controller 114 obtains a first voltage V1 (which is predetermined) from one or both of (i) a first power supply connected to a VBUS terminal and (ii) a second power supply connected to the auxiliary power supply line 14b1. In a case where the first voltage V is obtained from both the first power supply and the second power supply, the current balance controller 114 serves to distribute the load between the first power supply and the second power supply. The booster circuit 115 converts (boosts) the first voltage V1 obtained by the current balance controller 114 to a second voltage V2 that is higher than the first voltage V1. In one or more embodiments, the first voltage V1 obtained by the current balance controller 114 is 5 V, and the second voltage V2 obtained by the booster circuit 115 is 7 V, 10 V, or 16 V. The second voltage V2 obtained by the booster circuit 115 is applied to the power supply line 10b1.

The step-down circuit 116 converts (steps down) the first voltage V1 obtained by the current balance controller 114 to a third voltage V3 that is lower than the first voltage V. In one or more embodiments, the third voltage V3 obtained by the step-down circuit 116 is 3.3 V. The third voltage V3 obtained by the step-down circuit 116 is applied to the transmitter-receiver circuit 111 and the control circuit 117. The transmitter-receiver circuit 111 and the control circuit 117 operate with use of the third voltage V3.

At least the following signals are inputted into the control circuit 117: (1) a monitor signal VMON1 that indicates a voltage applied to the VBUS terminal; (2) a monitor signal VMON2 that indicates a voltage applied to the auxiliary power supply line 14b1; and (3) the monitor signal IMON, which indicates a strength of a current signal (photocurrent) obtained by the light receiving element 113. The control circuit 117 refers to these monitor signals and controls the transmitter-receiver circuit 111, the current balance controller 114, and the booster circuit 115. For example, the control circuit 117 determines, based on the monitor signal VMON1, whether or not a voltage of 5 V is being applied to the VBUS terminal. In a case where the control circuit 117 determines that a voltage of 5 V is being applied to the VBUS terminal, the control circuit 117 uses a control signal ENINT to instruct the current balance controller 114 to obtain from the VBUS terminal a voltage to supply to the booster circuit 115 and the step-down circuit 116. Similarly, the control circuit 117 determines, based on the monitor signal VMON2, whether or not a voltage of 5 V is being applied to the auxiliary power supply line 14b1. In a case where the control circuit 117 determines that a voltage of 5 V is being applied to the auxiliary power supply line 14b1, the control circuit 117 uses a control signal ENEXT to instruct the current balance controller 114 to obtain from the auxiliary power supply line 14b1 a voltage to supply to the booster circuit 115 and the step-down circuit 116. In one or more embodiments, a micro controller unit (MCU) is used as the control circuit 117.

A feature of the first connector 11 is a fault test carried out by the control circuit 117 with reference to the monitor signals VMON1, VMON2, and IMON immediately after the first connector 11 or the auxiliary connector 13 is connected to the host device 51. The indicator 118 is for example an LED, and is used for notifying a user of a result of the fault test. A method for the fault test will be described below with reference to a different diagram.

Internal Structure of Second Connector

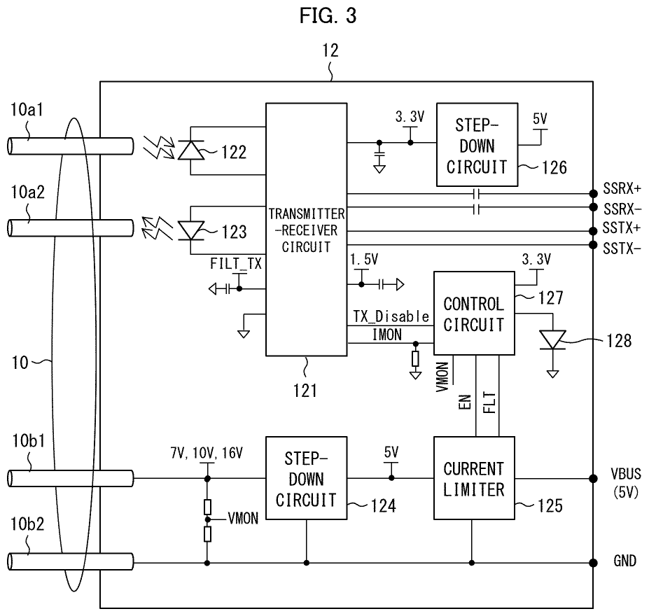

Next, with reference to FIG. 3, the following description will discuss an internal structure of the second connector 12 of the active optical cable 1 in accordance with one or more embodiments. FIG. 3 is a block diagram illustrating an internal structure of the second connector 12.

The second connector 12 includes a transmitter-receiver circuit 121, a light receiving element 122, a light emitting element 123, a step-down circuit 124, a current limiter 125, a step-down circuit 126, a control circuit 127, and an indicator 128.

The light receiving element 122 converts, into a current signal, an optical signal received from the first connector 11 via the first optical fiber cord 10a1. This current signal is supplied to the transmitter-receiver circuit 121. The transmitter-receiver circuit 121 converts this current signal into a differential voltage signal. The differential voltage signal is outputted as a received signal, to the client device 52, from the second connector 12 and via SSRX+/SSRX− terminals. Note that a capacitor is interposed between the transmitter-receiver circuit 121 and each of the SSRX+/SSRX− terminals. As such, the differential voltage signal outputted from the second connector 12 via the SSRX+/SSRX− is an AC component of the differential voltage signal obtained by the transmitter-receiver circuit 121.

The transmitter-receiver circuit 121 converts, into a current signal, a differential voltage signal inputted as a transmission signal into the second connector 12 from the client device 52 via SSTX+/SSTX− terminals. This current signal is inputted into the light emitting element 123. The light emitting element 123 converts this current signal into an optical signal. The optical signal is sent to the first connector 11 via the second optical fiber cord 10a2. Note that each of the signal lines in client device 52 which are connected to the SSTX+/SSTX− terminals have a capacitor (not illustrated) interposed therein. As such, the differential voltage signal supplied from the client device 52 via the SSTX+/SSTX− terminals is an AC component of the transmission signal outputted from the client device 52.

In one or more embodiments, a photodiode (PD) is used as the light receiving element 122. In one or more embodiments, a vertical cavity surface emitting laser (VCSEL) is used as the light emitting element 123. In one or more embodiments, used as the transmitter-receiver circuit 121 is an integrated circuit (IC) in which the following are integrated: a transimpedance amplifier (TIA) which converts a current signal (photocurrent) supplied from the light receiving element 122 into a voltage signal (received signal); and a VCSEL driver that converts a voltage signal (transmission signal) into a current signal (driving current) to be supplied to the light emitting element 123. Note also that the transmitter-receiver circuit 121 includes therein a current mirror circuit (not illustrated) which copies the current signal obtained by the light receiving element 122. The current signal obtained by the current mirror circuit is supplied to the control circuit 127 as a monitor signal IMON.

The step-down circuit 124 converts (steps down) the second voltage V2 applied to the power supply line 10b1 into the first voltage V1, which is lower than the second voltage V2. In one or more embodiments, the second voltage V2 applied to the power supply line 10b1 is 7 V, 10 V, or 16 V, and the first voltage V1 obtained by the step-down circuit 124 is 5 V. The first voltage V1 obtained by the step-down circuit 124 is applied to the VBUS terminal via the current limiter 125.

Note that the power supply line 10b1 and the ground line 10b2 each have a resistance value in accordance with their respective lengths. As such, a voltage supplied to the second connector 12 via the power supply line 10b1 will, in actuality, be smaller than the second voltage V2 obtained by the booster circuit 115 of the first connector 11. However, for convenience of explanation, the following descriptions will assume that voltage does not drop in the power supply line 10b1 and the ground line 10b2, and that the voltage supplied to the second connector 12 has the same value as the second voltage V2 obtained by the booster circuit 115 of the first connector 11.

The step-down circuit 126 converts (steps down) the first voltage V1 obtained by the step-down circuit 124 to the third voltage V3 that is lower than the first voltage V. In one or more embodiments, the third voltage V3 obtained by the step-down circuit 126 is 3.3 V. The third voltage V3 obtained by the step-down circuit 126 is applied to the transmitter-receiver circuit 121 and the control circuit 127. The transmitter-receiver circuit 121 and the control circuit 127 operate with use of the third voltage V3.

At least the following signals are inputted into the control circuit 127: (1) a monitor signal VMON that indicates a voltage applied to the power supply line 10b1; (2) a monitor signal IMON that indicates a strength of a current signal (photocurrent) obtained by the light receiving element 122. The control circuit 127 refers to these monitor signals and controls the transmitter-receiver circuit 121 and the current limiter 125. For example, the control circuit 127 determines, based on the monitor signal VMON, whether or not a voltage of 16 V is being applied to the power supply line 10b1. In a case where the control circuit 127 determines that a voltage of 16 V is being applied to the power supply line 10b1, the control circuit 127 uses a control signal EN to instruct the current limiter 125 to apply a voltage to the VBUS terminal. In a case where the control circuit 127 determines that a voltage of 16 V is not being applied to the power supply line 10b1, the control circuit 127 uses the control signal EN to instruct the current limiter 125 not to apply a voltage to the VBUS terminal. Furthermore, by referring to a control signal FLT, the control circuit 127 detects that a current which is greater than or equal to a set value has flowed through the current limiter 125. Note that the control signal FLT is a signal for providing notification of flow of a current greater than or equal to the set value. The control signal FLT is supplied to the control circuit 127 from the current limiter 125. In one or more embodiments, a micro controller unit (MCU) is used as the control circuit 127.

A feature of the second connector 12 is a fault test carried out by the control circuit 127 with reference to the monitor signals VMON and IMON immediately after the first connector 11 or the auxiliary connector 13 is connected to the host device 51. The indicator 128 is for example an LED, and is used for notifying a user of a result of the fault test. A method for the fault test will be described below with reference to a different diagram.

Method of Fault Test

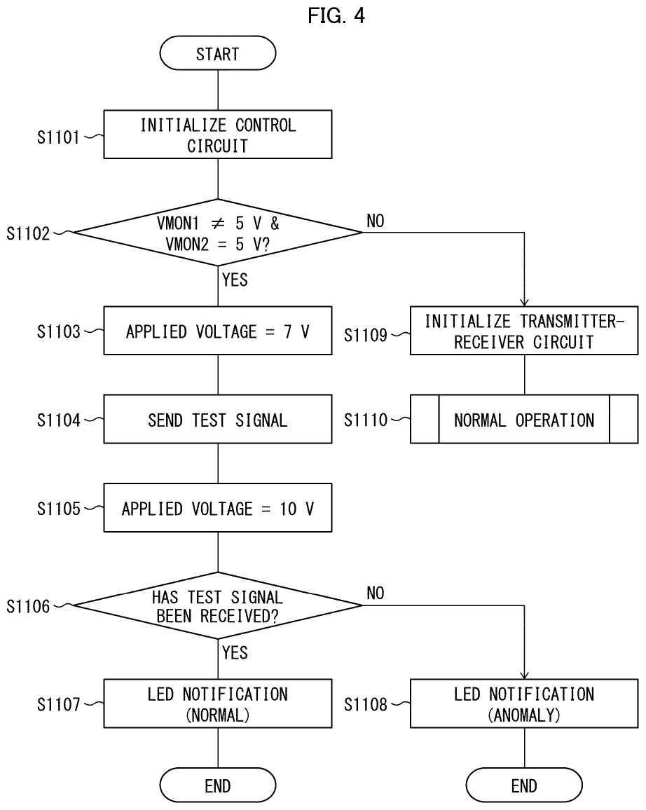

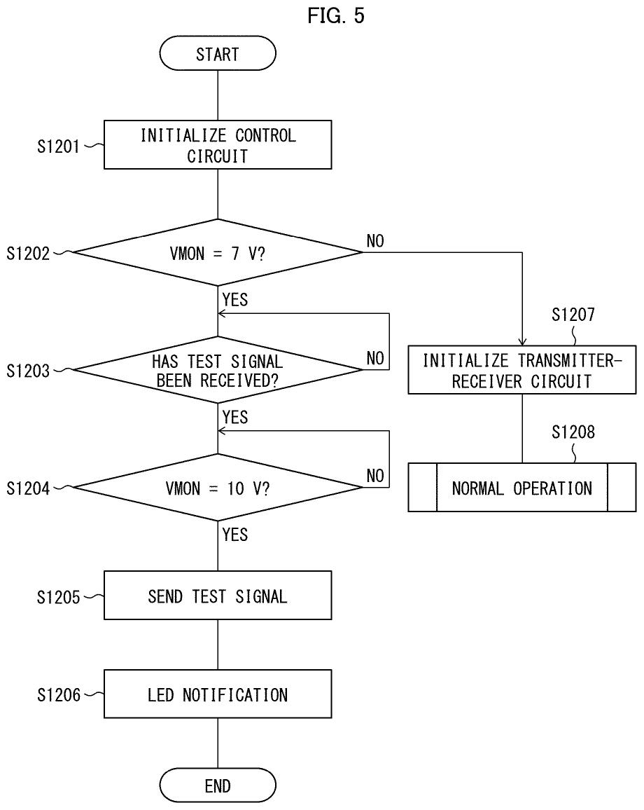

Next, with reference to FIGS. 4 and 5, the following description will discuss a fault test carried out in the active optical cable 1 of one or more embodiments immediately after the first connector 11 or the auxiliary connector 13 is connected to the host device 51. FIG. 4 is a flowchart indicating operations of the first connector 11 during the fault test. FIG. 5 is a flowchart indicating operations of the second connector 12 during the fault test.

First, operations of the first connector 11 are discussed with reference to FIG. 4. In a case where the first connector 11 or the auxiliary connector 13 is connected to the host device 51, the first connector 11 carries out the below-described steps (indicated in FIG. 4).

Step S1101: Once the first connector 11 or the auxiliary connector 13 is connected to the host device 51, the control circuit 117 starts up. The control circuit 117 first initializes itself.

Step S1102: Next, the control circuit 117 refers to the monitor signal VMON1 and determines whether or not the first connector 11 is connected to the host device 51. The control circuit 117 also refers to the monitor signal VMON2 and determines whether or not the auxiliary connector 13 is connected to the host device 51. In a case where the first connector 11 is in an unconnected state and the auxiliary connector 13 is in a connected state, the control circuit 117 enters a fault test mode and carries out steps S1103 through S1108 described below.

Note that in a case (1) where the first connector 11 is in a connected state and the auxiliary connector 13 is in an unconnected state, or in a case (2) where the first connector 11 is in a connected state and the auxiliary connector 13 is in a connected state, the control circuit 117 does not enter the fault test mode, and instead initializes the transmitter-receiver circuit 111 in step S1109, and then commences normal operation in step S1110.

Step S1103: The control circuit 117 uses a control signal CTLDC to instruct the booster circuit 115 to set the voltage applied to the power supply line 10b1 to 7 V. The booster circuit 115 changes the voltage applied to the power supply line 10b1 from 16 V to 7 V.

Step S1104: For a predetermined time period, the control circuit 117 supplies to the transmitter-receiver circuit 111 a low-frequency voltage signal having a predetermined first pulse pattern, the voltage signal being supplied as a TX_Disable signal. The transmitter-receiver circuit 111 drives the light emitting element 112 in accordance with the TX_Disable signal. In other words, when a value of the TX_Disable signal is a low level, the light emitting element 112 is on, and when the value of the TX_Disable signal is a high level, the light emitting element 112 is off. In this way, a low-frequency optical signal having the first pulse pattern is sent during a predetermined time period from the first connector 11 to the second connector 12. This optical signal is hereinafter referred to as a “first test signal”.

Step S1105: The control circuit 117 uses the control signal CTLDC to instruct the booster circuit 115 to set the voltage applied to the power supply line 10b1 to 10 V. The booster circuit 115 changes the voltage applied to the power supply line 10b1 from 7 V to 10 V.

As will be described later, changing the voltage of the power supply line 10b1 to 7 V serves as a trigger for the second connector 12 to enter the fault test mode. Once the second connector 12 has received the first test signal in the fault test mode, changing the voltage of the power supply line 10b1 to 10 V serves as a trigger for the second connector 12 to send in response an optical signal having a predetermined second pulse pattern. This optical signal is hereinafter referred to as a “second test signal”. Note that the second pulse pattern may be the same pulse pattern as the first pulse pattern, or may be a pulse pattern differing from the first pulse pattern.

Step S1106: the control circuit 117 refers to the monitor signal IMON and determines whether or not the transmitter-receiver circuit 111 has received the second test signal. In a case where the second test signal has been received, presumably no fault has occurred in the first optical fiber cord 10a1 and the second optical fiber cord 10a2. In such a case, the control circuit 117 carries out step S1107 described below. However, in a case where the second test signal has not been received, presumably a fault has occurred in the first optical fiber cord 10a1 or the second optical fiber cord 10a2. In such a case, the control circuit 117 carries out step S1108 described below.

Step S1107: The control circuit 117 uses the indicator 118 to notify the user that no fault has occurred in the first optical fiber cord 10a1 and the second optical fiber cord 10a2. For example, the control circuit 117 turns on the indicator 118.

Step S1108: The control circuit 117 uses the indicator 118 to notify the user that a fault such as a break has occurred in the first optical fiber cord 10a1 or the second optical fiber cord 10a2. For example, the control circuit 117 causes the indicator 118 to blink on and off. In this way, an operator on a host device 51 side can easily visually determine whether a fault such as a break has occurred in the active optical cable 1, by checking whether the LED is on or blinking on and off. Examples of faults that can be detected on a first connector 11 side by the above method include (i) malfunctioning of the light emitting element 112 of the first connector 11 or the light receiving element 122 of the second connector 12 and (ii) a break in the first optical fiber cord 10a1 or the second optical fiber cord 10a2.

Consider an example in which one host device 51 has an interface connectable to a plurality of active optical cables 1. In such a case, presumably a plurality of first connectors 11 will be in close proximity with each other when the plurality of active optical cables 1 are connected. In such a state, if a large number of the indicators of the first connectors 11 are on, then it will be easy to visually determine a first connector 11 whose indicator is blinking on and off. As such, an operator on the host device 51 side can easily visually determine that a fault has occurred in the active optical cable 1.

Next, the following description will discuss operations of the second connector 12 with reference to FIG. 5. In a case where the first connector 11 or the auxiliary connector 13 is connected to the host device 51, the second connector 12 carries out the below-described steps (indicated in FIG. 5).

Step S1201: Once the first connector 11 or the auxiliary connector 13 is connected to the host device 51, the control circuit 127 starts up. The control circuit 127 first initializes itself.

Step S1202: The control circuit 127 refers to the monitor signal VMON and determines whether or not the voltage of the power supply line 10b1 has changed to 7 V. In a case where the voltage of the power supply line 10b1 has changed to 7 V within a predetermined time period, the control circuit 127 enters the fault test mode and carries out steps S1203 through S1206 described below.

Note that in a case where the voltage of the power supply line 10b1 has not changed to 7 V within the predetermined time period, the control circuit 127 does not enter the fault test mode, and instead initializes the transmitter-receiver circuit 121 in step S1207 and then commences normal operation in step S1208.

Step S1203: The control circuit 127 refers to the monitor signal IMON and determines whether or not the transmitter-receiver circuit 121 has received the first test signal. In a case where the first test signal has been received within a predetermined time period, the control circuit 127 carries out step S1204 described below.

Step S1204: The control circuit 127 refers to the monitor signal VMON and determines whether or not the voltage of the power supply line 10b1 has changed to 10 V. In a case where the voltage of the power supply line 10b1 has changed to 10 V within a predetermined time period, the control circuit 127 carries out step S1205 described below.

Step S1205: For a predetermined time period, the control circuit 127 supplies to the transmitter-receiver circuit 121 a low-frequency voltage signal having the above-described second pulse pattern, the voltage signal being supplied as a TX_Disable signal. The transmitter-receiver circuit 121 drives the light emitting element 123 in accordance with the TX_Disable signal. In other words, when a value of the TX_Disable signal is a low level, the light emitting element 123 is on, and when the value of the TX_Disable signal is a high level, the light emitting element 123 is off. In this way, a low-frequency optical signal having a second pulse pattern, i.e., the second test signal, is sent from the second connector 12 to the first connector 11 for a predetermined time period.

Step S1206: The control circuit 127 uses the indicator 128 to notify the user that the fault test has finished. For example, the control circuit 127 turns on the indicator 128 (which is an LED). Note here that connecting the auxiliary connector 13 to the host device 51 causes the fault test to be carried out. As such, an operator on a client device 52 side can easily visually determine that the auxiliary connector 13 has been connected to the host device 51 and that the fault test has finished by checking that the indicator 128 is on.

The above operations involved an example where the second connector 12 provides notification that the fault test has finished. Note, however, that this is a non-limiting example. The second connector 12 may use the indicator 128 to notify the user of whether or not a fault such as a break has occurred in the active optical cable 1.

In such a case, the control circuit 127 may, for example, operate as follows. For example, in a case where the first test signal is received during a period from (i) when the voltage of the power supply line 10b1 changes to 7 V to (ii) when the voltage of the power supply line 10b1 changes to 10 V, the control circuit 127 determines that a fault has not occurred. In such a case, the control circuit 127 for example turns on the indicator 128 (which is an LED). Conversely, in a case where the first test signal is not received during the period from (i) when the voltage of the power supply line 10b1 changes to 7 V to (ii) when the voltage of the power supply line 10b1 changes to 10 V, the control circuit 127 determines that a fault has occurred. In such a case, the control circuit 127 for example causes the indicator 128 (which is an LED) to blink on and off.

In this way, an operator on the client device 52 side can easily visually determine whether a fault such as a break has occurred in the active optical cable 1, by checking whether the LED is on or blinking on and off. Examples of faults that can be detected on the second connector 12 side include (i) malfunctioning of the light emitting element 112 of the first connector 11 and (ii) a break in the first optical fiber cord 10a1.

The above-described operations involve an example in which the first test signal sent from the first connector 11 to the second connector 12 is a low-frequency optical signal. Note, however, that the first test signal is not limited to being a low-frequency optical signal. For example, the first test signal may be continuous light. In such a case, in step S1104, for the predetermined time period, the control circuit 117 of the first connector 11 can supply to the transmitter-receiver circuit 111 a TX_Disable signal having a constant low level. Even in such a case, in step S1203, the control circuit 127 of the second connector 12 can refer to the monitor signal IMON and determine whether or not the transmitter-receiver circuit 121 has received the first test signal.

Similarly, the above-described operations involve an example in which the second test signal sent from the second connector 12 to the first connector 11 is a low-frequency optical signal. Note, however, that the second test signal is not limited to being a low-frequency optical signal. For example, the second test signal may be continuous light. In such a case, in step S1205, for the predetermined time period, the control circuit 127 of the second connector 12 can supply to the transmitter-receiver circuit 121 a TX_Disable signal having a constant low level. Even in such a case, in step S1106, the control circuit 117 of the first connector can refer to the monitor signal IMON and determine whether or not the transmitter-receiver circuit 111 has received the second test signal.

Variation 1

Discussed in one or more embodiments above was an example configuration in which the fault test is carried out only in cases in which the state at commencement of operation (i.e., the state at the time point at which the first connector 11 or the auxiliary connector 13 is connected to the host device 51) is the state 5 or state 6 indicated in Table 1. Note, however that the present invention is not limited to such a configuration. For example, it is possible to employ a configuration in which the fault test is carried out only in cases in which the state at commencement of operation is the state 2, the state 4, or the state 6 indicated in Table 1 (i.e., in cases where the second connector 12 is in an unconnected state at commencement of operation).

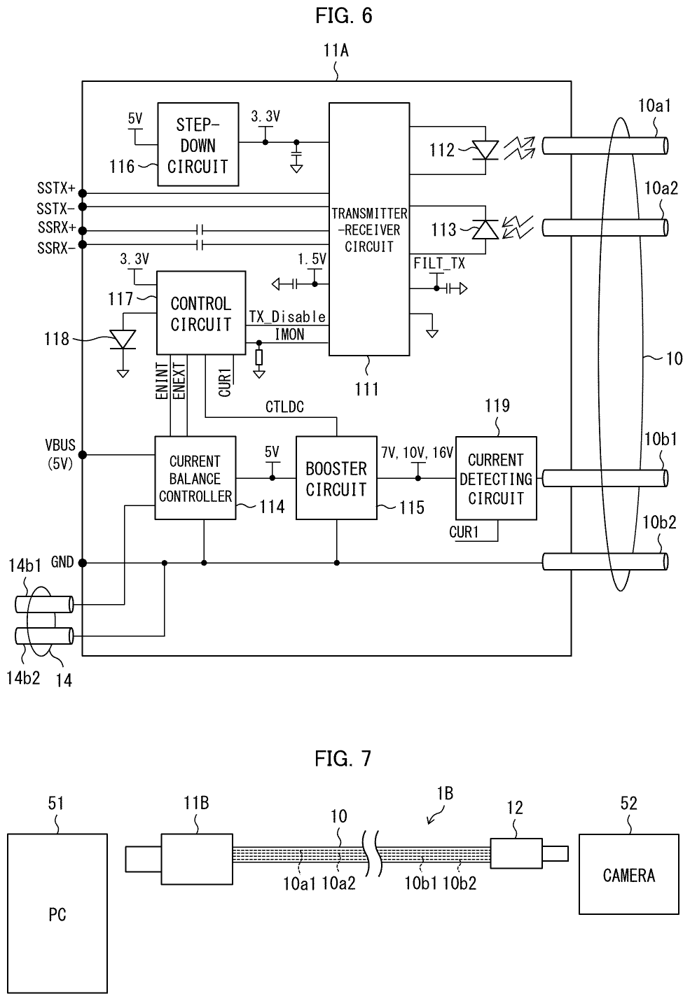

FIG. 6 illustrates a variation of the first connector 11 adapted for such a configuration. FIG. 6 is a block diagram illustrating an internal configuration of a first connector 11A in accordance with Variation 1.

The first connector 11A in accordance with Variation 1 is obtained by adding a current detecting circuit 119 to the first connector 11 illustrated in FIG. 2. The current detecting circuit 119 is for detecting the level of a current flowing into the power supply line 10b1 from the booster circuit 115. The current detecting circuit 119 provides to the control circuit 117 a monitor signal CUR1 which indicates the level of the current thus detected.

In a case where the second connector 12 is connected to the client device 52, there is an increase in the current flowing into the power supply line 10b1 from the booster circuit 115. As such, by referring to the monitor signal CUR1 provided by the current detecting circuit 119, the control circuit 117 is able to determine whether or not the second connector 12 is connected to the client device 52 at commencement of operation. Replacing the first connector 11 with the first connector 11A of Variation 1 therefore makes it possible to achieve an active optical cable 1 in which the fault test is carried out only in a case where the second connector 12 is in an unconnected state at commencement of operation.

Note that, in comparison to a configuration in which the active optical cable 1 includes the first connector 11, a configuration in which the active optical cable 1 includes the first connector 11A has the advantage that an unconnected state of the second connector 12 can be detected as a state for which the fault test can be carried out. However, the first connector 11A requires the current detecting circuit 119, which is not included in the configuration of the first connector 11. In other words, in comparison to the first connector 11A, the first connector 11 has the advantage of having a simpler configuration. As such, a configuration in which the active optical cable 1 includes the first connector 11A can be employed in applications where it is desirable to detect an unconnected state of the second connector 12 as a state for which the fault test can be carried out. A configuration in which the active optical cable 1 has the first connector 11 can be employed in applications where it will suffice to be able to detect an unconnected state of the first connector 11 as a state for which the fault test can be carried out.

Variation 2

Discussed in Variation 1 was a configuration in which the fault test is carried out only in a case where the second connector 12 is in an unconnected state at commencement of operation. In such a configuration, the active optical cable 1 does not necessarily need to include the auxiliary connector 13 and the auxiliary cable 14. FIG. 7 illustrates an active optical cable 1B which is a variation of the active optical cable 1 in which variation the auxiliary connector 13 and the auxiliary cable 14 are omitted. With such a configuration, the fault test can be carried out in the active optical cable 1B in a case where the first connector 11 has been connected and the second connector 12 has not been connected.

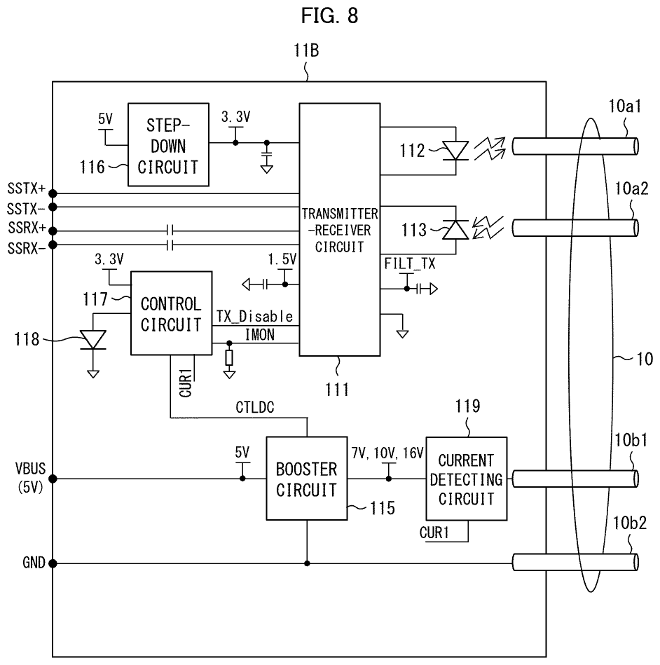

FIG. 8 is a block diagram illustrating an internal configuration of a first connector 11B included in the active optical cable 1B.

The first connector 11B in accordance with Variation 2 is obtained by omitting the auxiliary cable 14 and the current balance controller 114 from the first connector 11A illustrated in FIG. 6.

Once the first connector 11B is connected to the host device 51, power is supplied and the first connector 11B commences operation. At commencement of operation, similarly to the first connector 11A of Variation 1, the first connector 11B is capable of referring to the monitor signal CUR1 provided by the current detecting circuit 119 and thereby determining whether or not the second connector 12 is connected to the client device 52. This makes it possible to achieve the active optical cable 1B in which the fault test is carried out only in a case where the second connector 12 is in an unconnected state at commencement of operation.

Method of Fault Test in Variation 1 and Variation 2

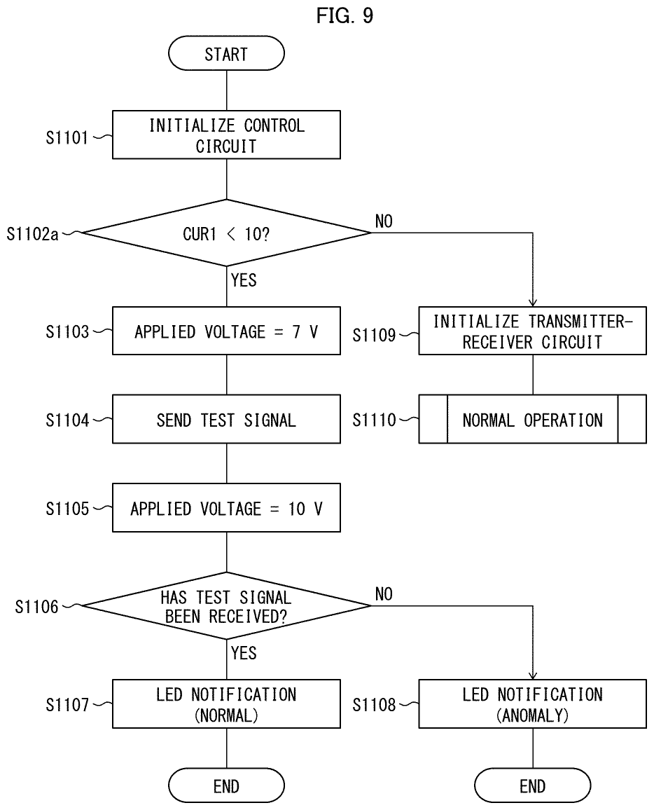

Next, with reference to FIG. 9, the following description will discuss operations of the first connector 11A and the first connector 11B during the fault tests in Variation 1 and Variation 2. FIG. 9 is a flowchart for explaining operations of the first connector 11A and the first connector 11B. The first connector 11A carries out the operations indicated in FIG. 9 immediately after the first connector 11A or the auxiliary connector 13 is connected to the host device 51. The first connector 11B carries out the operations indicated in FIG. 9 immediately after the first connector 11B is connected to the host device 51.

As illustrated in FIG. 9, the operations of the first connector 11A and the first connector 11B differ from the operations of the first connector 11 explained with reference to FIG. 4 in that the first connector 11A and the first connector 11B carry out the step S1102a instead of the step S1102. The step S1102a is a step of determining whether or not to carry out the fault test.

After the control circuit 117 has initialized itself in step S1101, the control circuit 117 proceeds to step S1102a, in which the control circuit 117 refers to the monitor signal CUR1 and determines whether or not the second connector 12 is connected to the client device 52. For example, the control circuit 117 determines that the second connector 12 is not connected to the client device 52 in a case where the CUR1 is less than 10 mA.

In a case where the second connector 12 is in an unconnected state, the control circuit 117 enters the fault test mode and carries out the above-described steps S1103 through S1108. In a case where the second connector 12 is in a connected state, the control circuit 117 does not enter the fault test mode, and instead carries out the above-described steps S1109 and S1110 and commences normal operation.

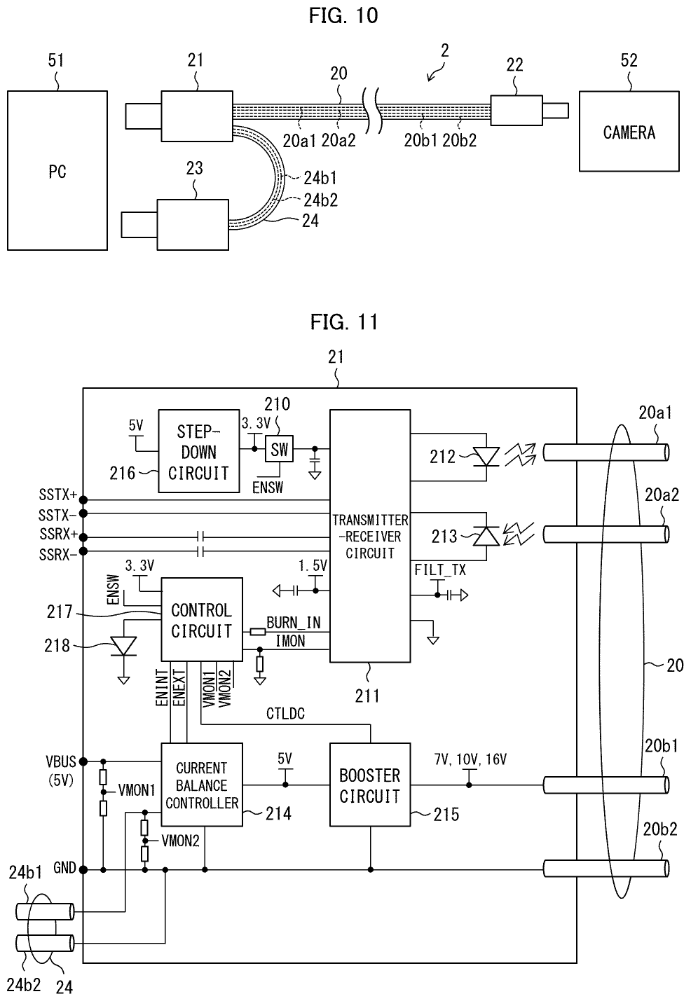

The following description will discuss an active optical cable in accordance with one or embodiments of the present invention, with reference to FIGS. 10 to 18.

Configuration of Active Optical Cable

With reference to FIG. 10, the following description will discuss a configuration of an active optical cable 2 in accordance with one or more embodiments. FIG. 10 is a block diagram illustrating a configuration of the active optical cable 2.

The active optical cable 2 is a cable for achieving bidirectional communication between two devices. The active optical cable 2 includes a composite cable 20, a first connector 21, a second connector 22, an auxiliary connector 23, and an auxiliary cable 24.

The composite cable 20, first connector 21, second connector 22, auxiliary connector 23, and auxiliary cable 24 included in the active optical cable 2 of one or more embodiments are configured similarly to the composite cable 10, first connector 11, second connector 12, auxiliary connector 13, and auxiliary cable 14, respectively, included in the active optical cable 1 of one or more embodiments described above (see FIG. 1).

Similarly to the active optical cable 1 of one or more embodiments discussed above, the active optical cable 2 of one or more embodiments carries out a fault test only in a case where a state at commencement of operation is the state 5 or the state 6 indicated in Table 1, i.e., a case where at commencement of operation, the first connector 11 is in a unconnected state and the auxiliary connector 13 is in a connected state.

Internal Structure of First Connector

Next, with reference to FIG. 11, the following description will discuss an internal structure of the first connector 21 of the active optical cable 2 in accordance with one or more embodiments. FIG. 11 is a block diagram illustrating an internal structure of the first connector 21.

The first connector 21 includes a transmitter-receiver circuit 211, a light emitting element 212, a light receiving element 213, a current balance controller 214, a booster circuit 215, a step-down circuit 216, a control circuit 217, an indicator 218, and a switch 210.

The transmitter-receiver circuit 211, light emitting element 212, light receiving element 213, current balance controller 214, booster circuit 215, step-down circuit 216, control circuit 217, and indicator 218 included in the first connector 21 are configured similarly to the transmitter-receiver circuit 111, light emitting element 112, light receiving element 113, current balance controller 114, booster circuit 115, step-down circuit 116, control circuit 117, and indicator 118, respectively, included in the first connector 11 of one or more embodiments (see FIG. 2).

Note, however, that the transmitter-receiver circuit 211 included in the first connector 21 brings about the implementation limitation that, in a state where power is being supplied to the transmitter-receiver circuit 211 from an external source, the driving current supplied to the light emitting element 212 cannot be controlled directly from the control circuit 217. As such, in the first connector 21, the switch 210 is provided between the step-down circuit 216 and the transmitter-receiver circuit 211, and supply of power from the step-down circuit 216 to the transmitter-receiver circuit 211 is cut off in a case where a first test signal is sent in the fault test mode.

Note that a method for the fault test which utilizes the first connector 21 will be described below with reference to a different diagram.

Internal Structure of Second Connector

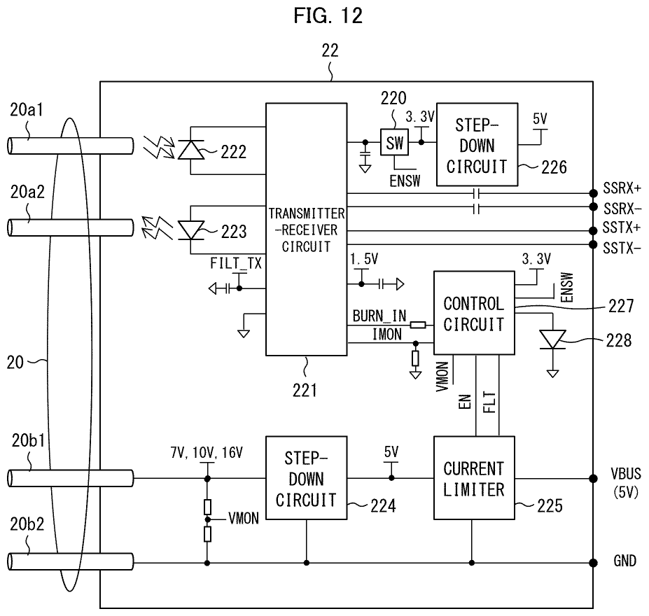

Next, with reference to FIG. 12, the following description will discuss an internal structure of the second connector 22 of the active optical cable 2 in accordance with one or more embodiments. FIG. 12 is a block diagram illustrating an internal structure of the second connector 22.

The second connector 22 includes a transmitter-receiver circuit 221, a light receiving element 222, a light emitting element 223, a step-down circuit 224, a current limiter 225, a step-down circuit 226, a control circuit 227, an indicator 228, and a switch 220.

The transmitter-receiver circuit 221, light receiving element 222, light emitting element 223, step-down circuit 224, current limiter 225, step-down circuit 226, control circuit 227, and indicator 228 included in the second connector 22 are configured similarly to the transmitter-receiver circuit 121, light receiving element 122, light emitting element 123, step-down circuit 124, current limiter 125, step-down circuit 126, control circuit 127, and indicator 128, respectively, included in the second connector 12 of one or more embodiments (see FIG. 3).

Note, however, that the transmitter-receiver circuit 221 included in the second connector 22 brings about the implementation limitation that, in a state where power is being supplied to the transmitter-receiver circuit 221 from an external source, the driving current supplied to the light emitting element 223 cannot be controlled directly from the control circuit 227. As such, in the second connector 22, the switch 220 is provided between the step-down circuit 226 and the transmitter-receiver circuit 221, and supply of power from the step-down circuit 226 to the transmitter-receiver circuit 221 is cut off in a case where a second test signal is sent in the fault test mode.

Note that a method for the fault test which utilizes the second connector 22 will be described below with reference to a different diagram.

Method of Fault Test

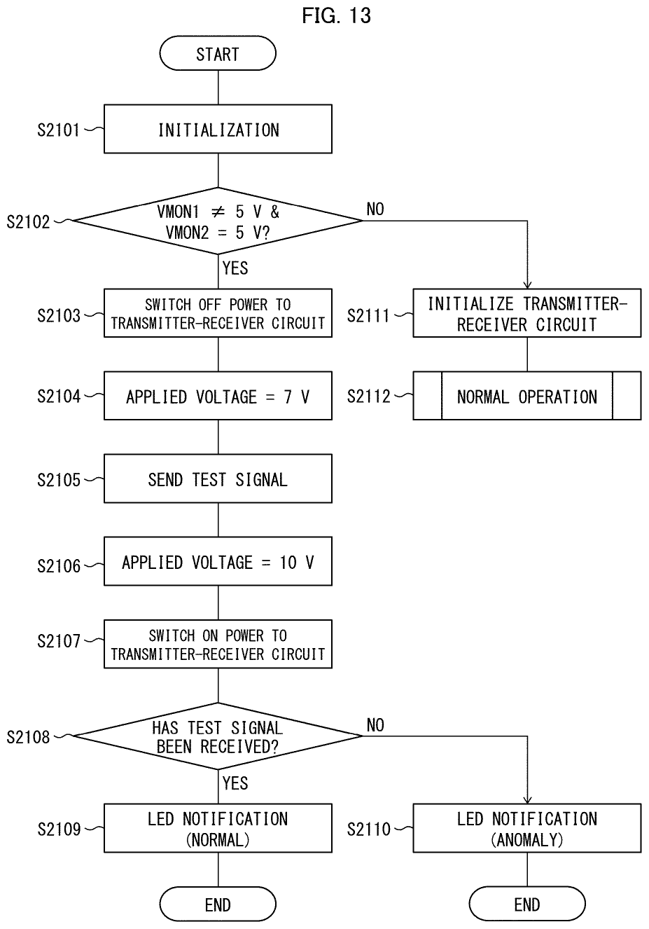

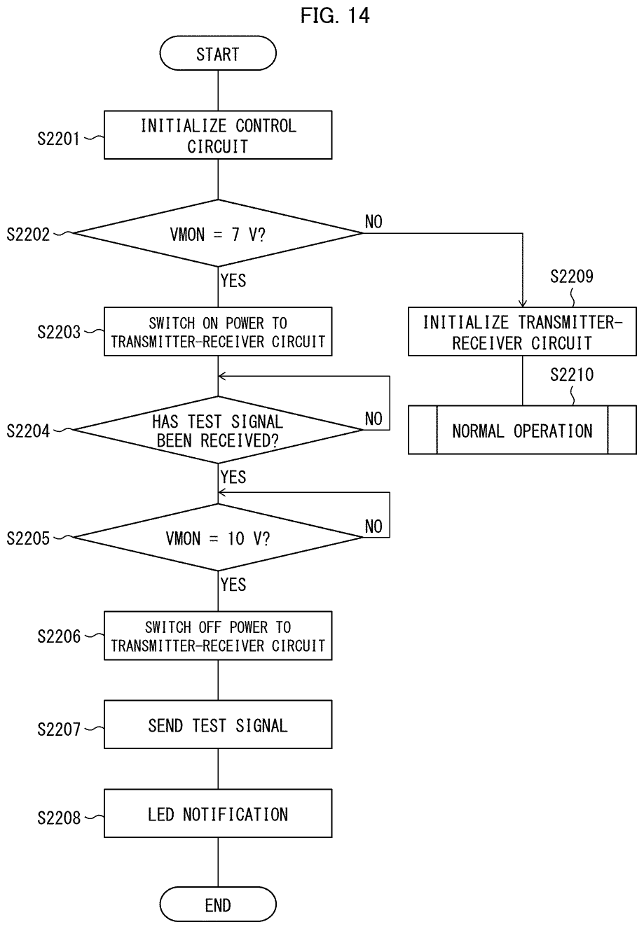

Next, with reference to FIGS. 13 and 14, the following description will discuss a fault test carried out in the active optical cable 2 of one or more embodiments immediately after the first connector 21 or the auxiliary connector 23 is connected to a host device 51. FIG. 13 is a flowchart indicating operations of the first connector 21 during the fault test. FIG. 14 is a flowchart indicating operations of the second connector 22 during the fault test.

First, operations of the first connector 21 are discussed with reference to FIG. 13. In a case where the first connector 21 or the auxiliary connector 23 is connected to the host device 51, the first connector 21 carries out the below-described steps (indicated in FIG. 13).

Step S2101: Once the first connector 21 or the auxiliary connector 23 is connected to the host device 51, the control circuit 217 starts up. The control circuit 217 first initializes itself.

Step S2102: Next, the control circuit 217 refers to a monitor signal VMON1 and determines whether or not the first connector 21 is connected to the host device 51. The control circuit 217 also refers to a monitor signal VMON2 and determines whether or not the auxiliary connector 23 is connected to the host device 51. In a case where the first connector 21 is in an unconnected state and the auxiliary connector 23 is in a connected state, the control circuit 217 enters a fault test mode and carries out steps S2103 through S2110 described below.

Note that in a case (1) where the first connector 21 is in a connected state and the auxiliary connector 23 is in an unconnected state, or in a case (2) where the first connector 21 is in a connected state and the auxiliary connector 23 is in a connected state, the control circuit 217 does not enter the fault test mode, and instead initializes the transmitter-receiver circuit 211 in step S2111, and then commences normal operation in step S2112.

Step S2103: The control circuit 217 uses a control signal ENSW to put the switch 210 into a cutoff state. This cuts off the power supplied to the transmitter-receiver circuit 211 from the step-down circuit 216 and makes it possible to directly control, from the control circuit 217, the driving current supplied from the transmitter-receiver circuit 211 to the light emitting element 212.

Step S2104: The control circuit 217 uses a control signal CTLDC to instruct the booster circuit 215 to set the voltage applied to a power supply line 20b1 to 7 V. The booster circuit 215 changes the voltage applied to the power supply line 20b1 from 16 V to 7 V.

Step S2105: For a predetermined time period, the control circuit 217 supplies to the transmitter-receiver circuit 211 a low-frequency voltage signal having a predetermined first pulse pattern, the voltage signal being supplied as a BURN_IN signal. The transmitter-receiver circuit 211 drives the light emitting element 212 in accordance with the BURN_IN signal. In other words, when a value of the BURN_IN signal is a high level, the light emitting element 212 is on, and when the value of the BURN_IN signal is a low level, the light emitting element 212 is off. In this way, a low-frequency optical signal having the first pulse pattern is sent during a predetermined time period from the first connector 21 to the second connector 22. This optical signal is hereinafter referred to as a “first test signal”.

Step S2106: The control circuit 217 uses the control signal CTLDC to instruct the booster circuit 215 to set the voltage applied to the power supply line 20b1 to 10 V. The booster circuit 215 changes the voltage applied to the power supply line 20b1 from 7 V to 10 V.

Step S2107: The control circuit 217 uses a control signal ENSW to put the switch 210 into a state of electrical continuity. This restarts the supply of power from the step-down circuit 216 to the transmitter-receiver circuit 211.

As will be described later, changing the voltage of the power supply line 20b1 to 7 V serves as a trigger for the second connector 22 to enter the fault test mode. Once the second connector 22 has received the first test signal in the fault test mode, changing the voltage of the power supply line 20b1 to 10 V serves as a trigger for the second connector 22 to send in response an optical signal having a predetermined second pulse pattern. This optical signal is hereinafter referred to as a “second test signal”. Note that the second pulse pattern may be the same pulse pattern as the first pulse pattern, or may be a pulse pattern differing from the first pulse pattern.

Step S2108: The control circuit 217 refers to a monitor signal IMON and determines whether or not the transmitter-receiver circuit 211 has received the second test signal. In a case where the second test signal has been received, presumably no fault (such as a break) has occurred in a first optical fiber cord 20a1 and a second optical fiber cord 20a2. In such a case, the control circuit 217 carries out step S2109 described below. However, in a case where the second test signal has not been received, presumably a fault such as a break has occurred in the first optical fiber cord 20a1 or the second optical fiber cord 20a2. In such a case, the control circuit 217 carries out step S2110 described below.

Step S2109: The control circuit 217 uses the indicator 218 to notify the user that no fault (such as a break) has occurred in the first optical fiber cord 20a1 and the second optical fiber cord 20a2. For example, the control circuit 217 turns on the indicator 218.

Step S2110: The control circuit 217 uses the indicator 218 to notify the user that a fault (such as a break) has occurred in the first optical fiber cord 20a1 or the second optical fiber cord 20a2. For example, the control circuit 217 causes the indicator 218 to blink on and off. In this way, an operator on a host device 51 side can easily visually determine whether a fault has occurred in the active optical cable 2, by checking whether the LED is on or blinking on and off.

Next, the following description will discuss operations of the second connector 22 with reference to FIG. 14. In a case where the first connector 21 or the auxiliary connector 23 is connected to the host device 51, the second connector 22 carries out the below-described steps (indicated in FIG. 14).

Step S2201: Once the first connector 21 or the auxiliary connector 23 is connected to the host device 51, the control circuit 227 starts up. The control circuit 227 first initializes itself.

Step S2202: The control circuit 227 refers to a monitor signal VMON and determines whether or not the voltage of the power supply line 20b1 has changed to 7 V. In a case where the voltage of the power supply line 20b1 has changed to 7 V within a predetermined time period, the control circuit 227 enters the fault test mode and carries out steps S2203 through S2208 described below.

Note that in a case where the voltage of the power supply line 20b1 has not changed to 7 V within the predetermined time period, the control circuit 227 does not enter the fault test mode, and instead initializes the transmitter-receiver circuit 221 in step S2209 and then commences normal operation in step S2210.

Step S2203: The control circuit 227 uses a control signal ENSW to put the switch 220 into a state of electrical continuity. This starts the supply of power from the step-down circuit 216 to the transmitter-receiver circuit 211.

Step S2204: The control circuit 227 refers to the monitor signal IMON and determines whether or not the transmitter-receiver circuit 221 has received the first test signal. In a case where the first test signal has been received within a predetermined time period, the control circuit 227 carries out step S2205 described below.

Step S2205: The control circuit 227 refers to the monitor signal VMON and determines whether or not the voltage of the power supply line 20b1 has changed to 10 V. In a case where the voltage of the power supply line 20b1 has changed to 10 V within a predetermined time period, the control circuit 227 carries out step S2206 described below.

Step S2206: The control circuit 227 uses the control signal ENSW to put the switch 220 into a cutoff state. This cuts off the power supplied to the transmitter-receiver circuit 221 from the step-down circuit 226 and makes it possible to directly control, from the control circuit 227, the driving current supplied from the transmitter-receiver circuit 221 to the light emitting element 223.

Step S2207: For a predetermined time period, the control circuit 227 supplies to the transmitter-receiver circuit 221 a low-frequency voltage signal having the above-described second pulse pattern, the voltage signal being supplied as a BURN_IN signal. The transmitter-receiver circuit 221 drives the light emitting element 223 in accordance with the BURN_IN signal. In other words, when a value of the BURN_IN signal is a high level, the light emitting element 223 is on, and when the value of the BURN_IN signal is a low level, the light emitting element 223 is off. In this way, a low-frequency optical signal having a second pulse pattern, i.e., the second test signal, is sent from the second connector 22 to the first connector 21 for a predetermined time period.

Step S2208: The control circuit 227 uses the indicator 228 to notify the user that the fault test has finished. For example, the control circuit 227 turns on the indicator 228 (which is an LED). Note here that connecting the auxiliary connector 23 to the host device 51 causes the fault test to be carried out. As such, an operator on a client device 52 side can easily visually determine that the auxiliary connector 23 has been connected to the host device 51 and that the fault test has finished by checking that the indicator 228 is on.

The above operations involve an example where the second connector 22 provides notification that the fault test has finished. Note, however, that this is a non-limiting example. The second connector 22 may use the indicator 228 to notify the user of whether or not a fault such as a break has occurred in the active optical cable 2. Details of operations carried out by the control circuit 227 in such a case are as described in one or more embodiments. In this way, an operator on the client device 52 side can easily visually determine whether a fault such as a break has occurred in the active optical cable 2, by checking whether the LED is on or blinking on and off.

The above-described operations involve an example in which the first test signal sent from the first connector 21 to the second connector 22 is a low-frequency optical signal. Note, however, that the first test signal is not limited to being a low-frequency optical signal. For example, the first test signal may be continuous light. In such a case, in step S2105, for the predetermined time period, the control circuit 217 of the first connector 21 can supply to the transmitter-receiver circuit 211 a BURN_IN signal having a constant high level. Even in such a case, in step S2204, the control circuit 227 of the second connector 22 can refer to the monitor signal IMON and determine whether or not the transmitter-receiver circuit 221 has received the first test signal.

Similarly, the above-described operations involve an example in which the second test signal sent from the second connector 22 to the first connector 21 is a low-frequency optical signal. Note, however, that the second test signal is not limited to being a low-frequency optical signal. For example, the second test signal may be continuous light. In such a case, in step S2207, for the predetermined time period, the control circuit 227 of the second connector 22 can supply to the transmitter-receiver circuit 221 a BURN_IN signal having a constant high level. Even in such a case, in step S2108, the control circuit 217 of the first connector 21 can refer to the monitor signal IMON and determine whether or not the transmitter-receiver circuit 211 has received the second test signal.

Variation 1

Discussed in one or more embodiments was an example configuration in which the fault test is carried out only in cases in which the state at commencement of operation (i.e., the state at the time point at which the first connector 21 or the auxiliary connector 23 is connected to the host device 51) is the state 5 or state 6 indicated in Table 1. Note, however, that the present invention is not limited to such a configuration. For example, it is possible to employ a configuration in which the fault test is carried out only in cases in which the state at commencement of operation is the state 2, the state 4, or the state 6 indicated in Table 1 (i.e., in cases where the second connector 22 is in an unconnected state at commencement of operation).

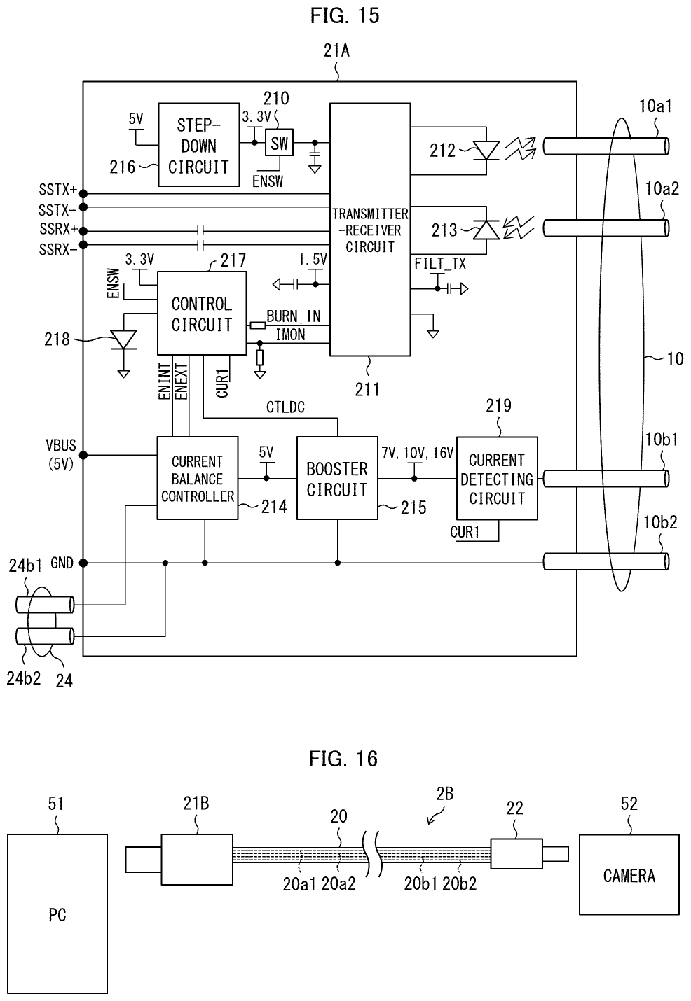

FIG. 15 illustrates a variation of the first connector 21 adapted for such a configuration. FIG. 15 is a block diagram illustrating an internal configuration of a first connector 21A in accordance with Variation 1.

The first connector 21A in accordance with Variation 1 is obtained by adding a current detecting circuit 219 to the first connector 21 illustrated in FIG. 11. The current detecting circuit 219 is for detecting the level of a current flowing into the power supply line 20b1 from the booster circuit 215. The current detecting circuit 219 provides to the control circuit 217 a monitor signal CUR1 which indicates the level of the current thus detected.

In a case where the second connector 22 is connected to the client device 52, there is an increase in the current flowing into the power supply line 20b1 from the booster circuit 215. As such, by referring to the monitor signal provided by the current detecting circuit 219, the control circuit 217 is able to determine whether or not the second connector 22 is connected to the client device 52 at commencement of operation. Replacing the first connector 21 with the first connector 21A of Variation 1 therefore makes it possible to achieve an active optical cable 2 in which the fault test is carried out only in a case where the second connector 22 is in an unconnected state at commencement of operation.

Note that, in comparison to a configuration in which the active optical cable 2 includes the first connector 21, a configuration in which the active optical cable 2 includes the first connector 21A has the advantage that an unconnected state of the second connector 22 can be detected as a state for which the fault test can be carried out. However, the first connector 21A requires the current detecting circuit 219, which is not included in the configuration of the first connector 21. In other words, in comparison to the first connector 21A, the first connector 21 has the advantage of having a simpler configuration. As such, the configuration in which the active optical cable 2 has the first connector 21A can be employed in applications where it is desirable to detect an unconnected state of the second connector 22 as a state for which the fault test can be carried out. The configuration in which the active optical cable 2 has the first connector 21 can be employed in application where it will suffice to be able to detect an unconnected state of the first connector 21 as a state for which the fault test can be carried out.

Variation 2

Discussed in Variation 1 was a configuration in which the fault test is carried out only in a case where the second connector 22 is in an unconnected state at commencement of operation. In such a configuration, the active optical cable 2 does not necessarily need to include the auxiliary connector 23 and the auxiliary cable 24. FIG. 16 illustrates an active optical cable 2B which is a variation of the active optical cable 2 in which variation the auxiliary connector 23 and the auxiliary cable 24 are omitted. With such a configuration, the fault test can be carried out in the active optical cable 2B in a case where the first connector 21 has been connected and the second connector 22 has not been connected.

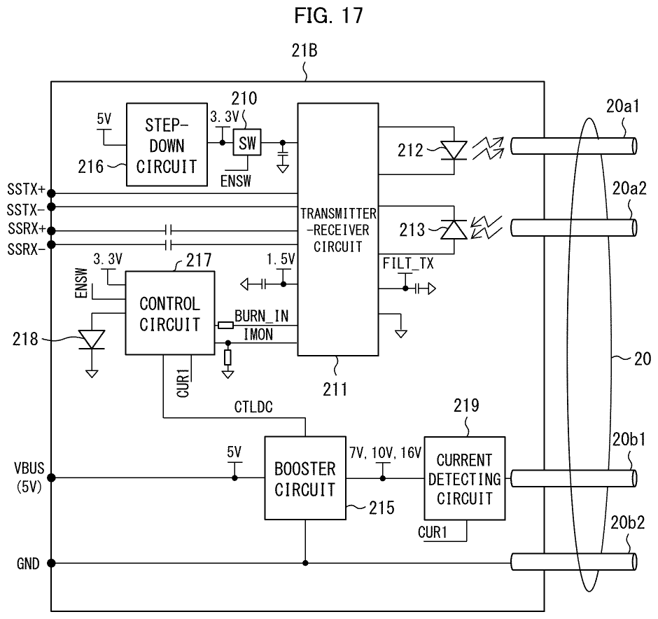

FIG. 17 is a block diagram illustrating an internal configuration of a first connector 21B included in the active optical cable 2B.

The first connector 21B in accordance with Variation 2 is obtained by omitting the auxiliary cable 24 and the current balance controller 214 from the first connector 21A illustrated in FIG. 15.

Once the first connector 21B is connected to the host device 51, power is supplied and the first connector 21B commences operation. At commencement of operation, similarly to the first connector 21A of Variation 1, the first connector 21B is capable of referring to the monitor signal CUR1 provided by the current detecting circuit 219 and thereby determining whether or not the second connector 22 is connected to the client device 52. This makes it possible to achieve the active optical cable 2B in which the fault test is carried out only in a case where the second connector 22 is in an unconnected state at commencement of operation.

Method of Fault Test in Variation 1 and Variation 2

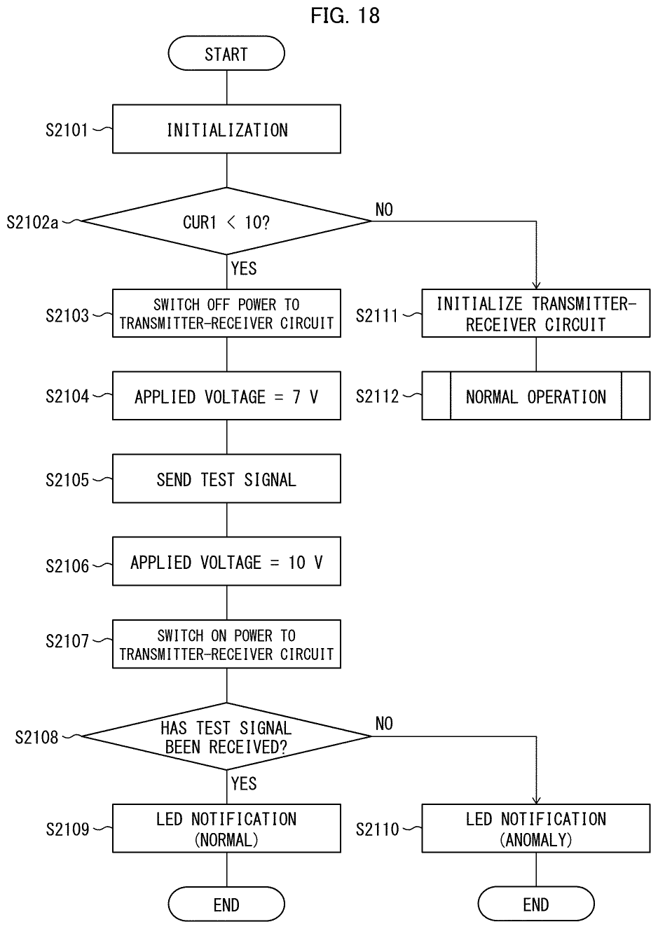

Next, with reference to FIG. 18, the following description will discuss operations of the first connector 21A and the first connector 21B during the fault tests in Variation 1 and Variation 2. FIG. 18 is a flowchart for explaining operations of the first connector 21A and the first connector 21B. The first connector 21A carries out the operations indicated in FIG. 18 immediately after the first connector 21A or the auxiliary connector 23 is connected to the host device 51. The first connector 21B carries out the operations indicated in FIG. 18 immediately after the first connector 21B is connected to the host device 51.

As illustrated in FIG. 18, the operations of the first connector 21A and the first connector 21B differ from the operations of the first connector 21 explained with reference to FIG. 13 in that the first connector 21A and the first connector 21B carry out the step S2102a instead of the step S2102. The step S2102a is a step of determining whether or not to carry out the fault test.

After the control circuit 217 has initialized itself in step S2101, the control circuit 217 proceeds to step S2102a, in which the control circuit 217 refers to the monitor signal CUR1 and determines whether or not the second connector 22 is connected to the client device 52. For example, the control circuit 217 determines that the second connector 22 is not connected to the client device 52 in a case where the CUR1 is less than 10 mA.

In a case where the second connector 22 is in an unconnected state, the control circuit 217 enters the fault test mode and carries out the above-described steps S2103 through S2110. In a case where the second connector 22 is in a connected state, the control circuit 217 does not enter the fault test mode, and instead carries out the above-described steps S2111 and S2112 and commences normal operation.

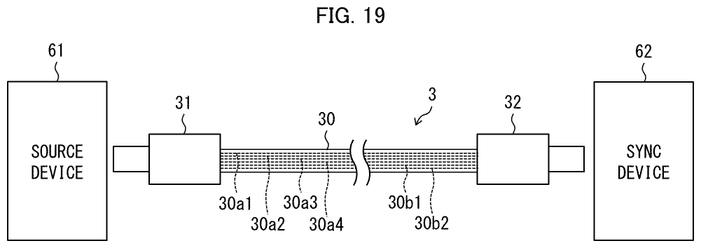

The following description will discuss an active optical cable in accordance with one or more embodiments of the present invention with reference to FIGS. 19 to 23.

Configuration of Active Optical Cable

With reference to FIG. 19, the following description will discuss a configuration of an active optical cable 3 in accordance with one or more embodiments. FIG. 19 is a block diagram illustrating a configuration of the active optical cable 3.

The active optical cable 3 is a cable for transmitting signals between two devices. The active optical cable 3 includes a composite cable 30, a first connector 31, and a second connector 32. In one or more embodiments, the active optical cable 3 is embodied as a high definition multimedia interface (HDMI; registered trademark) cable. Here, a device to which the first connector 31 is connected is referred to as a “source device” 61, and a device to which the second connector 32 is connected is called a “sync device” 62. The present discussion assumes that the source device 61 is a device that supplies a video signal and an audio signal. Possible examples of the source device 61 include a video camera and a video recorder (a video recording device having a function of replaying recorded video). The present discussion assumes that the sync device 62 is a device which uses a video signal and an audio signal obtained from the source device. Possible examples of the sync device 62 include a television and a projector. Note that although FIG. 19 illustrates a configuration for supplying a signal from a first connector 31 side to a second connector 32 side, the active optical cable 3 may further include a configuration for supplying a signal from the second connector 32 side to the first connector 31 side.

The first connector 31 is provided at a first end of the composite cable 30 and is for electrically connecting the active optical cable 3 to the source device 61. The first connector 31 converts into an optical signal an electric signal obtained from the source device 61, and sends that optical signal to the second connector 32. The first connector 31 also serves to connect a power supply line 30b1 and a ground line 30b2, each included in the composite cable 30, to a power supply and a ground of the source device 61, respectively. Note that in one or more embodiments, the first connector 31 is embodied as a type-A connector in conformance with HDMI standards. An internal configuration of the first connector 31 will be described below with reference to a different diagram.

The second connector 32 is provided at a second end of the composite cable 30 and is for electrically connecting the active optical cable 3 to the sync device 62. The second connector 32 converts an optical signal received from the first connector 31 into an electric signal and provides that electric signal to the sync device 62. The second connector 32 also serves to connect the power supply line 30b1 and the ground line 30b2, each included in the composite cable 30, to a load and a ground of the sync device 62, respectively. Note that in one or more embodiments, the second connector 32 is embodied as a type-A connector in conformance with HDMI standards. An internal configuration of the second connector 32 will be described below with reference to a different diagram.

The composite cable 30 includes therein optical fiber cords 30a1 through 30a4, in addition to the power supply line 30b1 and the ground line 30b2. The optical fiber cords 30a1 though 30a3 are signal lines for sending a video signal and an audio signal. The optical fiber cord 30a4 is a signal line for sending a clock signal. The power supply line 30b1 is connected to the power supply of the source device 61 via the first connector 31. The power supply line 30b1 is connected to the load of the sync device 62 via the second connector 32. The ground line 30b2 is connected to the ground of the source device 61 via the first connector 31. The ground line 30b2 is connected to the ground of the sync device 62 via the second connector 12.

Once the first connector 31 is connected to the source device 61, supply of power commences from the source device 61 to the first connector 31 and the second connector 32. Once the supply of power is commenced, control circuits in each of the first connector 31 and the second connector 32 are initialized, and operation of the active optical cable 3 is commenced. At this time, the active optical cable 3 will be in either state 7 or state 8 indicated in the following Table 2, in accordance with whether or not the second connector 32 is connected to the sync device 62. Note that in one or more embodiments, because connecting the first connector 31 to the source device 61 causes supply of power to the first connector 31 and second connector 32 to commenced, state 9 and state 10 indicated in Table 2 are not detected.

TABLE 2

| | State | | | |
|---|---|---|---|---|
| | State 7 | State 8 | State 9 | State 10 |
| First | Connected | Connected | Unconnected | Unconnected |
| connector | | | | |
| Second | Connected | Unconnected | Connected | Unconnected |
| connector | | | | |

In a case where the state at commencement of operation is state 7, there is a possibility that, immediately after commencement of operation, communication will be carried out between the source device 61 and the sync device 62. As such, depending on the state at commencement of operation, there are cases where a fault test cannot be carried out for the optical fiber cords 30a1 through 30a4. The active optical cable 3 in accordance with one or more embodiments therefore carries out a fault test only in a case where there the state at commencement of operation is the state 8 indicated in Table 1.

Internal Structure of First Connector

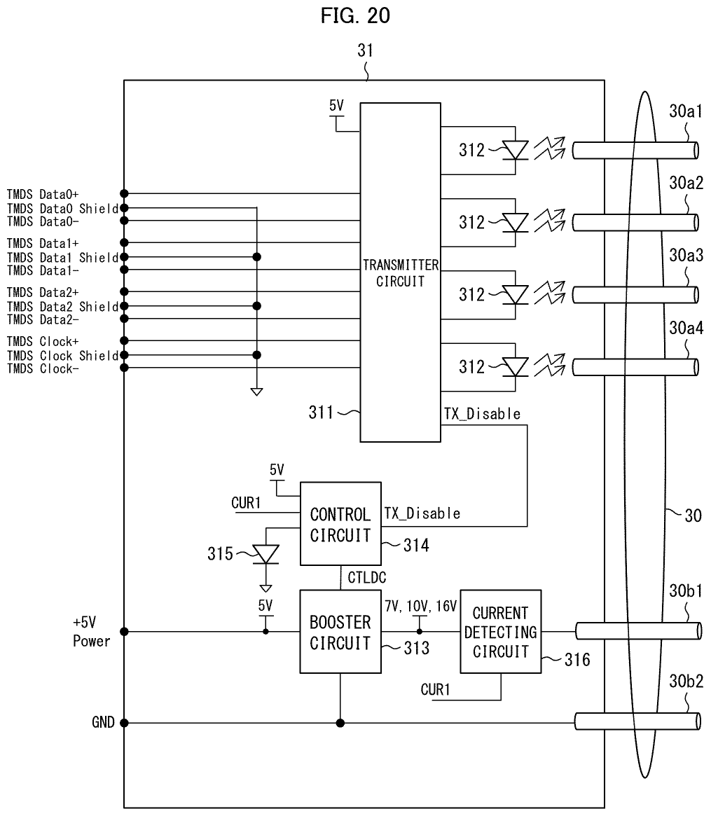

Next, with reference to FIG. 20, the following description will discuss an internal structure of the first connector 31 of the active optical cable 3 in accordance with one or more embodiments. FIG. 20 is a block diagram illustrating an internal structure of the first connector 31.

The first connector 31 includes a transmitter circuit 311, a light emitting element 312, a booster circuit 313, a control circuit 314, an indicator 315, and a current detecting circuit 316.

The transmitter circuit 311 converts each of four channels of differential voltage signals into a respective current signal, the differential voltage signals being inputted as transmission signals from the source device 61 into the first connector 31. Three out of the four channels are channels for transmitting signals representing video and audio. The differential voltage signal of a first channel (channel 0) is inputted via TMDS Data0+/TMDS Data0− terminals. The differential voltage signal of a second channel (channel 1) is inputted via TMDS Data1+/TMDS Data1− terminals. The differential voltage signal of a third channel (channel 2) is inputted via TMDS Data2+/TMDS Data2− terminals. The differential voltage signal of a fourth channel is a channel for transmitting the above-described clock signal. The differential voltage signal representing the clock signal is inputted via TMDS Clock+/TMDS Clock− terminals. Current signals obtained from these differential voltage signals are inputted into the light emitting element 312. The light emitting element 312 converts these current signal into respective optical signals. These optical signals are sent to the second connector 32 via the optical fiber cords 30a1 through 30a4.

In one or more embodiments, a vertical cavity surface emitting laser (VCSEL) is used as the light emitting element 312. In one or more embodiments, used as the transmitter circuit 311 is an integrated circuit (IC) which includes a VCSEL driver that converts a voltage signal (transmission signal) into a current signal (driving current) to be supplied to the light emitting element 312.

Once the first connector 31 is connected to the source device 61, current flowing in from a +5V power terminal is supplied to the transmitter circuit 311. The current detecting circuit 316 is for detecting the level of a current flowing into the power supply line 30b1 from the booster circuit 313. The current detecting circuit 316 provides to the control circuit 314 a monitor signal CUR1 which indicates the level of the current thus detected.

Once the first connector 31 is connected to the source device 61, the current flowing in from the +5V power terminal is also supplied to the power supply line 30b1 via the booster circuit 313. The booster circuit 313 is for controlling the voltage of the power supply line 30b1 to 7 V, 10 V, or 16 V.

At least the following signal is inputted into the control circuit 314: (1) the monitor signal CUR1. The control circuit 314 refers to the monitor signal CUR1 and controls the transmitter circuit 311 and the booster circuit 313. Specifically, the control circuit 314 determines, based on the monitor signal CUR1, whether or not the second connector 32 is connected to the sync device 62. Note here that in a case where the second connector 32 is connected to the sync device 62, there is an increase in the current flowing into the power supply line 30b1. As such, by referring to the monitor signal CUR1 provided by the current detecting circuit 316, the control circuit 314 is able to determine whether or not the second connector 32 is connected to the sync device 62 at commencement of operation. Specifically, for example, the control circuit 314 may determine that the second connector 32 is not connected to the sync device 62 in a case where the CUR1 is less than 10 mA. In one or more embodiments, a micro controller unit (MCU) is used as the control circuit 314.

A feature of the first connector 31 is a fault test carried out by the control circuit 314 with reference to the monitor signal CUR1 immediately after the first connector 31 is connected to the source device 61. In a case where the control circuit 314 has determined that the first connector 31 is connected to the source device 61 and the second connector 32 is not connected to the sync device 62, the control circuit 314 controls the transmitter circuit 311 and the booster circuit 313 so as to carry out the fault test. A method for the fault test will be described below with reference to a different diagram.

The indicator 315 is for example an LED, and is used for notifying a user of a result of the fault test.

Note that the first connector 31 carries out processes in accordance with various control signals obtained from the source device 61. These control signals are inputted/outputted via other terminal(s) (not illustrated), but illustrations of configurations for these other terminal(s) and detailed descriptions thereof are omitted in one or more embodiments.

Internal Structure of Second Connector

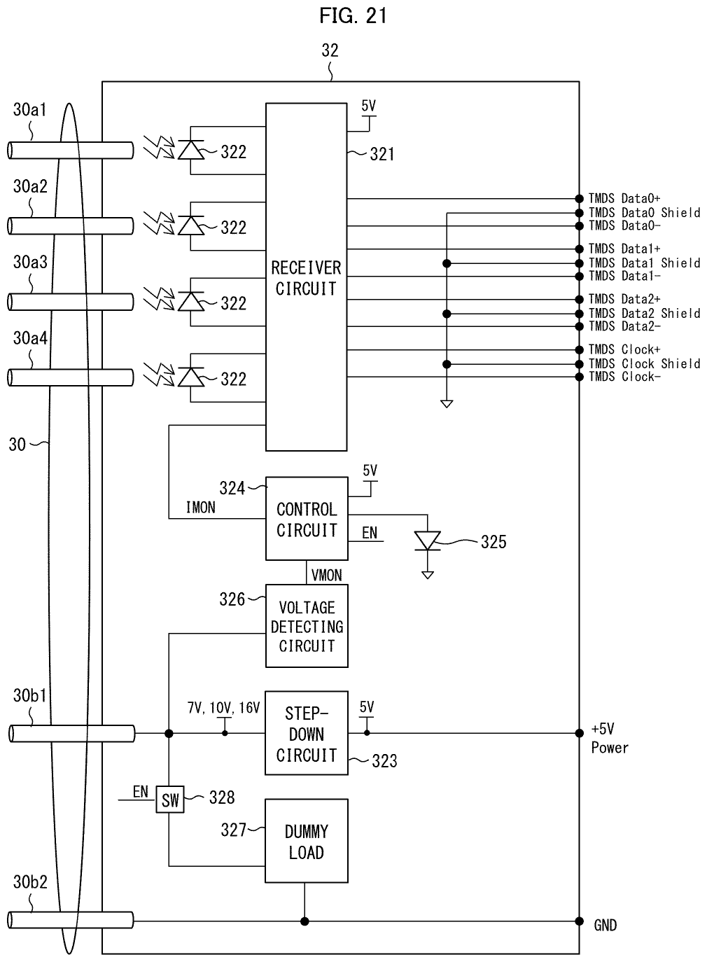

Next, with reference to FIG. 21, the following description will discuss an internal structure of the second connector 32 of the active optical cable 3 in accordance with one or more embodiments. FIG. 21 is a block diagram illustrating an internal structure of the second connector 32.

The second connector 32 includes a receiver circuit 321, a light receiving element 322, a step-down circuit 323, a control circuit 324, an indicator 325, a voltage detecting circuit 326, a dummy load 327, and a switch 328.

The light receiving element 322 converts, into respective current signals, optical signals received from the first connector 31 via the optical fiber cords 30a1 through 30a4. These current signals are supplied to the receiver circuit 321. The receiver circuit 321 converts these current signal into respective differential voltage signals. A first differential voltage signal is outputted via TMDS Data0+/TMDS Data0− terminals. A second differential voltage signal is outputted via TMDS Data1+/TMDS Data1− terminals. A third differential voltage signal is outputted via TMDS Data2+/TMDS Data2− terminals. These three differential voltage signals represent video and audio. A fourth differential voltage signal is outputted via TMDS Clock+/TMDS Clock− terminals. This fourth differential voltage signal represents a clock signal.

In one or more embodiments, a photodiode (PD) is used as the light receiving element 322. In one or more embodiments, used as the receiver circuit 321 is an integrated circuit (IC) including a transimpedance amplifier (TIA) which converts a current signal (photocurrent) supplied from the light receiving element 322 into a voltage signal (received signal). Note also that the receiver circuit 321 includes therein a current mirror circuit (not illustrated) which copies the current signal obtained by the light receiving element 322. The current signal obtained by the current mirror circuit is supplied to the control circuit 324 as a monitor signal IMON.

The step-down circuit 323 converts (steps down) a second voltage V2 applied to the power supply line 30b1 into a first voltage V1, which is lower than a second voltage V2. In one or more embodiments, the second voltage V2 applied to the power supply line 30b1 is 7 V, 10 V, or 16 V, and the first voltage V1 obtained by the step-down circuit 323 is 5 V. The first voltage V1 obtained by the step-down circuit 323 is applied to the receiver circuit 321, the control circuit 324, and the +5V Power terminal. Note that the second voltage V2 applied to the power supply line 30b1 is detected by the voltage detecting circuit 326. The voltage detecting circuit 326 supplies to the control circuit 324 a monitor signal VMON which indicates the voltage thus detected.

At least the following signals are inputted into the control circuit 324: (1) the monitor signal VMON that indicates the voltage applied to the power supply line 30b1; and (2) the monitor signal IMON, which indicates a strength of a current signal (photocurrent) obtained by the light receiving element 322. The control circuit 324 refers to these monitor signals and controls whether the switch 328 is on or off. In one or more embodiments, a micro controller unit (MCU) is used as the control circuit 324.

The dummy load 327 is connected to the power supply line 30b1. The switch 328 is provided between the dummy load 327 and the power supply line 30b1. In a case where the switch 328 is in an on state, a current (for example, a maximum of 10 mA) flows from the power supply line 30b1 to the dummy load 327. In a case where the switch 328 is in an off state, no current flows from the power supply line 30b1 to the dummy load 327. Note that the switch 328 is in an off state at commencement of operation.

A feature of the second connector 32 is a fault test carried out by the control circuit 324 with reference to the monitor signals VMON and IMON immediately after the first connector 31 is connected to the source device 61. The indicator 325 is for example an LED, and is used for notifying a user of a status of the fault test. A method for the fault test will be described below with reference to a different diagram.

Method of Fault Test

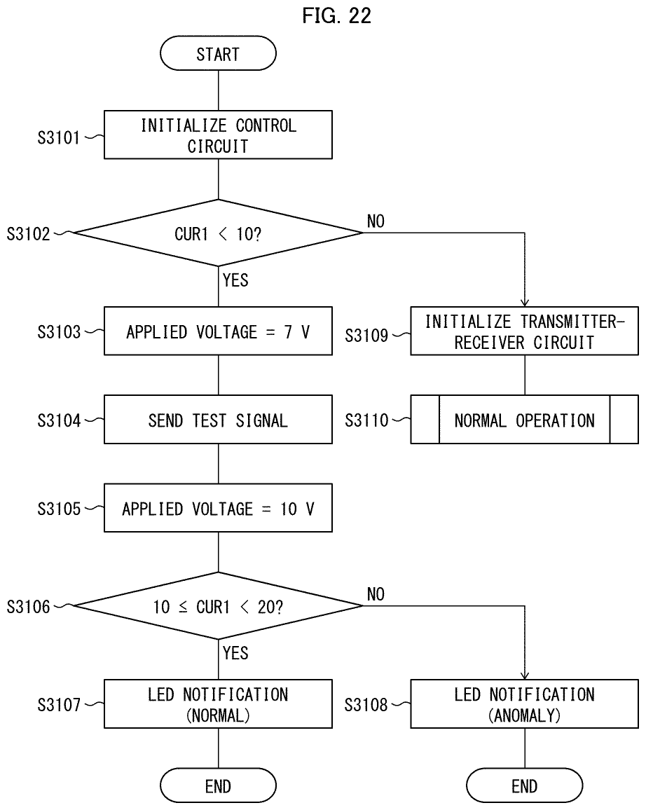

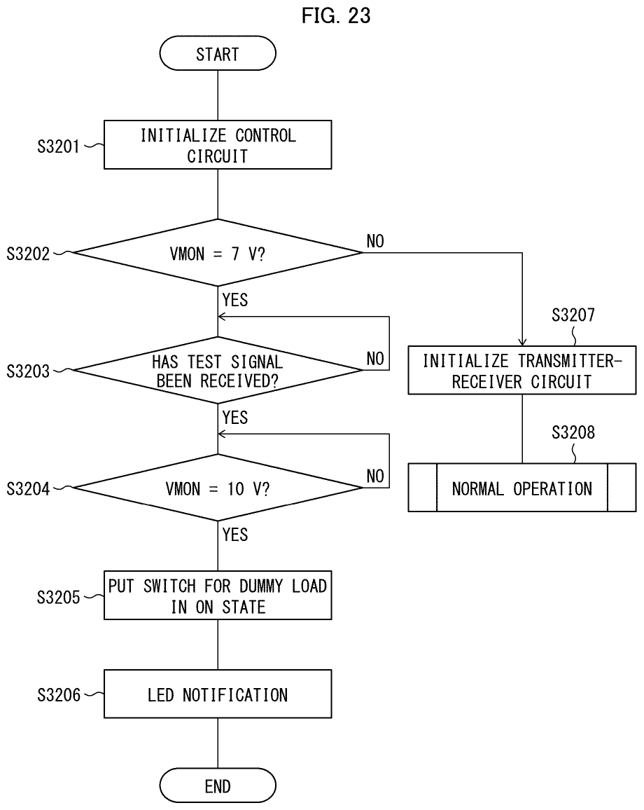

Next, with reference to FIGS. 22 and 23, the following description will discuss the fault test carried out in the active optical cable 3 of one or more embodiments immediately after the first connector 31 is connected to the source device 61. FIG. 22 is a flowchart indicating operations of the first connector 31 during the fault test. FIG. 23 is a flowchart indicating operations of the second connector 32 during the fault test.

First, operations of the first connector 31 are discussed with reference to FIG. 22. In a case where the first connector 31 is connected to the source device 61, the first connector 31 carries out the below-described steps (indicated in FIG. 22).

Step S3101: Once the first connector 31 is connected to the source device 61, the control circuit 314 starts up. The control circuit 314 first initializes itself.

Step S3102: Next, the control circuit 314 refers to the monitor signal CUR1 and determines whether or not the second connector 32 is connected to the sync device 62. In a case where the second connector 32 is in an unconnected state, the control circuit 314 enters the fault test mode and carries out steps S3103 through S3108 described below.

In a case where the second connector 32 is in a connected state, the control circuit 314 does not enter the fault test mode, and instead initializes the transmitter circuit 311 in step S3109 and then commences normal operation in step S3110.

Step S3103: The control circuit 314 uses a control signal CTLDC to instruct the booster circuit 313 to set the voltage applied to the power supply line 30b1 to 7 V. The booster circuit 313 changes the voltage applied to the power supply line 30b1 from 16 V to 7 V.

Step S3104: For a predetermined time period, the control circuit 314 supplies to the transmitter circuit 311 a low-frequency voltage signal having a predetermined first pulse pattern, the voltage signal being supplied as a TX_Disable signal. The transmitter circuit 311 drives the light emitting element 312 in accordance with the TX_Disable signal. In other words, when a value of the TX_Disable signal is a low level, the light emitting element 312 is on, and when the value of the TX_Disable signal is a high level, the light emitting element 312 is off. In this way, a low-frequency optical signal having the first pulse pattern is sent during a predetermined time period from the first connector 31 to the second connector 32. This optical signal is hereinafter referred to as a “test signal”.

Step S3105: The control circuit 314 uses the control signal CTLDC to instruct the booster circuit 313 to set the voltage applied to the power supply line 30b1 to 10 V. The booster circuit 313 changes the voltage applied to the power supply line 30b1 from 7 V to 10 V.

As will be described later, changing the voltage of the power supply line 30b1 to 7 V serves as a trigger for the second connector 32 to enter the fault test mode. Once the second connector 32 has received the test signal in the fault test mode, changing the voltage of the power supply line 30b1 to 10 V serves as a trigger for the second connector 32 to control the switch 328 from an off state to an on state. This causes current to flow to the dummy load 327 and increases the current flowing into the power supply line 30b1.

Step S3106: the control circuit 314 refers to the monitor signal CUR1 and determines whether or not the current flowing into the power supply line 30b1 has increased. Specifically, for example, the control circuit 314 may determine that the current flowing into the power supply line 30b1 has increased in a case where the CUR1 has become a value that is less than 20 mA and not less than 10 mA. In a case where the current flowing into the power supply line 30b1 has increased, presumably no fault (such as a break) has occurred in the optical fiber cords 30a1 through 30a4. In such a case, the control circuit 314 carries out step S3107 described below. However, in a case where the current flowing into the power supply line 30b1 has not increased, presumably a fault such as a break has occurred in one or more of the optical fiber cords 30a1 through 30a4. In such a case, the control circuit 314 carries out step S3108 described below.

Step S3107: The control circuit 314 uses the indicator 315 to notify the user that no fault (such as a break) has occurred in the optical fiber cords 30a1 through 30a4. For example, the control circuit 314 turns on the indicator 315.

Step S3108: The control circuit 314 uses the indicator 315 to notify the user that a fault such as a break has occurred in one or more of the optical fiber cords 30a1 through 30a4. For example, the control circuit 314 causes the indicator 315 to blink on and off. In this way, an operator on a source device 61 side can easily visually determine whether a fault has occurred in the active optical cable 3, by checking whether the LED is on or blinking on and off.

Next, the following description will discuss operations of the second connector 32 with reference to FIG. 23. In a case where the first connector 31 is connected to the source device 61, the second connector 32 carries out the below-described steps (indicated in FIG. 23).

Step S3201: Once the first connector 31 is connected to the source device 61, the control circuit 324 starts up. The control circuit 324 first initializes itself.

Step S3202: The control circuit 324 refers to the monitor signal VMON and determines whether or not the voltage of the power supply line 30b1 has changed to 7 V. In a case where the voltage of the power supply line 30b1 has changed to 7 V within a predetermined time period, the control circuit 324 enters the fault test mode and carries out steps S3203 through S3206 described below.

Note that in a case where the voltage of the power supply line 30b1 has not changed to 7 V within the predetermined time period, the control circuit 324 does not enter the fault test mode, and instead initializes the receiver circuit 321 in step S3207 and then commences normal operation in step S3208.

Step S3203: The control circuit 324 refers to the monitor signal IMON and determines whether or not the receiver circuit 321 has received the test signal. In a case where the test signal has been received within a predetermined time period, the control circuit 324 carries out step S3204 described below.

Step S3204: The control circuit 324 refers to the monitor signal VMON and determines whether or not the voltage of the power supply line 30b1 has changed to 10 V. In a case where the voltage of the power supply line 30b1 has changed to 10 V within a predetermined time period, the control circuit 324 carries out step S3205 described below.

Step S3205: The control circuit 324 uses a control signal EN to put the switch 328 into a state of electrical continuity. This causes current to flow to the dummy load 327. As a result, it is detected on a first connector 31 side that the current flowing into the power supply line 30b1 has increased, as described above.

Step S3206: The control circuit 324 uses the indicator 325 to notify the user that the fault test has finished. For example, the control circuit 324 turns on the indicator 325 (which is an LED). Note here that connecting the first connector 31 to the source device 61 causes the fault test to be carried out. As such, an operator on a sync device 62 side can easily visually determine that the first connector 31 has been connected to the source device 61 and that the fault test has finished by checking that the indicator 325 is on.

The above operations involve an example where the second connector 32 provides notification that the fault test has finished. Note, however that this is a non-limiting example. The second connector 32 may use the indicator 325 to notify the user of whether or not the test signal was received successfully. Details of operations carried out by the control circuit 324 in such a case are as described in one or more embodiments. In this way, an operator on the sync device 62 side can easily visually determine whether a fault such as a break has occurred in the active optical cable 3, by checking whether the LED is on or blinking on and off.

Furthermore, the above operations involve an example where the switch 328 is in an off state at commencement of operation. This is a non-limiting example, however, and the switch 328 may be in an on state at commencement of operation. In such a case, once the control circuit 324 of second connector 32 has received the test signal in the fault test mode, changing the voltage of the power supply line 30b1 to 10 V serves as a trigger for the control circuit 324 to control the switch 328 from an on state to an off state. This causes current flowing to the dummy load 327 to be cut off and decreases the current flowing into the power supply line 30b1. As such, after sending the test signal and setting the voltage to be applied to the power supply line 30b1 to 10 V, the control circuit 314 of the first connector 31 can refer to the monitor signal CUR1 and determine whether or not the current flowing into the power supply line 30b1 has decreased. In a case where the current flowing into the power supply line 30b1 has decreased, presumably no fault (such as a break) has occurred in the optical fiber cords 30a1 through 30a4. In a case where the current flowing into the power supply line 30b1 has not decreased, presumably a fault such as a break has occurred in one or more of the optical fiber cords 30a1 through 30a4.

Variation

Discussed in one or more embodiments above was an example configuration in which the fault test is carried out only in cases in which the state at commencement of operation (i.e., the state at a time point at which the first connector 31 is connected to the source device 61) is the state 8 indicated in Table 2. Note, however, that the present invention is not limited to such a configuration. For example, the active optical cable 3 may further include an auxiliary connector and an auxiliary cable. For example, the auxiliary connector may be a connector provided at a first end of the composite cable 30, for electrically connecting the active optical cable 3 to the source device 61. For example, the auxiliary cable may include therein an auxiliary power supply line and a ground line for connecting the power supply line 30b1 and the ground line 30b2 to the source device 61. In such a case, the first connector 31 and the second connector 32 can commence operation also in a case where the auxiliary connector is connected to the source device 61. Further, in such a case, a configuration may be employed in which the control circuit 314 is supplied with (i) a monitor signal VMON1 indicating a voltage applied to the +5V Power terminal and (ii) a monitor signal VMON2 indicating a voltage applied to the auxiliary power supply line. The configuration of this variation enables the control circuit 314 of the first connector 31 to detect the states 1 through 6 indicated in Table 1.

In such a case, the first connector 31 can be configuration to determine, in step S3102 of FIG. 22, whether or not at least one of the first connector 31 and the second connector 32 is in an unconnected state. This makes it possible to employ a configuration in which the fault test is carried out only in a case in which the state at commencement of operation is the state 2, state 4, state 5, or state 6 indicated in Table 1 (i.e., a case in which at least one of the first connector 31 and the second connector 32 is in an unconnected state at commencement of operation).

Note that the descriptions of one or more embodiments above involve examples in which LEDs served as the indicators of the first connector and the second connector. Note, however, that the indicators of the various embodiments are not limited to being LEDs. For example, the indicator may be any of a variety of output devices capable of providing notification of information indicating the results of the fault test. Possible examples include a display device and a speaker.

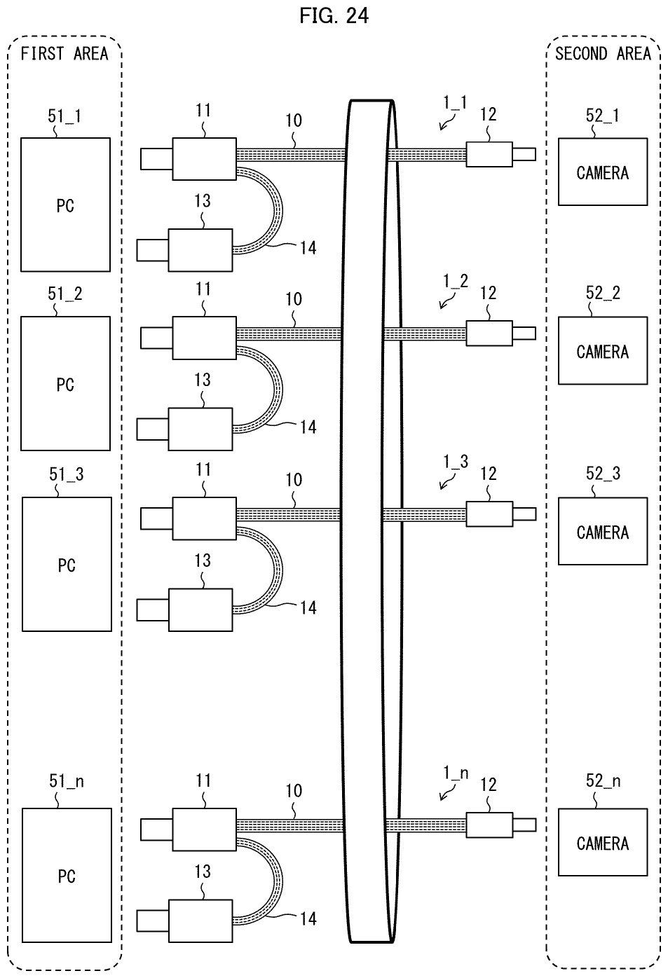

With reference to FIGS. 24 to 26, the following description will discuss, as one or more embodiments of the present invention, a method of wiring for a plurality of active optical cables. Discussed in one or more embodiments below is an example in which each of the plurality of active optical cables is the active optical cable 1 in accordance with one or more embodiments discussed above. Note, however, that even in a case where an active optical cable in accordance with another embodiment is used as one or more of the plurality of active optical cables, one or more embodiments can still be carried out in a similar manner. In such a case, it is not necessary for each of the plurality of active optical cables to be an active optical cable of the same embodiment.

FIG. 24 is a diagram schematically illustrating a configuration of an active optical cable system 4 which is constituted by a plurality of the active optical cables 1, which are to be used in wiring in one or more embodiments. As illustrated in FIG. 24, an n number of active optical cables 1 (where n is an integer greater than or equal to 2) have been laid in a pipe between a first area and a second area. An n or more number of host devices 51 are provided in the first area. An n or more number of client devices 52 are provided in the second area. In the first area, a first operator carries out work such as connecting first connectors 11 to respective ones of the host devices 51. In the second area, a second operator carries out work such as connecting second connectors 12 to respective ones of the client devices 52. It is assumed here that, with regard to the appropriate combination of host device 51 and client device 52 to be connected by each active optical cable 1, the order of connection is determined in advance. Hereinafter, a host device 51 and a client device 52 which are ordered i-th in terms of connection order are denoted as a host device 51_i and a client device 52_i, respectively. Furthermore, an active optical cable 1 used for connecting the host device 51_i and the client device 52_i is denoted as an active optical cable 1_i.

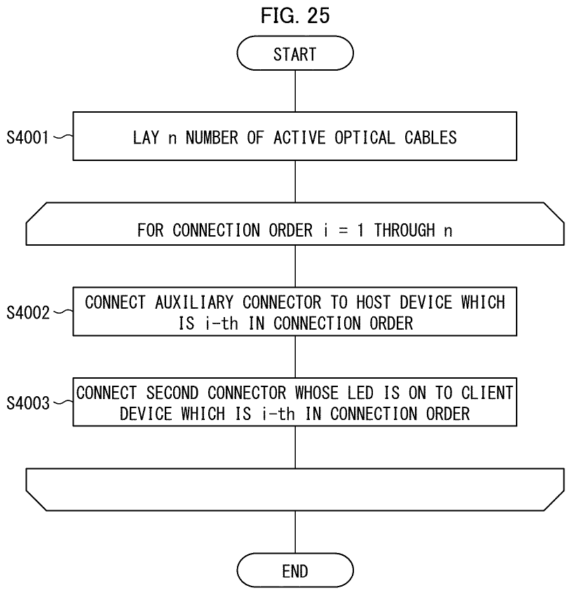

With reference to FIG. 25, the following description will discuss a method of wiring for the n number of active optical cables 1_1 through 1_n in the active optical cable system 4 configured as above. FIG. 25 is a flowchart indicating a method of wiring for the n number of active optical cables 1_1 through 1_n.

Step S4001: The n number of active optical cables 1_1 through 1_n are laid together in a pipe by the first operator and the second operator. Each of the active optical cables 1_i is laid such that the first connector 11 is provided in the first area and the second connector 12 is provided in the second area.

Step S4002: In the first area, the first operator connects an auxiliary connector 13 of the active optical cable 1_1 to a host device 51_1. This causes supply of power to the active optical cable 1_1 to commence. The active optical cable 1_1 carries out a fault test in the manner described in one or more embodiments. Once the fault test has finished, a second connector 12 of the active optical cable 1_1 uses an indicator 128 to provide notification that the fault test has finished.

Step S4003: In the second area, the second operator identifies, out of the n number of active optical cables 1_1 through 1_n, the active optical cable 1_1 which is using the indicator 128 of the second connector 12 to provide notification that the fault test has finished. The second operator then connects the second connector 12 of the active optical cable 1_1 to a client device 52_1.

Thereafter, step S4002 and step S4003 are repeated for each of the active optical cable 1_2 through 1_n, so that wiring for the n number of active optical cables 1_1 through 1_n is finished.

In this way, the wiring method in accordance with one or more embodiments makes it possible to easily identify, in the second area, which active optical cable out of the n number of active optical cables 1_1 through 1_n has been connected in the first area. As such, using a plurality of the active optical cables 1_1 through 1_n makes it possible to connect appropriate combinations of the plurality of host devices 51_1 through 51_n and the client devices 52_1 through 52_n. One or more embodiments are particularly effective in cases where the first area in which the host devices 51 are provided is spatially distanced from the second area in which the client devices 52 are provided.

Discussed in one or more embodiments is an example in which an n number of host devices 51 and client devices 52 are connected by an n number of active optical cables 1. Note, however, that the number of host devices 51, the number of client devices 52, and the number of active optical cables 1 do not need to be the same. For example, there may be cases in which a single host device 51 has an interface to which a plurality of active optical cables 1 can be connected. There may also be cases in which a single client device 52 has an interface to which a plurality of active optical cables 1 can be connected. In such cases, one need only determine in advance the connection order for each combination of a connector of a host device 51 and a connector of a client device 52, which combination should be connected by one active optical cable 1. In such a case, one or more embodiments can be carried out in the manner described above by treating each relevant connector of the host device 51 as the “host device 51” mentioned in the above descriptions, and by treating each relevant connector of the client device 52 as the “client device 52” mentioned in the above descriptions.

Variation

In one or more embodiments, it is not essential that the active optical cables 1 provide notification that the fault test has finished.

For example, instead of providing notification that the fault test has finished, the second connector 12 may be configured to provide notification that the first connector 11 has been connected to the host device 51. Specifically, in a case where the control circuit 127 of the second connector 12 has determined, based on the monitor signal VMON, that a voltage has been applied to the power supply line 10b1, the control circuit 127 may use the indicator 128 to provide notification that the connection has been made.

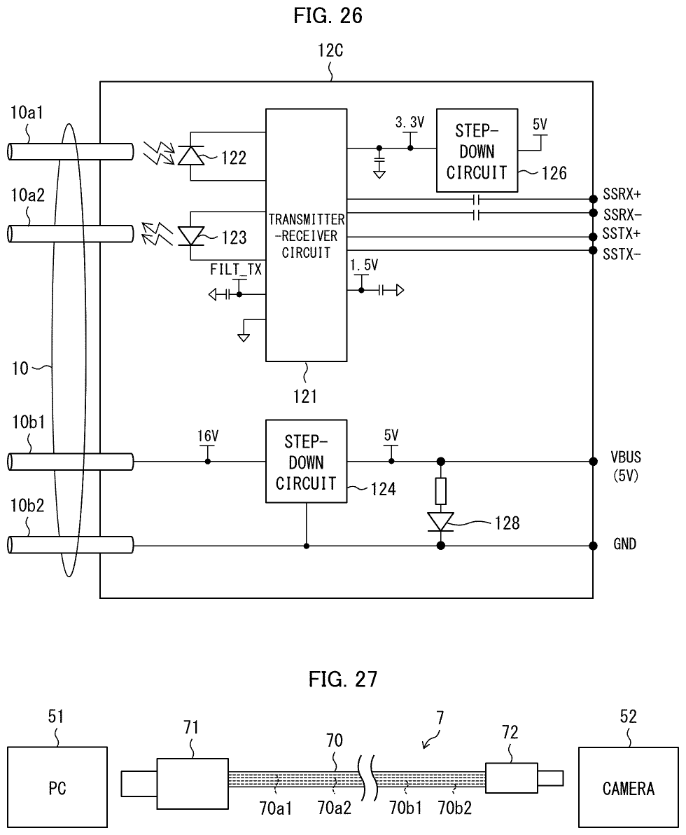

Furthermore, in a configuration as above where notification that the fault test has finished is not provided, the active optical cable 1 may include a second connector 12C instead of the second connector 12. FIG. 26 is a block diagram illustrating an internal configuration of the second connector 12C. As illustrated in FIG. 26, the second connector 12C has a configuration which is obtained by modifying the second connector 12 by (i) omitting the control circuit 127 and the current limiter 125 from the second connector 12 and (ii) connecting the indicator 128 to an output terminal (5 V) of the step-down circuit 124 via a resistor. Note that the indicator 128 may be connected to an input terminal (16 V) of the step-down circuit 124 (in other words, to the power supply line 10b1) via a resistor.

Furthermore, in such a case, the active optical cable 1 may omit the fault test. In such a case, the active optical cable 1 may be configured to include, in the place of the first connector 11, a typical conventional connector.

In a wiring method for such a variation, in step S4002, once the first operator connects the auxiliary connector 13 to the host device 51, voltage is supplied to the power supply line 10b1 via the auxiliary power supply line 14b1, and the indicator 128 of the second connector 12C turns on. Then, in step S4003, the second operator identifies which of the active optical cables 1 has an indicator 128 that is turned on so as to provide notification that connection has been achieved in the first area.

In this way, the second operator can easily identify, in the second area, which active optical cable out of the n number of active optical cables 1_1 through 1_n has been connected in the first area.

One or more embodiments bring about the effect of making it possible to connect appropriate combinations of host devices and client devices even when using a plurality of active optical cables 1 modified to have a simpler configuration as described above.

The following description will discuss an active optical cable in accordance with one or more embodiments of the present invention with reference to FIGS. 27 to 31.

Configuration of Active Optical Cable

With reference to FIG. 27, the following description will discuss a configuration of an active optical cable 7 in accordance with one or more embodiments. FIG. 27 is a block diagram illustrating a configuration of the active optical cable 7.

The active optical cable 7 is a cable for achieving bidirectional communication between two devices. The active optical cable 7 includes a composite cable 70, a first connector 71, and a second connector 72. The composite cable 70, first connector 71, and second connector 72 included in the active optical cable 7 of one or more embodiments are configured similarly to the composite cable 10, first connector 11, and second connector 12, respectively, included in the active optical cable 1 of one or more embodiments described above (see FIG. 1).

Once the first connector 71 is connected to a host device 51, supply of power from the host device 51 to the first connector 71 and to the second connector 72 is commenced. Once power supply from the host device 51 to the first connector 71 and the second connector 72 is commenced, control circuits in each of the first connector 71 and the second connector 72 are initialized, and operation of the active optical cable 7 is commenced. At this time, the active optical cable 7 will be in either state 7 or state 8 indicated in the above Table 2, in accordance with whether or not the second connector 72 is connected to a client device 52.

In a case where the state at commencement of operation is state 7, there is a possibility that, immediately after commencement of operation, communication will be carried out between the host device 51 and the client device 52. As such, depending on the state at commencement of operation, there are cases where a fault test cannot be carried out for an optical fiber cord 70a1 and an optical fiber cord 70a2. The active optical cable 7 in accordance with one or more embodiments therefore carries out a fault test only in a case where there the state at commencement of operation is the state 8 indicated in Table 2.

Internal Structure of First Connector

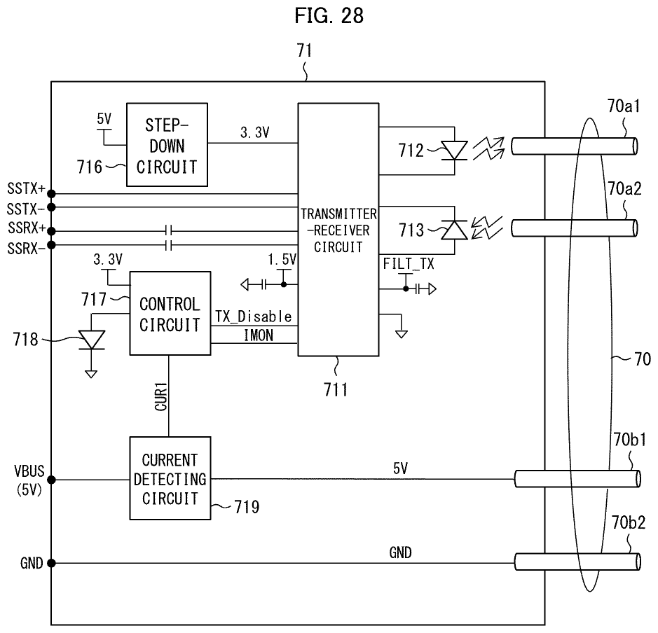

Next, with reference to FIG. 28, the following description will discuss an internal structure of the first connector 71 of the active optical cable 7 in accordance with one or more embodiments. FIG. 28 is a block diagram illustrating an internal structure of the first connector 71.

The first connector 71 includes a transmitter-receiver circuit 711, a light emitting element 712, a light receiving element 713, a step-down circuit 716, a control circuit 717, an indicator 718, and a current detecting circuit 719.

The transmitter-receiver circuit 711, light emitting element 712, light receiving element 713, step-down circuit 716, control circuit 717, and indicator 718 included in the first connector 71 are configured similarly to the transmitter-receiver circuit 111, light emitting element 112, light receiving element 113, step-down circuit 116, control circuit 117, and indicator 118, respectively, included in the first connector 11 of one or more embodiments (see FIG. 2). The current detecting circuit 719 is for detecting a current flowing into a power supply line 70b1 from the host device 51. The current detecting circuit 719 provides to the control circuit 717 a monitor signal CUR1 which indicates the level of the current thus detected. The control circuit 717 determines, based on the monitor signal CUR1, whether or not the second connector 72 is connected to the client device 52.

Note that a method for the fault test which utilizes the first connector 71 will be described below with reference to a different diagram.

Internal Structure of Second Connector

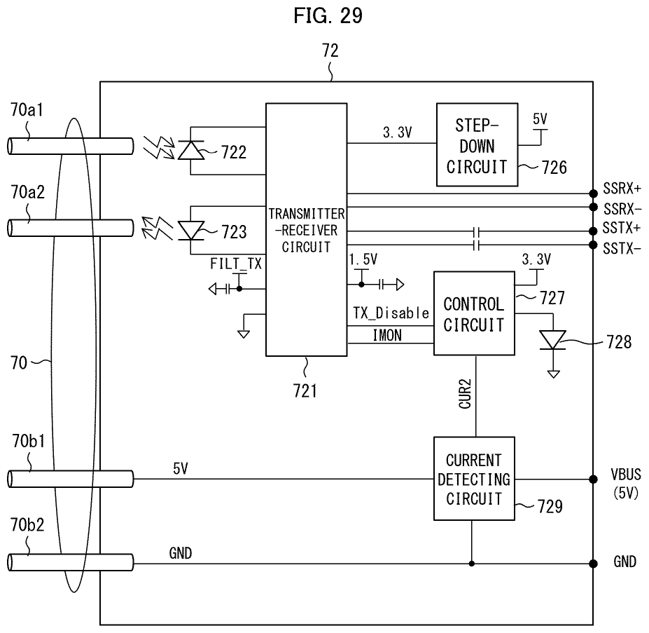

Next, with reference to FIG. 29, the following description will discuss an internal structure of the second connector 72 of the active optical cable 7 in accordance with one or more embodiments. FIG. 29 is a block diagram illustrating an internal structure of the second connector 72.

The second connector 72 includes a transmitter-receiver circuit 721, a light receiving element 722, a light emitting element 723, a step-down circuit 726, a control circuit 727, an indicator 728, and a current detecting circuit 729.

The transmitter-receiver circuit 721, light receiving element 722, light emitting element 723, step-down circuit 726, control circuit 727, and indicator 728 included in the second connector 72 are configured similarly to the transmitter-receiver circuit 121, light receiving element 172, light emitting element 123, step-down circuit 126, control circuit 127, and indicator 128, respectively, included in the second connector 12 of one or more embodiments (see FIG. 3). The current detecting circuit 729 is for detecting a current flowing from the power supply line 70b1 to the client device 52. The current detecting circuit 729 provides to the control circuit 727 a monitor signal CUR2 which indicates the level of the current thus detected. The control circuit 727 determines, based on the monitor signal CUR2, whether or not the second connector 72 is connected to the client device 52.

Note that a method for the fault test which utilizes the second connector 72 will be described below with reference to a different diagram.

Note although that one or more embodiments employ a configuration which detects the current flowing from the power supply line 70b1 to the client device 52 in order to determine whether or not the second connector 72 is connected to the client device 52, this is a non-limiting example. In other words, in order to determine whether or not the second connector 72 is connected to the client device 52, it is possible to employ a configuration which detects a voltage drop in the power supply line 70b1 and a ground line 70b2 included in the composite cable 70, which voltage drop occurs along with the flow of current from the power supply line 70b1 to the client device 52.

Method of Fault Test

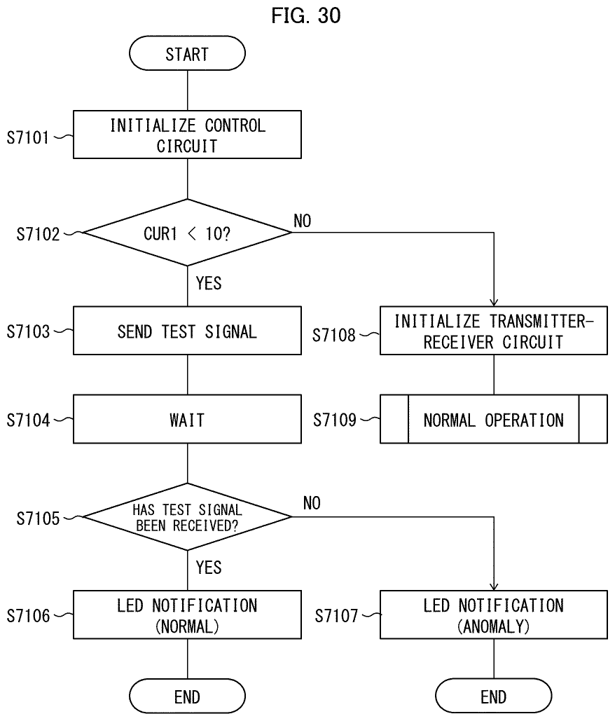

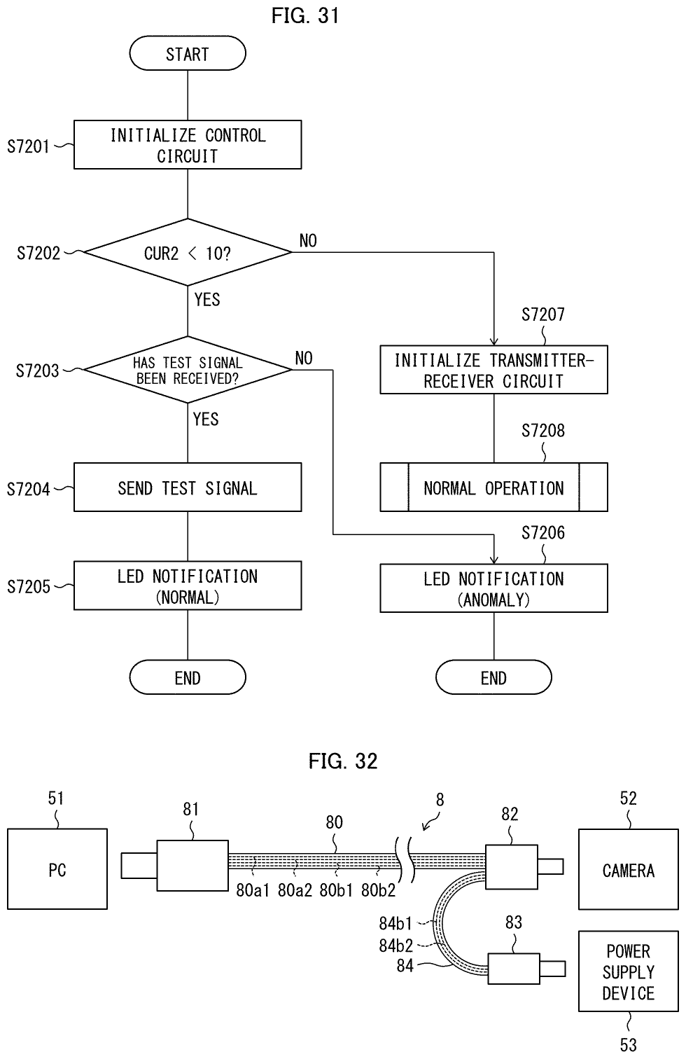

Next, with reference to FIGS. 30 and 31, the following description will discuss a fault test carried out in the active optical cable 7 of one or more embodiments immediately after the first connector 71 is connected to the host device 51. FIG. 30 is a flowchart indicating operations of the first connector 71 during the fault test. FIG. 31 is a flowchart indicating operations of the second connector 72 during the fault test.

In the active optical cable 7 in accordance with one or more embodiments, after the first connector 71 is connected to the host device 51, once the second connector 72 is connected to the client device 52, supply of power from the power supply line 70b1 to the client device 52 commences. As a result, there is an increase in current flowing from the host device 51 into the power supply line 70b1. As such, the first connector 71 can determine that the second connector 72 has been connected to the client device 52 by monitoring the current flowing from the host device 51 into the power supply line 70b1, and the second connector 72 can determine that the second connector 72 has been connected to the client device 52 by monitoring the current flowing from the power supply line 70b1 to the client device 52. The method for a fault test described below is based on this fact.

First, operations of the first connector 71 are discussed with reference to FIG. 30. In a case where the first connector 71 is connected to the host device 51, the first connector 71 carries out the below-described steps (indicated in FIG. 30).

Step S7101: Once the first connector 71 is connected to the host device 51, the control circuit 717 starts up. The control circuit 717 first initializes itself. Starting up of the control circuit 717 means that the first connector 71 is in a connected state.

Step S7102: The control circuit 717 refers to the monitor signal CUR1 (which indicates the level of the current flowing from the host device 51 into the power supply line 70b1) and determines whether or not the second connector 72 is connected to the client device 52. For example, the control circuit 717 may determine that the second connector 72 is not connected to the client device 52 in a case where the value of the monitor signal CUR1 is less than 10 mA, and determine that the second connector 72 is connected to the client device 52 in a case where the value of monitor signal CUR1 is greater than or equal to 10 mA.

In a case where it is determined in step S7102 that the second connector 72 is not connected to the client device 52, the control circuit 717 enters the fault test mode and carries out steps S7103 through S7109 described below. In a case where it is determined in step S7102 that the second connector 72 is connected to the client device 52, the control circuit 717 does not enter the fault test mode, and instead initializes the transmitter-receiver circuit 711 in step S7108 and then carries out normal operation in step S7109.

Step S7103: For a predetermined time period, the control circuit 717 supplies to the transmitter-receiver circuit 711 a low-frequency voltage signal having a predetermined first pulse pattern, the voltage signal being supplied as a TX_Disable signal. The transmitter-receiver circuit 711 drives the light emitting element 712 in accordance with the TX_Disable signal. In other words, when a value of the TX_Disable signal is a low level, the light emitting element 712 is on, and when the value of the TX_Disable signal is a high level, the light emitting element 712 is off. In this way, a low-frequency optical signal having the first pulse pattern is sent during a predetermined time period from the first connector 71 to the second connector 72. This optical signal is hereinafter referred to as a “first test signal”.

As will be described later, the current flowing from the power supply line 70b1 to the client device 52 exceeding a predetermined threshold value serves as a trigger for the second connector 72 to enter the fault test mode. Once the second connector 72 has received the first test signal in the fault test mode, the second connector 72 sends in response an optical signal having a predetermined second pulse pattern. This optical signal is hereinafter referred to as a “second test signal”. Note that the second pulse pattern may be the same pulse pattern as the first pulse pattern, or may be a pulse pattern differing from the first pulse pattern.

Step S7104: After the control circuit 717 has finished sending the first test signal, the control circuit 717 waits for a predetermined time period.

Step S7105: The control circuit 717 refers to a monitor signal IMON and determines whether or not the transmitter-receiver circuit 711 has received the second test signal. In a case where the second test signal has been received, presumably no fault (such as a break) has occurred in the first optical fiber cord 70a1 and the second optical fiber cord 70a2. In such a case, the control circuit 717 carries out step S7106 described below. However, in a case where the second test signal has not been received, presumably a fault such as a break has occurred in the first optical fiber cord 70a1 or the second optical fiber cord 70a2. In such a case, the control circuit 717 carries out step S7107 described below.

Step S7106: The control circuit 717 uses the indicator 718 to notify the user that no fault (such as a break) has occurred in the first optical fiber cord 70a1 and the second optical fiber cord 70a2. For example, the control circuit 717 turns on the indicator 718.

Step S7107: The control circuit 717 uses the indicator 718 to notify the user that a fault such as a break has occurred in the first optical fiber cord 70a1 or the second optical fiber cord 70a2. For example, the control circuit 717 causes the indicator 718 to blink on and off. In this way, an operator on a host device 51 side can easily visually determine whether a fault has occurred in the active optical cable 7, by checking whether the LED is on or blinking on and off.

Next, the following description will discuss operations of the second connector 72 with reference to FIG. 31. In a case where the first connector 71 is connected to the host device 51, the second connector 72 carries out the below-described steps (indicated in FIG. 31).

Step S7201: Once the first connector 71 is connected to the host device 51, the control circuit 727 starts up. The control circuit 727 first initializes itself.

Step S7202: The control circuit 727 refers to the monitor signal CUR2 (which indicates the level of the current flowing from the power supply line 70b1 to the client device 52) and determines whether or not the second connector 72 is connected to the client device 52. For example, the control circuit 727 may determine that the second connector 72 is not connected to the client device 52 in a case where the value of the monitor signal CUR2 is less than 10 mA, and determine that the second connector 72 is connected to the client device 52 in a case where the value of monitor signal CUR2 is greater than or equal to 10 mA.

In a case where it is determined in step S7202 that the second connector 72 is not connected to the client device 52, the control circuit 727 enters the fault test mode and carries out steps S7203 through S7206 described below. In a case where it is determined in step S7202 that the second connector 72 is connected to the client device 52, the control circuit 727 does not enter the fault test mode, and instead initializes the transmitter-receiver circuit 721 in step S7207 and then carries out normal operation in step S7208.

Step S7203: The control circuit 727 refers to the monitor signal IMON and determines whether or not the transmitter-receiver circuit 721 has received the first test signal. In a case where the first test signal has been received, presumably no fault (such as a break) has occurred in the first optical fiber cord 70a1. In such a case, the control circuit 727 carries out steps S7204 and S7205 described below. However, in a case where the first test signal has not been received, presumably a fault such as a break has occurred in the first optical fiber cord 70a. In such a case, the control circuit 727 carries out step S7106 described below.

Step S7204: For a predetermined time period, the control circuit 727 supplies to the transmitter-receiver circuit 721 a low-frequency voltage signal having the above-described second pulse pattern, the voltage signal being supplied as a TX_Disable signal. The transmitter-receiver circuit 721 drives the light emitting element 723 in accordance with the TX_Disable signal. In other words, when a value of the TX_Disable signal is a low level, the light emitting element 723 is on, and when the value of the TX_Disable signal is a high level, the light emitting element 723 is off. In this way, a low-frequency optical signal having a second pulse pattern, i.e., the second test signal, is sent from the second connector 72 to the first connector 71 for a predetermined time period.

Step S7205: The control circuit 727 uses the indicator 728 to notify the user that no fault (such as a break) has occurred in the first optical fiber cord 70a1. For example, the control circuit 727 turns on the indicator 728 (which is an LED).

Step S7206: The control circuit 727 uses the indicator 728 to notify the user that a fault such as a break has occurred in the first optical fiber cord 70a1. For example, the control circuit 727 causes the indicator 728 (which is an LED) to blink on and off. In this way, an operator on a client device 52 side can easily visually determine whether a fault has occurred in the active optical cable 7, by checking whether the LED is on or blinking on and off.

The following description will discuss an active optical cable in accordance with one or more embodiments of the present invention with reference to FIGS. 32 to 36.

Configuration of Active Optical Cable

With reference to FIG. 32, the following description will discuss a configuration of an active optical cable 8 in accordance with one or more embodiments. FIG. 32 is a block diagram illustrating a configuration of the active optical cable 8.

The active optical cable 8 is a cable for achieving bidirectional communication between two devices. The active optical cable 8 includes a composite cable 80, a first connector 81, and a second connector 82. The composite cable 80, first connector 81, and second connector 82 included in the active optical cable 8 of one or more embodiments are configured similarly to the composite cable 10, first connector 11, and second connector 12, respectively, included in the active optical cable 1 of one or more embodiments (see FIG. 1).

The active optical cable 8 further includes an auxiliary connector 83 (an example of the “second auxiliary connector” recited in the claims) and an auxiliary cable 84. The auxiliary connector 83 is for supplying power to a client device 52 via the second connector 82 and is connected to the second connector 82 via the auxiliary cable 84. The auxiliary connector 83 may be connected to, for example, a power supply device 53. In one or more embodiments, the auxiliary connector 83 is embodied as a Standard-A-type connector in conformance with USB standards. However, the auxiliary connector 83 need only be suitable for the power supply device 53 to which it is connected. For example, the auxiliary connector 83 may be a Micro-B-type connector in conformance with USB standards, or a connector in conformance with some standard other than USB standards. In one or more embodiments, the auxiliary connector 83 is provided not on a first connector 81 side, but rather on a second connector 82 side. Such a configuration makes it possible to supply power to the client device 52 through a route that does not pass through the composite cable 80. This obviates the need to consider a voltage drop in the composite cable 80 and makes it possible to reduce the diameter of the composite cable 80.

Once the first connector 81 is connected to a host device 51, supply of power from the host device 51 to the first connector 81 and to the second connector 82 is commenced. Once power supply from the host device 51 to the first connector 81 and the second connector 82 is commenced, control circuits in each of the first connector 81 and the second connector 82 are initialized, and operation of the active optical cable 8 is commenced. At this time, the active optical cable 8 will be in either state 7 or state 8 indicated in the above Table 2, in accordance with whether or not the second connector 82 is connected to the client device 52.

In a case where the state at commencement of operation is state 7, there is a possibility that, immediately after commencement of operation, communication will be carried out between the host device 51 and the client device 52. As such, depending on the state at commencement of operation, there are cases where a fault test cannot be carried out for an optical fiber cord 80a1 and an optical fiber cord 80a2. The active optical cable 8 in accordance with one or more embodiments therefore carries out a fault test only in a case where there the state at commencement of operation is the state 8 indicated in Table 2.

Internal Structure of First Connector

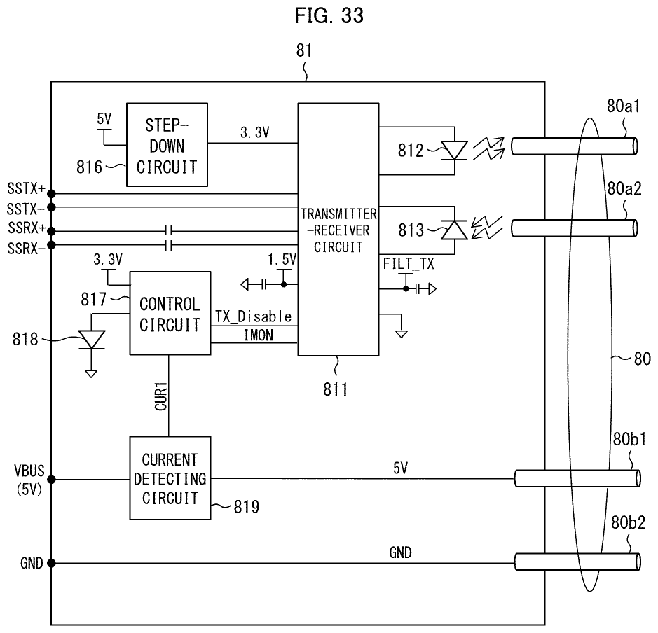

Next, with reference to FIG. 33, the following description will discuss an internal structure of the first connector 81 of the active optical cable 8 in accordance with one or more embodiments. FIG. 33 is a block diagram illustrating an internal structure of the first connector 81.

The first connector 81 includes a transmitter-receiver circuit 811, a light emitting element 812, a light receiving element 813, a step-down circuit 816, a control circuit 817, an indicator 818, and a current detecting circuit 819.

The transmitter-receiver circuit 811, light emitting element 812, light receiving element 813, step-down circuit 816, control circuit 817, and indicator 818 included in the first connector 81 are configured similarly to the transmitter-receiver circuit 111, light emitting element 112, light receiving element 113, step-down circuit 116, control circuit 117, and indicator 118, respectively, included in the first connector 11 of one or more embodiments (see FIG. 2). The current detecting circuit 819 is for detecting a current flowing into a power supply line 80b1 from the host device 51. The current detecting circuit 819 provides to the control circuit 817 a monitor signal CUR1 which indicates the level of the current thus detected. The control circuit 817 determines, based on the monitor signal CUR1, whether or not the second connector 82 is connected to the client device 52.

Note that a method for the fault test which utilizes the first connector 81 will be described below with reference to a different diagram.

Internal Structure of Second Connector

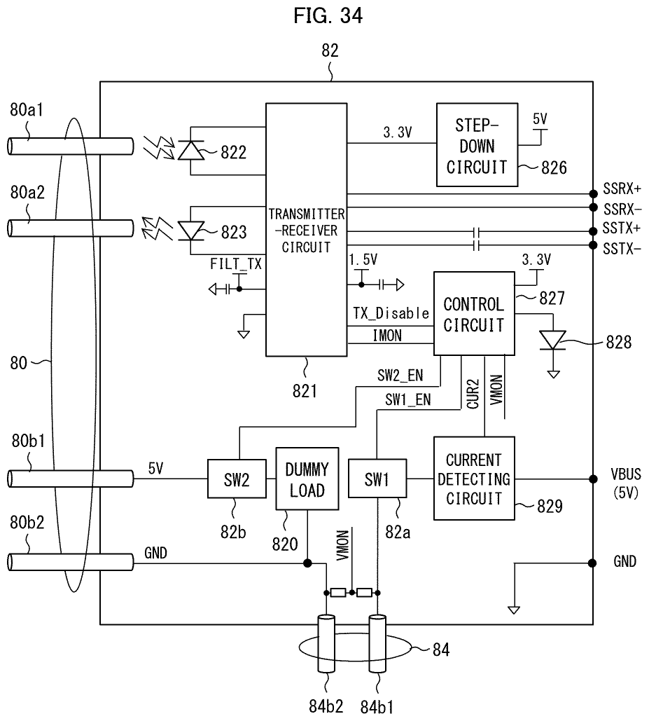

Next, with reference to FIG. 34, the following description will discuss an internal structure of the second connector 82 of the active optical cable 8 in accordance with one or more embodiments. FIG. 34 is a block diagram illustrating an internal structure of the second connector 82.

The second connector 82 includes a transmitter-receiver circuit 821, a light receiving element 822, a light emitting element 823, a step-down circuit 826, a control circuit 827, an indicator 828, a current detecting circuit 829, a first switch 82a, and a second switch 82b.

The transmitter-receiver circuit 821, light receiving element 822, light emitting element 823, step-down circuit 826, control circuit 827, and indicator 828 included in the second connector 82 are configured similarly to the transmitter-receiver circuit 121, light receiving element 122, light emitting element 123, step-down circuit 126, control circuit 127, and indicator 128, respectively, included in the second connector 12 of one or more embodiments (see FIG. 3). The current detecting circuit 829 is for detecting a current flowing from the power supply line 80b1 to the client device 52. The current detecting circuit 829 provides to the control circuit 827 a monitor signal CUR2 which indicates the level of the current thus detected. The control circuit 827 determines, based on the monitor signal CUR2, whether or not the second connector 82 is connected to the client device 52.

The first switch 82a is for allowing or cutting off supply of power to the client device 52 from an auxiliary power supply line 84b1 (an example of the “second auxiliary power supply line” recited in the claims) via a VBUS terminal. Opening and closing of the first switch 82a is controlled by the control circuit 827 with use of a control signal SW1_EN. Connection of the second connector 82 to the client device 52 serves as a trigger for the control circuit 827 to close the first switch 82a (i.e., to put the first switch 82a into an on state) so that supply of power from the auxiliary power supply line 84b1 to the client device 52 is commenced.

The second switch 82b is for allowing or cutting off supply of current to a dummy load 820 from the power supply line 80b1. Opening and closing of the second switch 82b is controlled by the control circuit 827 with use of a control signal SW2_EN. Connection of the second connector 82 to the client device 52 serves as a trigger for the control circuit 827 to close the second switch 82b (i.e., to put the second switch 82b into an on state) so that supply of current from the power supply line 80b1 to the dummy load 820 is commenced.

Note that a method for the fault test which utilizes the second connector 82 will be described below with reference to a different diagram.

Method of Fault Test

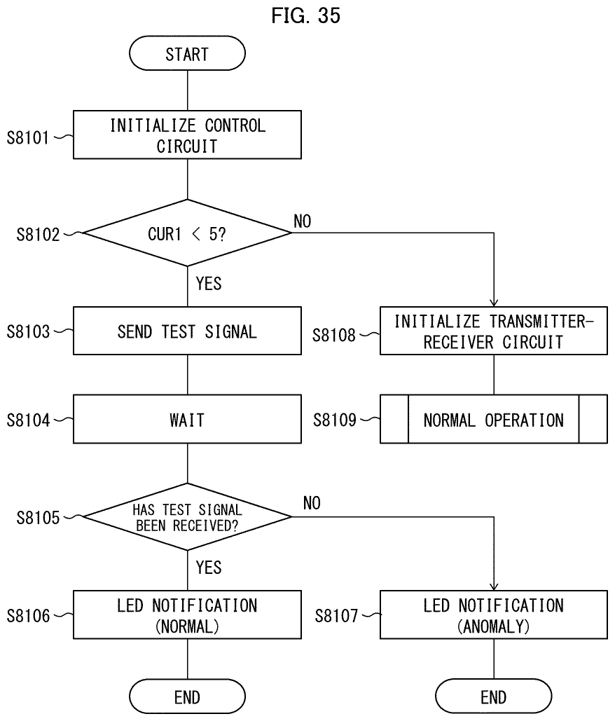

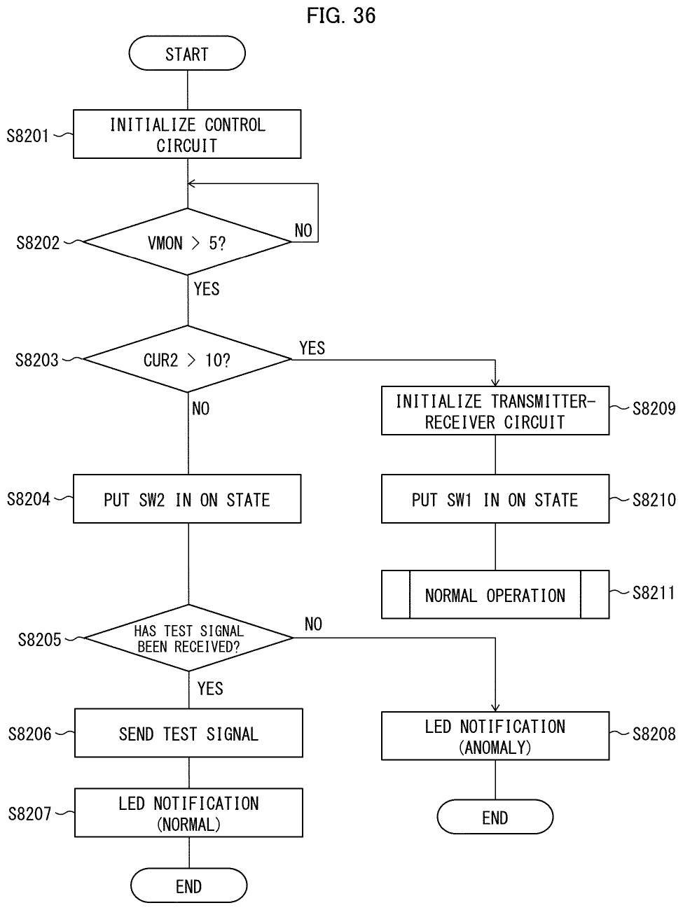

Next, with reference to FIGS. 35 and 36, the following description will discuss a fault test carried out in the active optical cable 8 of one or more embodiments immediately after the first connector 81 is connected to the host device 51. FIG. 35 is a flowchart indicating operations of the first connector 81 during the fault test. FIG. 36 is a flowchart indicating operations of the second connector 82 during the fault test.

In the active optical cable 8 in accordance with one or more embodiments, after the first connector 81 is connected to the host device 51, once the second connector 82 is connected to the client device 52, supply of power from the power supply line 80b1 to the dummy load 820 commences. As a result, there is an increase in current flowing from the host device 51 into the power supply line 80b1. As such, the first connector 81 can determine that the second connector 82 has been connected to the client device 52 by monitoring the current flowing from the host device 51 into the power supply line 80b1. The method for a fault test described below is based on this fact.

First, operations of the first connector 81 are discussed with reference to FIG. 35. In a case where the first connector 81 is connected to the host device 51, the first connector 81 carries out the below-described steps (indicated in FIG. 35).

Step S8101: Once the first connector 81 is connected to the host device 51, the control circuit 817 starts up. The control circuit 817 first initializes itself. Starting up of the control circuit 817 means that the first connector 81 is in a connected state.

Step S8102: The control circuit 817 refers to the monitor signal CUR1 (which indicates the level of the current flowing from the host device 51 into the power supply line 80b1) and determines whether or not the second connector 82 is connected to the client device 52. For example, the control circuit 817 may determine that the second connector 82 is not connected to the client device 52 in a case where the value of the monitor signal CUR1 is less than 5 mA, and determine that the second connector 82 is connected to the client device 52 in a case where the value of monitor signal CUR1 is greater than or equal to 5 mA.

In a case where it is determined in step S8102 that the second connector 82 is not connected to the client device 52, the control circuit 817 enters the fault test mode and carries out steps S8103 through S8107 described below. In a case where it is determined in step S8102 that the second connector 82 is connected to the client device 52, the control circuit 817 does not enter the fault test mode, and instead initializes the transmitter-receiver circuit 811 in step S8108 and then carries out normal operation in step S8109.

Step S8103: For a predetermined time period, the control circuit 817 supplies to the transmitter-receiver circuit 811 a low-frequency voltage signal having a predetermined first pulse pattern, the voltage signal being supplied as a TX_Disable signal. The transmitter-receiver circuit 811 drives the light emitting element 812 in accordance with the TX_Disable signal. In other words, when a value of the TX_Disable signal is a low level, the light emitting element 812 is on, and when the value of the TX_Disable signal is a high level, the light emitting element 812 is off. In this way, a low-frequency optical signal having the first pulse pattern is sent during a predetermined time period from the first connector 81 to the second connector 82. This optical signal is hereinafter referred to as a “first test signal”.

As will be described later, the current flowing from the power supply line 80b1 to the client device 52 being below a predetermined threshold value serves as a trigger for the second connector 82 to enter the fault test mode. Once the second connector 82 has received the first test signal in the fault test mode, the second connector 82 sends in response an optical signal having a predetermined second pulse pattern. This optical signal is hereinafter referred to as a “second test signal”. Note that the second pulse pattern may be the same pulse pattern as the first pulse pattern, or may be a pulse pattern differing from the first pulse pattern.

Step S8104: After the control circuit 817 has finished sending the first test signal, the control circuit 817 waits for a predetermined time period.

Step S8105: The control circuit 817 refers to a monitor signal IMON and determines whether or not the transmitter-receiver circuit 811 has received the second test signal. In a case where the second test signal has been received, presumably no fault (such as a break) has occurred in the first optical fiber cord 80a1 and the second optical fiber cord 80a2. In such a case, the control circuit 817 carries out step S8106 described below. However, in a case where the second test signal has not been received, presumably a fault such as a break has occurred in the first optical fiber cord 80a1 or the second optical fiber cord 80a2. In such a case, the control circuit 817 carries out step S8107 described below.

Step S8106: The control circuit 817 uses the indicator 818 to notify the user that no fault (such as a break) has occurred in the first optical fiber cord 80a1 and the second optical fiber cord 80a2. For example, the control circuit 817 turns on the indicator 818.

Step S8107: The control circuit 817 uses the indicator 818 to notify the user that a fault such as a break has occurred in the first optical fiber cord 80a1 or the second optical fiber cord 80a2. For example, the control circuit 817 causes the indicator 818 to blink on and off. In this way, an operator on a host device 51 side can easily visually determine whether a fault has occurred in the active optical cable 8, by checking whether the LED is on or blinking on and off.

Next, the following description will discuss operations of the second connector 82 with reference to FIG. 36. In a case where the first connector 81 is connected to the host device 51, the second connector 82 carries out the below-described steps (indicated in FIG. 36).

Step S8201: Once the first connector 81 is connected to the host device 51, power is supplied from the first connector 81 and via the power supply line 80b1, so that the control circuit 827 starts up. The control circuit 827 first initializes itself.

Step S8202: The control circuit 827 refers to a monitor signal VMON (which indicates a voltage of the auxiliary power supply line 84b1) and determines whether or not the auxiliary connector 83 is connected to a power supply device. For example, the control circuit 827 may determine that the auxiliary connector 83 is not connected to the power supply device in a case where value of the monitor signal VMON is less than 4.5 V, and determine that the auxiliary connector 83 is connected to the power supply device in a case where the value of the monitor signal VMON is greater than or equal to 4.5 V. Note that the threshold value to which the monitor signal VMON is compared is set to 4.5 V because in a case where the auxiliary connector 83 is connected to the power supply device, presumably the value of the monitor signal VMON will be within a range of 5 V±0.5 V. In a case where the control circuit 827 determines that the auxiliary connector 83 is connected to the power supply device, the control circuit 827 carries out step S8203 described below.

Step S8203: The control circuit 827 refers to a monitor signal CUR2 (which indicates the level of the current flowing from the power supply line 80b1 to the client device 52) and determines whether or not the second connector 82 is connected to the client device 52. For example, the control circuit 827 may determine that the second connector 82 is not connected to the client device 52 in a case where the value of the monitor signal CUR2 is less than 10 mA, and determine that the second connector 82 is connected to the client device 52 in a case where the value of monitor signal CUR2 is greater than or equal to 10 mA.

In a case where it is determined in step S8203 that the second connector 82 is not connected to the client device 52, the control circuit 827 enters the fault test mode and carries out steps S8204 through S8208 described below. In a case where it is determined in the step S8203 that the second connector 82 is connected to the client device 52, the control circuit 827 does not enter the fault test mode, and instead initializes the transmitter-receiver circuit 821 in step S8209, opens the first switch 82a in step S8210, and then carries out normal operation in step S8211.

Step S8204: The control circuit 827 closes the second switch 82b. This starts the supply of power from the power supply line 80b1 to the dummy load 820.

Step S8205: The control circuit 827 refers to the monitor signal IMON and determines whether or not the transmitter-receiver circuit 821 has received the first test signal. In a case where the first test signal has been received, presumably no fault (such as a break) has occurred in the first optical fiber cord 80a1. In such a case, the control circuit 827 carries out steps S8206 and S8207 described below. However, in a case where the first test signal has not been received, presumably a fault such as a break has occurred in the first optical fiber cord 80a1. In such a case, the control circuit 827 carries out step S8208 described below.

Step S8206: For a predetermined time period, the control circuit 827 supplies to the transmitter-receiver circuit 821 a low-frequency voltage signal having the above-described second pulse pattern, the voltage signal being supplied as a TX_Disable signal. The transmitter-receiver circuit 821 drives the light emitting element 823 in accordance with the TX_Disable signal. In other words, when a value of the TX_Disable signal is a low level, the light emitting element 823 is on, and when the value of the TX_Disable signal is a high level, the light emitting element 823 is off. In this way, a low-frequency optical signal having a second pulse pattern, i.e., the second test signal, is sent from the second connector 82 to the first connector 81 for a predetermined time period.

Step S8207: The control circuit 827 uses the indicator 828 to notify the user that no fault (such as a break) has occurred in the first optical fiber cord 80a1. For example, the control circuit 827 turns on the indicator 828 (which is an LED).

Step S8208: The control circuit 827 uses the indicator 828 to notify the user that a fault such as a break has occurred in the first optical fiber cord 80a1. For example, the control circuit 827 causes the indicator 828 (which is an LED) to blink on and off. In this way, an operator on a client device 52 side can easily visually determine whether a fault has occurred in the active optical cable 8, by checking whether the LED is on or blinking on and off.

### Further Effects of One or More Embodiments

Depending on the order of (i) connection of the first connector to the host device, (ii) connection of the second connector to the client device, and (iii) commencement of supply of power to the active optical cable, there are cases in which an initialization operation for establishing a link between the host device and the client device cannot be carried out properly with active optical cables.

For example, consider the case of an active optical cable used for communications in conformance with the USB3 protocol. A host device in conformance with the USB3 protocol repeatedly carries out an initialization operation, which includes an Rx termination detection process and an LFPS link process, until a link with the client device is established. In contrast, in some cases, a client device in conformance with the USB3 protocol carries out an initialization operation, including an Rx termination detection process and an LFPS link process, only one time immediately after supply of power has commenced.

In a case where a host device and a client device are connected with use of a USB cable employing a metal cable as a transmission medium, supply of power to the client device is commenced when the second connector of USB cable is connected to the client device after the first connector of the USB cable has already been connected to the host device. In other words, in such a case, at the point in time at which supply of power to the client device is commenced, establishment of a physical connection between the host device and the client device is guaranteed. As such, even in a case where the client device carries out an initialization operation only one time immediately after commencement of supply of power, the initialization operation for establishing a link between the host device and the client device functions as normal (i.e., is able to function under normal operations).

In contrast, in a case where a host device and a client device are connected with use of an active optical cable, it is not guaranteed that a physical connection between the host device and the client device will be established at the point in time at which supply of power to the client device is commenced. As such, in a case where the client device carries out an initialization operation only one time immediately after commencement of supply of power, the initialization operation for establishing a link between the host device and the client device may not function as normal.

For example, consider an active optical cable including (i) a first connector for connection with a host device, (ii) a second connector for connection with a client device, and (iii) an auxiliary connector for connection with a power supply device, the active optical cable being configured to supply power obtained from the power supply device to the client device. With such an active optical cable, the following cases may occur.

Case 1: The auxiliary connector is connected to the power supply device in a state where the first connector has not been connected to the host device and the second connector has not been connected to the client device. In Case 1, the initialization operation will function as normal if the second connector is connected to the client device after the first connector has been connected to the host device (Case 1A). This is because at the point in time at which the second connector is connected to the client device and supply of power to the client device is commenced, a physical connection between the host device and the client device is established. However, the initialization operation may not function as normal if the first connector is connected to the host device after the second connector has been connected to the client device (Case 1B). This is because at the point in time at which the second connector is connected to the client device and supply of power to the client device is commenced, a physical connection between the host device and the client device has not yet been established.

Case 2: The auxiliary connector is connected to the power supply device in a state where the first connector has not been connected to the host device and the second connector has been connected to the client device. The initialization operation in Case 2 may not function as normal. This is because at the point in time at which the second connector is connected to the client device and supply of power to the client device is commenced, a physical connection between the host device and the client device has not yet been established.

Case 3: The auxiliary connector is connected to the power supply device in a state where the first connector has been connected to the host device and the second connector has not been connected to the client device. The initialization operation in Case 3 may function as normal. This is because at the point in time at which the second connector is connected to the client device and supply of power to the client device is commenced, a physical connection between the host device and the client device is established.

Case 4: The auxiliary connector is connected to the power supply device in a state where the first connector has been connected to the host device and the second connector has been connected to the client device. The initialization operation in Case 4 may function as normal. This is because at the point in time at which the auxiliary connector is connected to the power supply device and supply of power to the client device is commenced, a physical connection between the host device and the client device has already been established.

As described above, the initialization operation for establishing a link between the host device and the client device in the above Case 1B or Case 2, i.e., may not function as normal in a case where the connection of the first connector to the host device is carried out last (after the second connector has been connected to the client device and the auxiliary connector has been connected to the power supply device). Using the active optical cable 8 in accordance with one or more embodiments makes it possible to address the functionality of the initialization operation. This is because the supply of power to the client device 52 is always commenced after (i) the first connector 81 has been connected to the host device 51 and (ii) initialization of the control circuit 827 has finished.

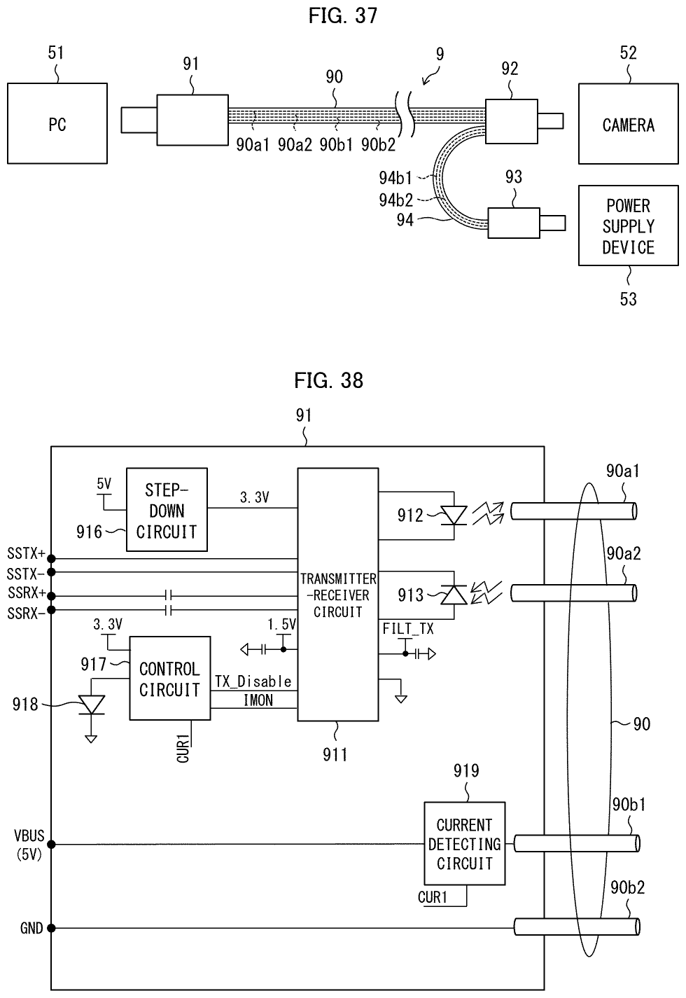

The following description will discuss an active optical cable in accordance with one or more embodiments of the present invention with reference to FIGS. 37 to 41.

Configuration of Active Optical Cable

With reference to FIG. 37, the following description will discuss a configuration of an active optical cable 9 in accordance with one or more embodiments. FIG. 37 is a block diagram illustrating a configuration of the active optical cable 9.

The active optical cable 9 is a cable for achieving bidirectional communication between two devices. The active optical cable 9 includes a composite cable 90, a first connector 91, and a second connector 92. The composite cable 90, first connector 91, and second connector 92 included in the active optical cable 9 of one or more embodiments are configured similarly to the composite cable 10, first connector 11, and second connector 12, respectively, included in the active optical cable 1 of one or more embodiments (see FIG. 1).

The active optical cable 9 further includes an auxiliary connector 93 and an auxiliary cable 94. The auxiliary connector 93 is for supplying power to a client device 52 via the second connector 92 and is connected to the second connector 92 via the auxiliary cable 94. The auxiliary connector 93 may be connected to, for example, a power supply device 53. In one or more embodiments, the auxiliary connector 93 is embodied as a Standard-A-type connector in conformance with USB standards. However, the auxiliary connector 93 need only be suitable for the power supply device 53 to which it is connected. For example, the auxiliary connector 93 may be a Micro-B-type connector in conformance with USB standards, or a connector in conformance with some standard other than USB standards.

Similarly to one or more embodiments, in one or more embodiments the auxiliary connector 93 is provided on a second connector 92 side. Such a configuration makes it possible to supply power to the client device 52 through a route that does not pass through the composite cable 90. This obviates the need to consider a voltage drop in the composite cable 90. Furthermore, because a configuration employed in which power is supplied to main circuits of the second connector 92 from the power supply device 53, it is possible to reduce the diameter of the composite cable 90 even more than one or more embodiments.

Once the first connector 91 is connected to the host device 51, supply of power from the host device 51 to the first connector 91 is commenced, and a control circuit included in the first connector 91 is initialized. Once the auxiliary connector 93 is connected to the power supply device 53, supply of power from the power supply device 53 to the second connector 92 is commenced, and a control circuit included in the second connector 92 is initialized. Operation of the active optical cable 9 is commenced by this initialization of the control circuits included in the first connector 91 and the second connector 92. In a case where, at commencement of operation of the active optical cable 9, the second connector 92 is connected to the client device 52, there is a possibility that, immediately after commencement of operation, communication will be carried out between the host device 51 and the client device 52. As such, a fault test cannot be carried out for an optical fiber cord 90a1 and an optical fiber cord 90a2 immediately after commencement of operation. The active optical cable 9 in accordance with one or more embodiments carries out a fault test for the optical fiber cord 90a1 and the optical fiber cord 90a2 only in a case where the second connector 92 is in an unconnected state at the point in time at which the first connector 91 is connected to the host device 51.

Internal Structure of First Connector

Next, with reference to FIG. 38, the following description will discuss an internal structure of the first connector 91 of the active optical cable 9 in accordance with one or more embodiments. FIG. 38 is a block diagram illustrating an internal structure of the first connector 91.

The first connector 91 includes a transmitter-receiver circuit 911, a light emitting element 912, a light receiving element 913, a step-down circuit 916, a control circuit 917, an indicator 918, and a current detecting circuit 919.

The transmitter-receiver circuit 911, light emitting element 912, light receiving element 913, step-down circuit 916, control circuit 917, and indicator 918 included in the first connector 91 are configured similarly to the transmitter-receiver circuit 111, light emitting element 112, light receiving element 113, step-down circuit 116, control circuit 117, and indicator 118, respectively, included in the first connector 11 of one or more embodiments (see FIG. 2). The current detecting circuit 919 is for detecting a current flowing into a power supply line 90b1 from the host device 51. The current detecting circuit 919 provides to the control circuit 917 a monitor signal CUR1 which indicates the level of the current thus detected. The control circuit 917 determines, based on the monitor signal CUR1, that the second connector 92 is in the fault test mode.

Note that a method for the fault test which utilizes the first connector 91 will be described below with reference to a different diagram.

Internal Structure of Second Connector

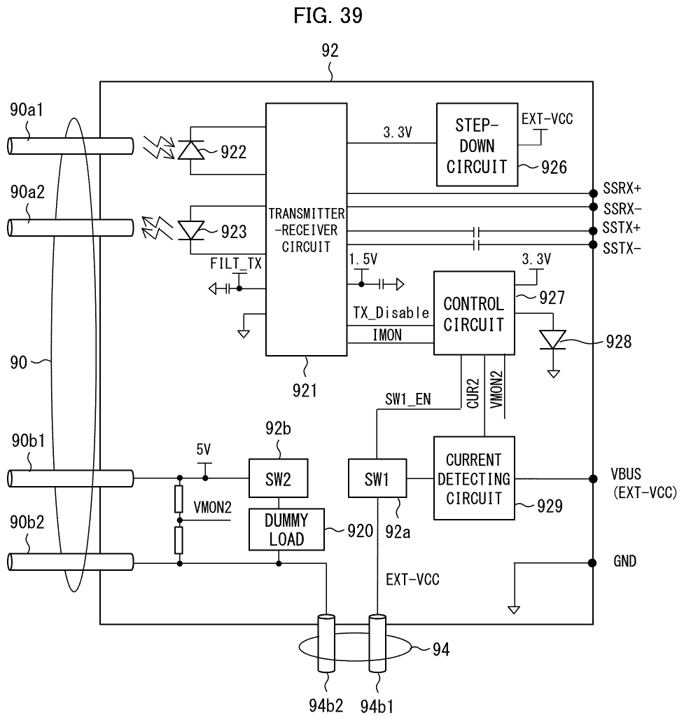

Next, with reference to FIG. 39, the following description will discuss an internal structure of the second connector 92 of the active optical cable 9 in accordance with one or more embodiments. FIG. 39 is a block diagram illustrating an internal structure of the second connector 92.

The second connector 92 includes a transmitter-receiver circuit 921, a light receiving element 922, a light emitting element 923, a step-down circuit 926, a control circuit 927, an indicator 928, a current detecting circuit 929, a first switch 92a, and a second switch 92b.

The transmitter-receiver circuit 921, light receiving element 922, light emitting element 923, step-down circuit 926, control circuit 927, and indicator 928 included in the second connector 92 are configured similarly to the transmitter-receiver circuit 121, light receiving element 122, light emitting element 123, step-down circuit 126, control circuit 127, and indicator 128, respectively, included in the second connector 12 of one or more embodiments (see FIG. 3). The current detecting circuit 929 is for detecting a current flowing from the power supply line 90b1 to the client device 52. The current detecting circuit 929 provides to the control circuit 927 a monitor signal CUR2 which indicates the level of the current thus detected. The control circuit 927 determines, based on the monitor signal CUR2, whether or not the second connector 92 is connected to the client device 52.

The first switch 92a is for allowing or cutting off supply of power to the client device 52 from an auxiliary power supply line 94b1 via a VBUS terminal. Opening and closing of the first switch 92a is controlled by the control circuit 927 with use of a control signal SW1_EN. Connection of the first connector 91 to the host device 51 serves as a trigger for the control circuit 927 to close the first switch 92a (i.e., to put the first switch 92a into an on state) so that supply of power from the auxiliary power supply line 94b1 to the client device 52 is commenced.

The second switch 92b is for allowing or cutting off supply of current to a dummy load 920 from the power supply line 90b1. Opening and closing of the second switch 92b is controlled by the control circuit 927 with use of a control signal SW2_EN (not illustrated). Connection of the second connector 92 to the client device 52 serves as a trigger for the control circuit 927 to close the second switch 92b (i.e., to put the second switch 92b into an on state) so that supply of current from the power supply line 90b1 to the dummy load 920 is commenced.

Note that a method for the fault test which utilizes the second connector 92 will be described below with reference to a different diagram.

Method of Fault Test

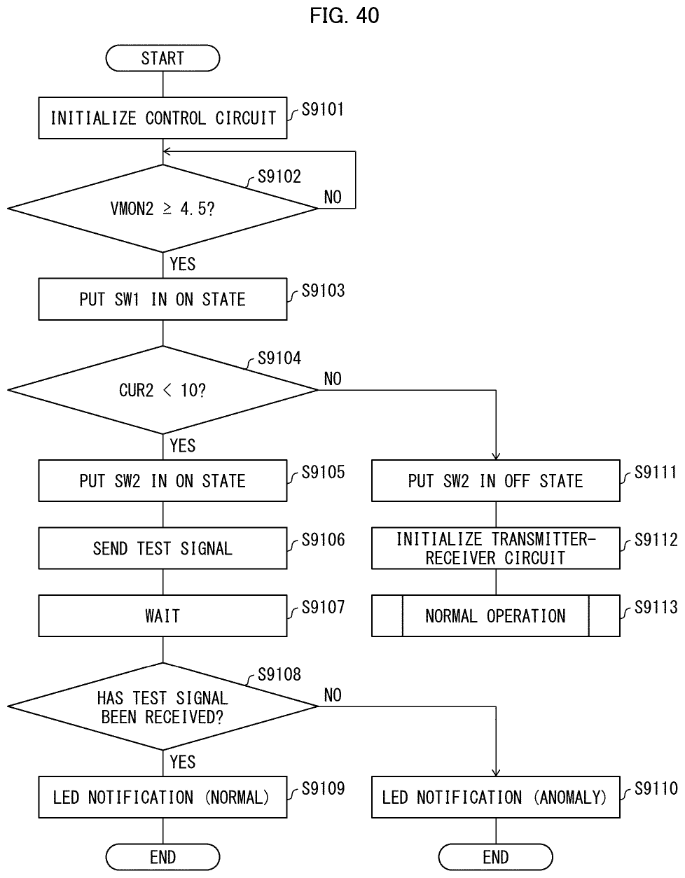

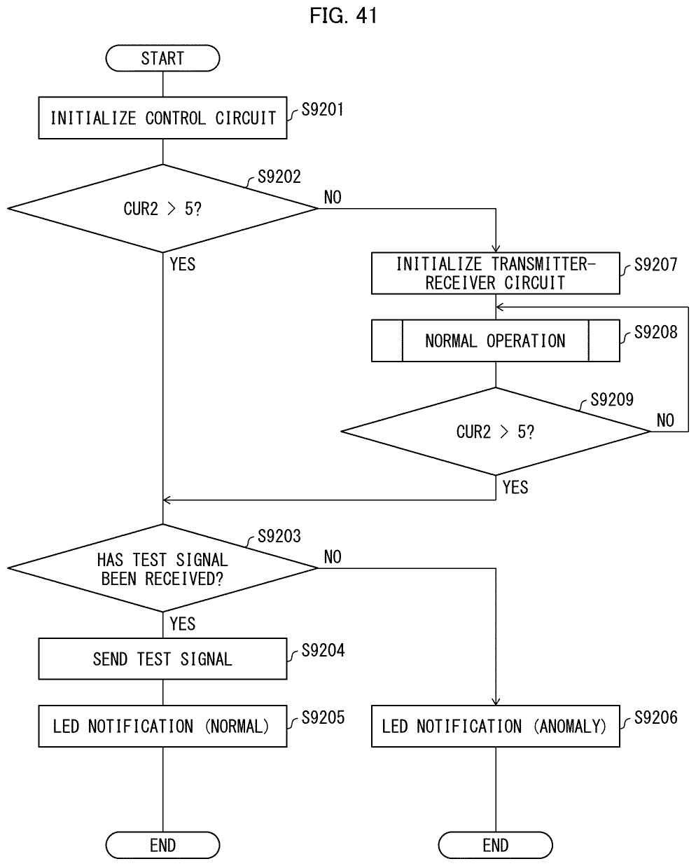

Next, with reference to FIGS. 40 and 41, the following description will discuss a fault test carried out in the active optical cable 9 of one or more embodiments immediately after the auxiliary connector 93 is connected to the power supply device 53. FIG. 40 is a flowchart indicating operations of the second connector 92 during the fault test. FIG. 41 is a flowchart indicating operations of the first connector 91 during the fault test. Note that in the active optical cable 9 in accordance with one or more embodiments, once the first connector 91 is connected to the host device 51, the voltage of the power supply line 90b1 rises. As such, the second connector 92 can determine that the first connector 91 has been connected to the host device 51 by monitoring the voltage of the power supply line 90b1. The method for a fault test described below is based on this fact.

First, operations of the second connector 92 are discussed with reference to FIG. 40. In a case where the auxiliary connector 93 is connected to the power supply device 53 and supply of power from the power supply device 53 to the second connector 92 via the auxiliary power supply line 94b1 is commenced, the second connector 92 carries out the below-described steps (indicated in FIG. 40).

Step S9101: Once the auxiliary connector 93 is connected to the power supply device 53 and supply of power from the power supply device 53 to the second connector 92 commences, the control circuit 927 starts up. The control circuit 927 first initializes itself.

Step S9102: The control circuit 927 refers to a monitor signal VMON2 (which indicates the level of the voltage of the power supply line 90b1) and determines whether or not the first connector 91 is connected to the host device 51. For example, the control circuit 927 may determine that the first connector 91 is connected to the host device 51 in a case where the value of the monitor signal VMON2 is greater than or equal to 4.5 V, and determine that the first connector 91 is not connected to the host device 51 in a case where the value of the monitor signal VMON2 is less than 4.5 V. The control circuit 927 repeats this determination until it is determined that the first connector 91 is connected to the host device 51. Once it is determined that the first connector 91 is connected to the host device 51, the control circuit 927 carries out the processes described below.

Step S9103: The control circuit 927 closes the first switch 92a. This makes it possible for current to be supplied from the power supply device 53 to the client device 52 via the auxiliary power supply line 94b1.

Step S9104: The control circuit 927 refers to a monitor signal CUR2 (which indicates the level of current supplied from the power supply device 53 to the client device 52 via the auxiliary power supply line 94b1) provided by the current detecting circuit 929 and determines whether or not the second connector 92 is connected to the client device 52. For example, the control circuit 927 may determine that the second connector 92 is not connected to the client device 52 in a case where the value of the monitor signal CUR2 is less than 10 mA, and determine that the second connector 92 is connected to the client device 52 in a case where the value of the monitor signal CUR2 is greater than or equal to 10 mA. In a case where the second connector 92 is not connected to the client device 52, the control circuit 927 enters the fault test mode and carries out steps S9105 through S9110 described below. In a case where the second connector 92 is connected to the client device 52, the control circuit 927 does not enter the fault test mode, and instead opens the second switch 92b (step S9111), initializes the transmitter-receiver circuit 921 (step S9112), and then carries out normal operation (step S9113).

Step S9105: The control circuit 927 closes the second switch 92b. This starts the supply of power from the host device 51 to the dummy load 920. As described later, the supply of power from the host device 51 to the dummy load 920 being commenced serves as a trigger for the first connector 91 to enter the fault test mode.

Step S9106: For a predetermined time period, the control circuit 927 supplies to the transmitter-receiver circuit 921 a low-frequency voltage signal having a predetermined first pulse pattern, the voltage signal being supplied as a TX_Disable signal. The transmitter-receiver circuit 921 drives the light emitting element 923 in accordance with the TX_Disable signal. In other words, when a value of the TX_Disable signal is a low level, the light emitting element 923 is on, and when the value of the TX_Disable signal is a high level, the light emitting element 923 is off. In this way, a low-frequency optical signal having the first pulse pattern is sent during a predetermined time period from the second connector 92 to the first connector 91. This optical signal is hereinafter referred to as a “first test signal”. As will be described later, once the first connector 91 has received the first test signal in the fault test mode, the first connector 91 sends in response an optical signal having a predetermined second pulse pattern. This optical signal is hereinafter referred to as a “second test signal”. Note that the second pulse pattern may be the same pulse pattern as the first pulse pattern, or may be a pulse pattern differing from the first pulse pattern.

Step S9107: After the control circuit 927 has finished sending the first test signal, the control circuit 927 waits for a predetermined time period.

Step S9108: The control circuit 927 refers to a monitor signal IMON and determines whether or not the transmitter-receiver circuit 921 has received the second test signal. In a case where the second test signal has been received, presumably no fault (such as a break) has occurred in the first optical fiber cord 90a1 and the second optical fiber cord 90a2. In such a case, the control circuit 927 carries out step S9109 described below. However, in a case where the second test signal has not been received, presumably a fault such as a break has occurred in the first optical fiber cord 90a1 or the second optical fiber cord 90a2. In such a case, the control circuit 927 carries out step S9110 described below.

Step S9109: The control circuit 927 uses the indicator 928 to notify the user that no fault (such as a break) has occurred in the first optical fiber cord 90a1 and the second optical fiber cord 90a2. For example, the control circuit 927 turns on the indicator 928.

Step S9110: The control circuit 927 uses the indicator 928 to notify the user that a fault such as a break has occurred in the first optical fiber cord 90a1 or the second optical fiber cord 90a2. For example, the control circuit 927 causes the indicator 928 to blink on and off. In this way, an operator on a client device 52 side can easily visually determine whether a fault has occurred in the active optical cable 9, by checking whether the LED is on or blinking on and off.

Next, the following description will discuss operations of the first connector 91 with reference to FIG. 41. In a case where the first connector 91 is connected to the host device 51 and the supply of power from the host device 51 to the first connector 91 has commenced, the first connector 91 carries out the below-described steps (indicated in FIG. 41).

Step S9201: Once the first connector 91 is connected to the host device 51 and the supply of power from the host device 51 to the first connector 91 commences, the control circuit 917 starts up. The control circuit 917 first initializes itself.

Step S9202: The control circuit 917 refers to the monitor signal CUR1 (which indicates the level of current supplied from the host device 51 to the second connector 92 via the power supply line 90b1) supplied by the current detecting circuit 919 and determines whether or not the second connector 92 is in the fault test mode. For example, the control circuit 917 may determine that the second connector 92 is in the fault test mode in a case where the value of the monitor signal CUR1 exceeds 5 mA, and determine that the second connector 92 is not in the fault test mode in a case where the value of the monitor signal CUR1 is less than or equal to 5 mA. In a case where the second connector 92 is in the fault test mode, the control circuit 917 also enters the fault test mode and carries out steps S9203 through S9206 described below. In a case where the second connector 92 is not in the fault test mode, the control circuit 917 initializes the transmitter-receiver circuit 911 (step S9207) and then carries out normal operation (step S9208). In a case where, during normal operation, it is detected that the second connector 92 has entered the fault test mode (“YES” in step S9209), the control circuit 917 enters the fault test mode and carries out the steps S9203 through S9206 described below.

Step S9203: The control circuit 917 refers to a monitor signal IMON and determines whether or not the transmitter-receiver circuit 911 has received the first test signal. In a case where the first test signal has been received, presumably no fault (such as a break) has occurred in the first optical fiber cord 90a1. In such a case, the control circuit 917 carries out steps S9204 and S9205 described below. However, in a case where the first test signal has not been received, presumably a fault such as a break has occurred in the first optical fiber cord 90a1. In such a case, the control circuit 917 carries out step S9206 described below.

Step S9204: For a predetermined time period, the control circuit 917 supplies to the transmitter-receiver circuit 911 a low-frequency voltage signal having the above-described second pulse pattern, the voltage signal being supplied as a TX_Disable signal. The transmitter-receiver circuit 911 drives the light emitting element 912 in accordance with the TX_Disable signal. In other words, when a value of the TX_Disable signal is a low level, the light emitting element 912 is on, and when the value of the TX_Disable signal is a high level, the light emitting element 912 is off. In this way, a low-frequency optical signal having a second pulse pattern, i.e., the second test signal, is sent from the first connector 91 to the second connector 92 for a predetermined time period.

Step S9205: The control circuit 917 uses the indicator 918 to notify the user that no fault (such as a break) has occurred in the first optical fiber cord 90a1. For example, the control circuit 917 turns on the indicator 918 (which is an LED).

Step S9206: The control circuit 917 uses the indicator 918 to notify the user that a fault such as a break has occurred in the first optical fiber cord 90a1. For example, the control circuit 917 causes the indicator 918 (which is an LED) to blink on and off. In this way, an operator on a host device 51 side can easily visually determine whether a fault has occurred in the active optical cable 9, by checking whether the LED is on or blinking on and off.

Note that the active optical cable 9 in accordance with one or more embodiments also makes it possible to address the functionality of the initialization operation in Case 1B and Case 2 as described above in the section titled “Further effects of one or more embodiments”. This is because (i) at the time point at which the auxiliary connector 93 is connected to the power supply device 53, the control circuit 827 has finished initializing and (ii) the supply of power to the client device 52 always commences after the first connector 91 has been connected to the host device 51.

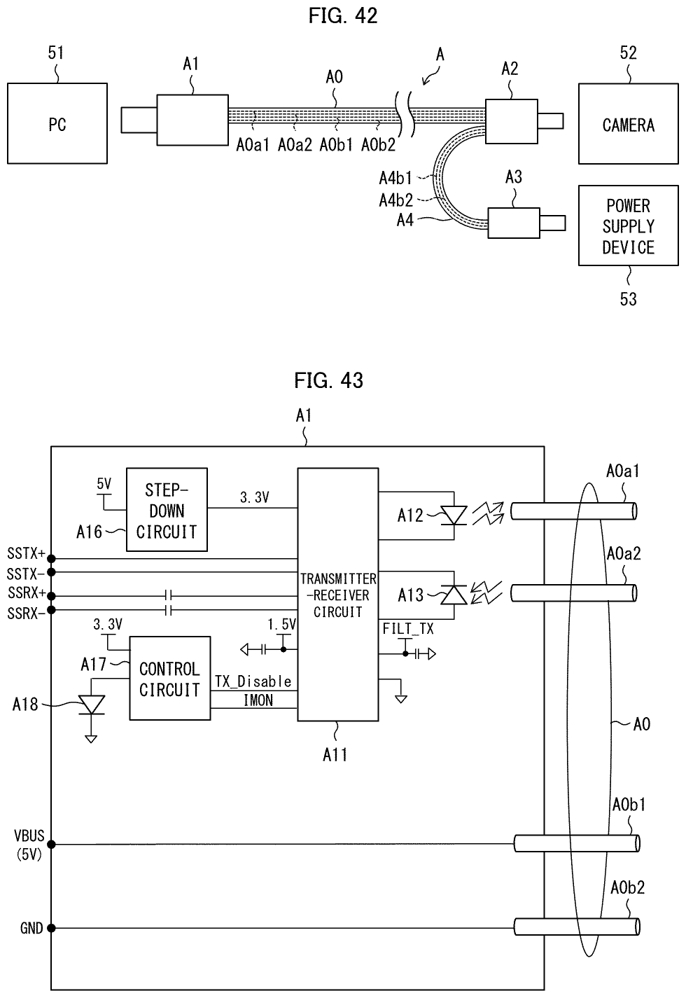

With reference to FIGS. 42 to 46, the following description will discuss an active optical cable A for one or more embodiments in the section titled “Further effects of one or more embodiments”.

Configuration of Active Optical Cable

With reference to FIG. 42, the following description will discuss a configuration of the active optical cable A in accordance with one or more embodiments. FIG. 42 is a block diagram illustrating a configuration of the active optical cable A.

The active optical cable A is a cable for achieving bidirectional communication between two devices. The active optical cable A includes a composite cable A0, a first connector A1, a second connector A2, an auxiliary connector A3 (an example of the “auxiliary connector” recited in the claims), and an auxiliary cable A4. The composite cable A0, first connector A1, second connector A2, auxiliary connector A3, and auxiliary cable A4 included in the active optical cable A of one or more embodiments are configured similarly to the composite cable 80, first connector 81, second connector 82, auxiliary connector 83, and auxiliary cable 84, respectively, included in the active optical cable 8 of one or more embodiments (see FIG. 32).

Internal Structure of First Connector

Next, with reference to FIG. 43, the following description will discuss an internal structure of the first connector A1 of the active optical cable A in accordance with one or more embodiments. FIG. 43 is a block diagram illustrating an internal structure of the first connector A1.

The first connector A1 includes a transmitter-receiver circuit A11, a light emitting element A12, a light receiving element A13, a step-down circuit A16, a control circuit A17, and an indicator A18.

The transmitter-receiver circuit A11, light emitting element A12, light receiving element A13, step-down circuit A16, control circuit A17, and indicator A18 included in the first connector A1 are configured similarly to the transmitter-receiver circuit 811, light emitting element 812, light receiving element 813, step-down circuit 816, control circuit 817, and indicator 818, respectively, included in the first connector 81 of one or more embodiments (see FIG. 33).

Note that operations of the first connector A1 will be described below with reference to a different diagram.

Internal Structure of Second Connector

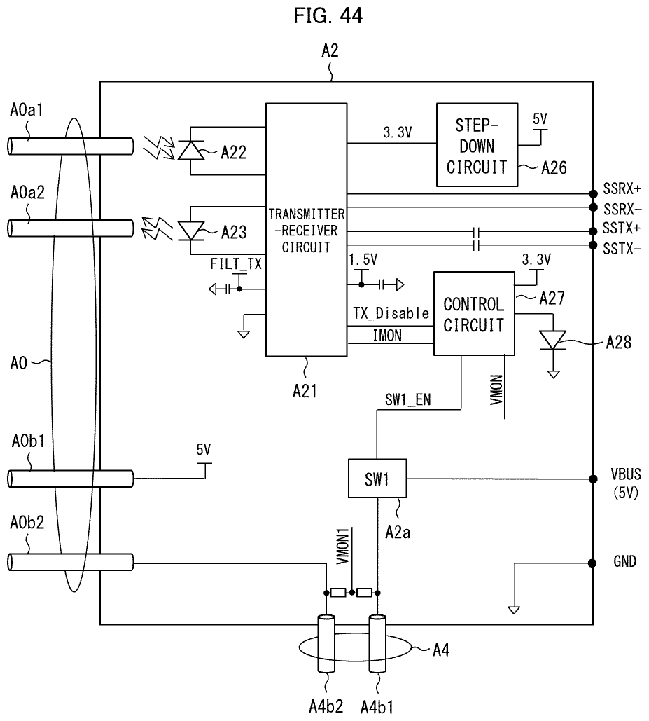

Next, with reference to FIG. 44, the following description will discuss an internal structure of the second connector A2 of the active optical cable A in accordance with one or more embodiments. FIG. 44 is a block diagram illustrating an internal structure of the second connector A2.

The second connector A2 includes a transmitter-receiver circuit A21, a light receiving element A22, a light emitting element A23, a step-down circuit A26, a control circuit A27, an indicator A28, and a switch A2a.

The transmitter-receiver circuit A21, light receiving element A22, light emitting element A23, step-down circuit A26, control circuit A27, indicator A28, and switch A2a included in the second connector A2 are configured similarly to the transmitter-receiver circuit 821, light receiving element 822, light emitting element 823, step-down circuit 826, control circuit 827, indicator 828, and first switch 82a, respectively, included in the second connector 82 of one or more embodiments (see FIG. 34).

Note that operations of the second connector A2 will be described below with reference to a different diagram.

Operations of Active Optical Cable

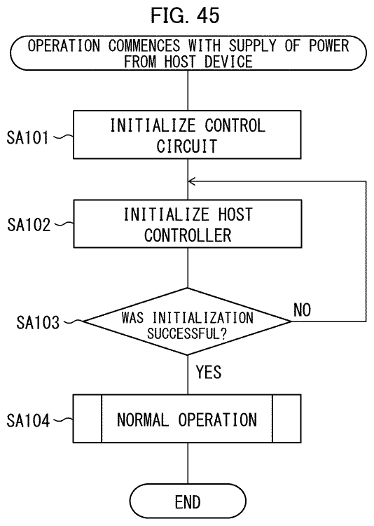

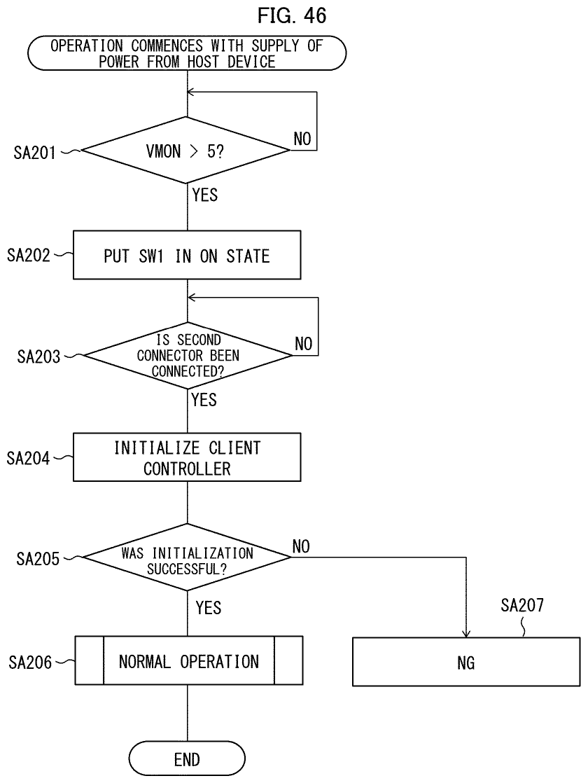

Next, with reference to FIGS. 45 and 46, the following description will discuss operations of the active optical cable A in accordance with one or more embodiments. FIG. 45 is a flowchart indicating operations of the first connector A1 and a host device 51. FIG. 46 is a flowchart indicating operations of the second connector A2 and a client device 52.

Discussed first, with reference to FIG. 45, are operations of the first connector A1 and the host device 51 which are carried out in a case where the first connector A1 is connected to the host device 51. In a case where the first connector A1 is connected to the host device 51, the first connector A1 and the host device 51 carry out the below-described steps (indicated in FIG. 45).

Step SA101: Once the first connector A1 and the host device 51 have been connected, the control circuit A17 of the first connector A1 carries out a predetermined initialization operation.

Step SA102: Once the control circuit A17 of the first connector A1 finishes the initialization operation, a controller of the host device 51 carries out a predetermined initialization operation. The initialization operation carried out by the controller of the host device 51 includes the Rx termination detection process and the LFPS link process described above.

Steps SA103 and SA104: The controller of the host device 51 waits for a predetermined signal which is sent by the client device 52 and constitutes an LFPS link sequence (step SA103). Once the controller of the host device 51 finishes receiving the predetermined signal, the controller of the host device 51 determines that the initialization operation was carried out successfully (“YES” in step SA103) and then carries out normal operation (step S104).

Next, with reference to FIG. 46, the following description will discuss operations of the second connector A2 carried out in a case where the first connector A1 and the host device 51 have been connected to each other and the supply of power from the host device 51 to the second connector A2 via the composite cable A0 has commenced. In a case where the supply of power from the host device 51 to the second connector A2 via the composite cable A0 has commenced, the second connector A2 carries out the below-described steps (indicated in FIG. 46).

Step SA201: The control circuit A27 of the second connector A2 refers to a monitor signal VMON (which indicates the voltage of an auxiliary power supply line A4b1 of the auxiliary cable A4) and determines whether or not the auxiliary connector A3 is connected to the power supply device 53. For example, the control circuit A27 of the second connector A2 may determine that the auxiliary connector A3 is not connected to the power supply device 53 in a case where the value of the monitor signal VMON is less than 4.5 V, and determine that the auxiliary connector A3 is connected to the power supply device 53 in a case where the value of the monitor signal VMON is greater than or equal to less than 4.5 V. In a case where the control circuit A27 determines that the auxiliary connector A3 is connected to the power supply device 53, the control circuit A27 carries out step SA202 described below.

Step SA202: The control circuit A27 of the second connector A2 closes the switch A2a (puts the switch A2a in an on state). This makes it possible for power to be supplied to the client device 52 once the second connector A2 is connected to the client device 52.

Steps SA203 and SA204: Once the second connector A2 and the client device 52 have been connected (“YES” in SA203), supply of power to the client device 52 is commenced. Once the supply of power to the client device 52 is commenced, a controller of the client device 52 carries out a predetermined initialization operation. The initialization operation carried out by the controller of the client device 52 includes the Rx termination detection process and the LFPS link process described above.

Steps SA205 through SA207: The controller of the client device 52 waits for a predetermined signal which is sent by the host device 51 and constitutes an LFPS link sequence (step SA205). Once the controller of the client device 52 finishes receiving the predetermined signal, the controller of the client device 52 determines that the initialization operation was carried out successfully (“YES” in step SA205) and then carries out normal operation (step SA206). In a case where the controller of the client device 52 is unable to finish receiving the predetermined signal, the controller of the client device 52 determines that the initialization operation has failed (“NO” in step S205) and carries out an operation for a no-good (NG) scenario. Examples of cases where the controller of the client device 52 determines that the initialization operation has failed include a case where the first connector A1 is removed from the host device 51 during the initialization operation. Examples of processes carried out as the operation for the NG scenario include a process for informing the user that the initialization operation has failed.

Effects of Active Optical Cable

As described above, the active optical cable A in accordance with one or more embodiments includes (i) the first connector A1 for connection with the host device 51, (ii) the second connector A2 for connection with the client device 52, and (iii) the auxiliary connector A3 for connection with the power supply device 53, the active optical cable A being configured to supply power obtained from the power supply device 53 to the client device 52. In the active optical cable A in accordance with one or more embodiments, the supply of power to the client device 52 is commenced after the first connector A1 has been connected to the host device 51 and the auxiliary connector A3 has been connected to the power supply device 53. As such, at the point in time at which the second connector A2 is connected to the client device 52 and supply of power to the client device 52 is commenced, a physical connection between the host device 51 and the client device 52 is established. As such, even in a case where the client device carries 52 out initialization only one time immediately after commencement of supply of power, the initialization operation for establishing a link between the host device 51 and the client device 52 may function as normal.

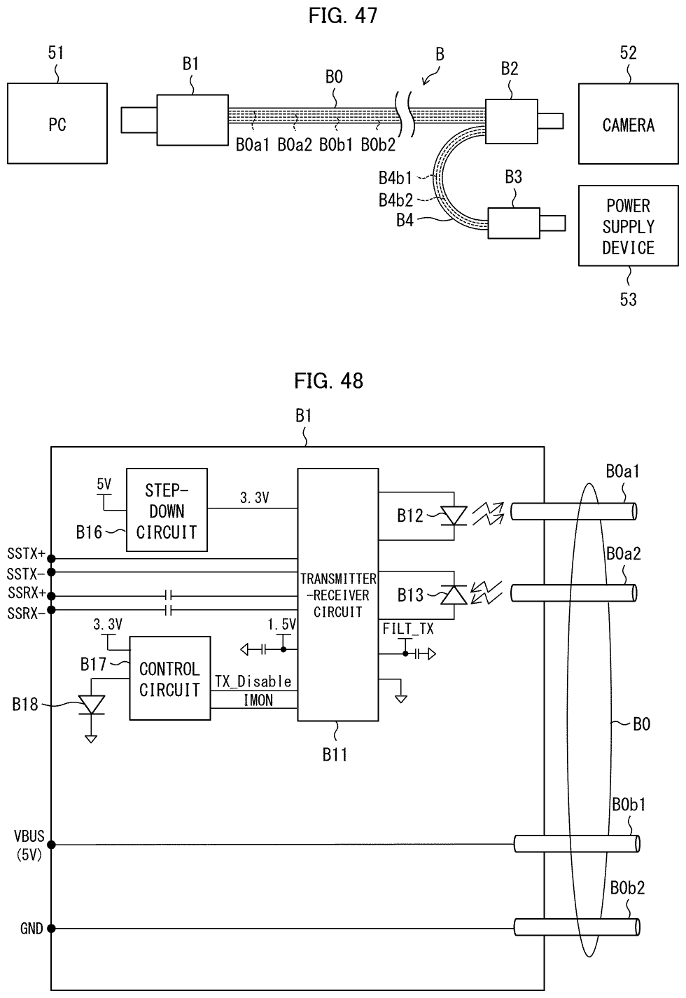

With reference to FIGS. 47 to 51, the following description will discuss an active optical cable B which is capable of addressing the functionality of the initialization operation in the section titled “Further effects of one or more embodiments”.

Configuration of Active Optical Cable

With reference to FIG. 47, the following description will discuss a configuration of the active optical cable B in accordance with one or more embodiments. FIG. 47 is a block diagram illustrating a configuration of the active optical cable B.

The active optical cable B is a cable for achieving bidirectional communication between two devices. The active optical cable B includes a composite cable B0, a first connector B1, a second connector B2, an auxiliary connector B3, and an auxiliary cable B4. The composite cable B0, first connector B1, second connector B2, auxiliary connector B3, and auxiliary cable B4 included in the active optical cable B of one or more embodiments are configured similarly to the composite cable 80, first connector 81, second connector 82, auxiliary connector 83, and auxiliary cable 84, respectively, included in the active optical cable 8 of one or more embodiments (see FIG. 32).

Internal Structure of First Connector

Next, with reference to FIG. 48, the following description will discuss an internal structure of the first connector B1 of the active optical cable B in accordance with one or more embodiments. FIG. 48 is a block diagram illustrating an internal structure of the first connector B1.

The first connector B1 includes a transmitter-receiver circuit B11, a light emitting element B12, a light receiving element B13, a step-down circuit B16, a control circuit B17, and an indicator B18.

The transmitter-receiver circuit B11, light emitting element B12, light receiving element B13, step-down circuit B16, control circuit B17, and indicator B18 included in the first connector B1 are configured similarly to the transmitter-receiver circuit 811, light emitting element 812, light receiving element 813, step-down circuit 816, control circuit 817, and indicator 818, respectively, included in the first connector 81 of one or more embodiments (see FIG. 33).

Note that operations of the first connector B1 will be described below with reference to a different diagram.

Internal Structure of Second Connector

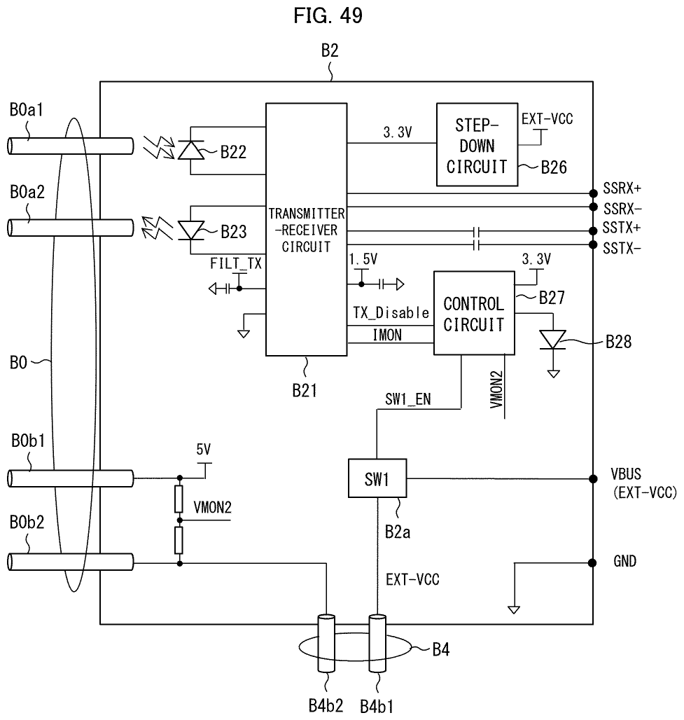

Next, with reference to FIG. 49, the following description will discuss an internal structure of the second connector B2 of the active optical cable B in accordance with one or more embodiments. FIG. 49 is a block diagram illustrating an internal structure of the second connector B2.

The second connector B2 includes a transmitter-receiver circuit B21, a light receiving element B22, a light emitting element B23, a step-down circuit B26, a control circuit B27, an indicator B28, and a switch B2a.

The transmitter-receiver circuit B21, light receiving element B22, light emitting element B23, step-down circuit B26, control circuit B27, indicator B28, and switch B2a included in the second connector B2 are configured similarly to the transmitter-receiver circuit 821, light receiving element 822, light emitting element 823, step-down circuit 826, control circuit 827, indicator 828, and first switch 82a, respectively, included in the second connector 82 of one or more embodiments (see FIG. 34). Note, however, that in the second connector 82 of one or more embodiments, power from the host device 51 is supplied to the step-down circuit 826 via the power supply line 80b1, whereas in the second connector B2 of Reference one or more embodiments, power from the power supply device 53 is supplied to the step-down circuit B26 via an auxiliary power supply line B4b1. Note also that in one or more embodiments, a power supply line B0b1 and a ground line B0b2 are used only for the purpose of supplying power to a circuit for detecting VMON2. The power supply line B0b1 and the ground line B0b2 are not used for supplying power to, for example, the transmitter-receiver circuit B21 and the control circuit B27.

Note that operations of the second connector B2 will be described below with reference to a different diagram.

Operations of Active Optical Cable

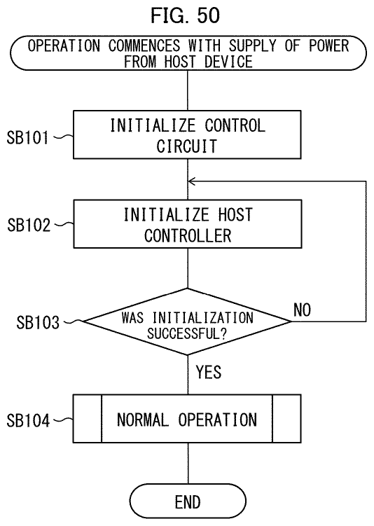

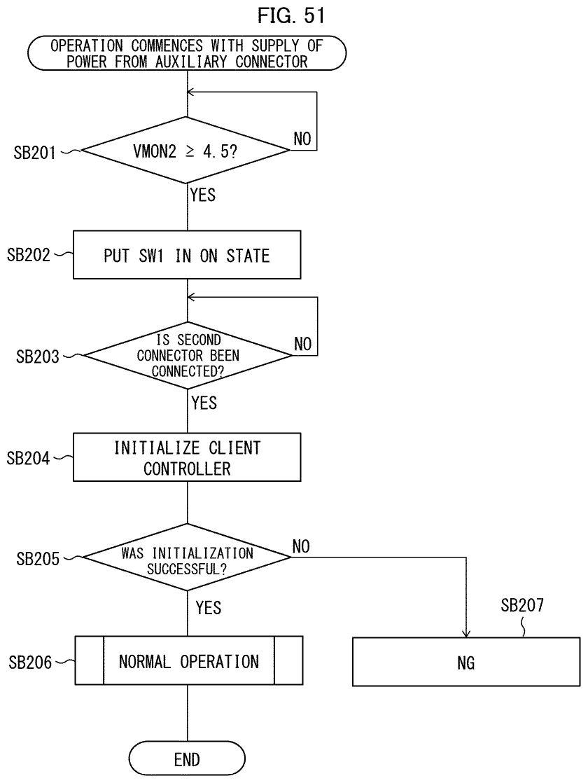

Next, with reference to FIGS. 50 and 51, the following description will discuss operations of the active optical cable B in accordance with one or more embodiments. FIG. 50 is a flowchart indicating operations of the first connector B1 and a host device 51. FIG. 51 is a flowchart indicating operations of the second connector B2 and a client device 52.

Discussed first, with reference to FIG. 50, are operations of the first connector B1 and the host device 51 which are carried out in a case where the first connector B1 is connected to the host device 51. In a case where the first connector B1 is connected to the host device 51, the first connector B1 and the host device 51 carry out the below-described steps (indicated in FIG. 50).

Step SB101: Once the first connector B1 and the host device 51 have been connected, the control circuit B17 of the first connector B1 carries out a predetermined initialization operation.

Step SB102: Once the control circuit B17 of the first connector B1 finishes the initialization operation, a controller of the host device 51 carries out a predetermined initialization operation. The initialization operation carried out by the controller of the host device 51 includes the Rx termination detection process and the LFPS link process described above.

Steps SB103 and SB104: The controller of the host device 51 waits for a predetermined signal which is sent by the client device 52 and constitutes an LFPS link sequence (step SB103). Once the controller of the host device 51 finishes receiving the predetermined signal, the controller of the host device 51 determines that the initialization operation was carried out successfully (“YES” in step SB103) and then carries out normal operation (step S104).

Next, with reference to FIG. 51, the following description will discuss operations of the second connector B2 carried out in a case where the auxiliary connector B3 and the power supply device 53 have been connected to each other and the supply of power from the power supply device 53 to the second connector B2 via the auxiliary cable B4 has commenced. In a case where the supply of power from the power supply device 53 to the second connector B2 via the auxiliary cable B4 has commenced, the second connector B2 carries out the below-described steps (indicated in FIG. 51).

Step SB201: The control circuit B27 of the second connector B2 refers to a monitor signal VMON2 (which indicates the voltage of the power supply line B0b1 of the composite cable B0) and determines whether or not the first connector B1 is connected to the host device 51. For example, the control circuit B27 of the second connector B2 may determine that the first connector B1 is not connected to the host device 51 in a case where the value of the monitor signal VMON2 is less than 4.5 V, and determine that the first connector B1 is connected to the host device 51 in a case where the value of the monitor signal VMON2 is greater than or equal to less than 4.5 V. In a case where the control circuit B27 determines that the first connector B1 is connected to the host device 51, the control circuit B27 carries out step SB202 described below.

Step SB202: The control circuit B27 of the second connector B2 closes the switch B2a (puts the switch B2a in an on state). This makes it possible for power to be supplied to the client device 52 once the second connector B2 is connected to the client device 52.

Steps SB203 and SB204: Once the second connector B2 and the client device 52 have been connected (“YES” in SB203), supply of power to the client device 52 is commenced. Once the supply of power to the client device 52 is commenced, a controller of the client device 52 carries out a predetermined initialization operation. The initialization operation carried out by the controller of the client device 52 includes the Rx termination detection process and the LFPS link process described above.

Steps SB205 through SB207: The controller of the client device 52 waits for a predetermined signal which is sent by the host device 51 and constitutes an LFPS link sequence (step SB205). Once the controller of the client device 52 finishes receiving the predetermined signal, the controller of the client device 52 determines that the initialization operation was carried out successfully (“YES” in step SB205) and then carries out normal operation (step SB206). In a case where the controller of the client device 52 is unable to finish receiving the predetermined signal, the controller of the client device 52 determines that the initialization operation has failed (“NO” in step S205) and carries out an operation for a no-good (NG) scenario. Examples of cases where the controller of the client device 52 determines that the initialization operation has failed include a case where the first connector B1 is removed from the host device 51 during the initialization operation. Examples of processes carried out as the operation for the NG scenario include a process for informing the user that the initialization operation has failed.

Effects of Active Optical Cable

As described above, the active optical cable B in accordance with one or more embodiments includes (i) the first connector B1 for connection with the host device 51, (ii) the second connector B2 for connection with the client device 52, and (iii) the auxiliary connector B3 for connection with the power supply device 53, the active optical cable B being configured to supply power obtained from the power supply device 53 to the client device 52. In the active optical cable B in accordance with one or more embodiments, the supply of power to the client device 52 is commenced after the first connector B1 has been connected to the host device 51 and the auxiliary connector B3 has been connected to the power supply device 53. As such, at the point in time at which the second connector B2 is connected to the client device 52 and supply of power to the client device 52 is commenced, a physical connection between the host device 51 and the client device 52 is established. As such, even in a case where the client device carries 52 out initialization only one time immediately after commencement of supply of power, the initialization operation for establishing a link between the host device 51 and the client device 52 may function as normal.

Software Implementation Example

Control circuits included in the respective connectors of the foregoing embodiments can each be realized by a logic circuit (hardware) provided in an integrated circuit (IC chip) or the like or can be alternatively realized by software as executed by a central processing unit (CPU).

In the latter case, each connector includes a CPU that executes instructions of a program that is software realizing the foregoing functions; a read only memory (ROM) or a storage device (each referred to as “storage medium”) in which the program and various kinds of data are stored so as to be readable by a computer (or a CPU); and a random access memory (RAM) in which the program is loaded. One or more embodiments of the present invention can be achieved by a computer (or a CPU) reading and executing the program stored in the storage medium. Examples of the storage medium encompass a “non-transitory tangible medium” such as a tape, a disk, a card, a semiconductor memory, and a programmable logic circuit. The program can be made available to the computer via any transmission medium (such as a communication network or a broadcast wave) which allows the program to be transmitted. Note that one or more embodiments of the present invention can also be achieved in the form of a computer data signal in which the program is embodied via electronic transmission and which is embedded in a carrier wave.

One or more embodiments of the present invention can also be expressed as follows:

An active optical cable in accordance with the foregoing embodiments includes: a first connector; a second connector; an optical fiber cord which connects the first connector to the second connector, the optical fiber cord being for communication; and a power supply line which connects the first connector to the second connector, the power supply line being for supplying power, the first connector including a control circuit configured to carry out a fault test in a case where the first connector or the second connector is in an unconnected state at a time point of commencement of supply of power to the first connector and the second connector.

A control method in accordance with the foregoing embodiments is a method of controlling an active optical cable including (i) a first connector, (ii) a second connector, (iii) an optical fiber cord which connects the first connector to the second connector, the optical fiber cord being for communication, and (iv) a power supply line which connects the first connector to the second connector, the power supply line being for supplying power, the method including: a control step in which the first connector carries out a fault test in a case where the first connector or the second connector is in an unconnected state at a time point of commencement of supply of power to the first connector and the second connector.

With the above configuration, the fault test is carried out at a point in time at which the either first connector or the second connector has not yet been connected to a respective device, i.e., before wiring is finished. As such, as compared to conventional techniques, the above configuration requires less time and effort for removing the cable in a case where it is determined that there is a fault such as a break in the optical fiber cord. In actuality, conventional active optical cables require removing both the first connector and the second connector from their respective devices. The above configuration, however, obviates the need to remove whichever of the first connector and the second connector is in an unconnected state at the point in time at which the fault test is carried out.

Furthermore, with the above configuration, the fault test is carried out at a point in time at which either the first connector or the second connector has not been connected to a respective device, i.e., at a point in time at which there is no possibility that the optical fiber cord will be used for communication. As such, the above configuration makes it possible to simplify the structure of the first connector and the second connector as compared to conventional connectors, because there is no need to employ in the first connector and second connector components for multiplexing an optical signal for the fault test into an optical signal for communication.

An active optical cable in accordance with the foregoing embodiments is arranged to further include: an auxiliary connector; and an auxiliary power supply line which connects the first connector to the auxiliary connector, the auxiliary power supply line being for supplying power, the supply of power to the first connector and the second connector being carried out from a device after the first connector or the auxiliary connector has been connected to the device.

With the above configuration, the active optical cable including the auxiliary connector and the auxiliary power supply line carries out the fault test in (1) a case where, at a point in time at which the first connector is connected to a respective device so that supply of power to the first connector and the second connector is commenced, the second connector has not yet been connected to a respective device, or (2) a case where, at a point in time at which the auxiliary connector is connected to a respective device so that supply of power to the first connector and the second connector is commenced, either the first connector or the second connector has not yet been connected to a respective device. As such, as compared to conventional techniques, the above configuration requires less time and effort for removing the cable in a case where it is determined that there is a fault such as a break in the optical fiber cord. In actuality, conventional active optical cables having an auxiliary connector require removing the first connector, the second connector, and the auxiliary connector from their respective devices. The above configuration, however, obviates the need to remove whichever of the first connector and the second connector is in an unconnected state at the point in time at which the fault test is carried out.

An active optical cable in accordance with the foregoing embodiments is arranged such that the control circuit is configured to carry out the fault test in a case where the first connector is in an unconnected state at a time point of commencement of the supply of power from the device to the first connector and the second connector, after the auxiliary connector has been connected to the device.

The above configuration makes it possible to achieve an active optical cable in which the fault test is carried out before the first connector is connected to a respective device. The above configuration also makes it possible to achieve an active optical cable which makes it possible to more easily determine whether or not the first connector is in an unconnected state. This is because it is the first connector which includes the control circuit and which is subjected to determination of state of connection.

An active optical cable in accordance with the foregoing embodiments is arranged such that the control circuit is configured to determine, based on a voltage of a power supply terminal of the first connector, whether or not the first connector is in an unconnected state.

Once the first connector is connected to a respective device, the voltage of the power supply terminal of the first connector rises. As such, the above configuration makes it possible to effectively determine whether or not the first connector is in an unconnected state.

An active optical cable in accordance with the foregoing embodiments is arranged such that the control circuit is configured to carry out the fault test in a case where the second connector is in an unconnected state at a time point of commencement of the supply of power from the device to the first connector and the second connector, after the first connector or the auxiliary connector has been connected to the device.

The above configuration makes it possible to achieve an active optical cable in which the fault test is carried out before the second connector is connected to a respective device.

An active optical cable in accordance with the foregoing embodiments is arranged such that the control circuit is configured to determine, based on a current flowing out from the first connector and through the power supply line, whether or not the second connector is in an unconnected state.

In a case where the second connector is connected to a respective device, there is an increase in the current flowing out from the first connector and through the power supply line. As such, the above configuration makes it possible to effectively determine whether or not the second connector is in an unconnected state.

Note that an active optical cable in accordance with the foregoing embodiments may employ a configuration in which the control circuit carries out the fault test in a case where both the first connector and the second connector are in an unconnected state at a time point of commencement of supply of power via the auxiliary connector to the first connector and the second connector. Such a configuration makes it possible to achieve an active optical cable in which the fault test is carried out before the first connector and the second connector have been connected to respective devices. When such a configuration is employed, the control circuit (i) determines, based on a voltage of a power supply terminal of the first connector, whether or not the first connector is in an unconnected state and (ii) determines, based on a current flowing out from the first connector and through the power supply line, whether or not the second connector is in an unconnected state. This makes it possible to effectively determine whether or not both the first connector and the second connector are in an unconnected state.

An active optical cable in accordance with the foregoing embodiments is arranged such that the control circuit is configured such that before the first connector begins sending a test signal for the fault test, the control circuit changes a voltage applied to the power supply line.

The above configuration makes it possible for the second connector to identify when the first connector commences sending the test signal to the second connector by monitoring the voltage of the power supply line. Furthermore, because the voltage of the power supply line can be monitored by a simple structure (for example, a comparator), it is possible to easily provide in the second connector a structure for identifying when the sending of the test signal is commenced.

An active optical cable in accordance with the foregoing embodiments is arranged such that the control circuit is configured such that after the first connector has finished sending a test signal for the fault test, the control circuit changes a voltage applied to the power supply line.

The above configuration makes it possible for the second connector to identify when the first connector finishes sending the test signal to the second connector by monitoring the voltage of the power supply line. Furthermore, because the voltage of the power supply line can be monitored by a simple structure (for example, a comparator), it is possible to easily provide in the second connector a structure for identifying when the sending of the test signal is finished.

An active optical cable in accordance with the foregoing embodiments is arranged such that the first connector includes an indicator for providing notification of a result of the fault test.

The above configuration allows a user on a first connector side to easily ascertain the result of the fault test.

An active optical cable in accordance with the foregoing embodiments is arranged such that the second connector includes an indicator for providing notification of a status of the fault test.

The above configuration allows a user on a second connector side to easily ascertain the status of the fault test. Furthermore, the above configuration allows a user on a second connector side to easily ascertain that the first connector (on an opposite end from the second connector whose indicator is providing notification) is operating. Here, “the first connector is operating” refers to, for example, a state in which power is being supplied to the first connector and the first connector is carrying out the fault test. Note “the first connector is operating” does not necessarily require that the first connector has been connected to the host device and is sending/receiving a data signal.

An active optical cable in accordance with the foregoing embodiments is arranged such that: the control circuit of the first connector is configured to send to the second connector a first test signal for the fault test; the second connector includes a control circuit configured to send a second test signal to the first connector in response to receiving the first test signal; and the control circuit of the first test signal is configured to determine, after sending the first test signal, whether or not the control circuit of the first connector has received the second test signal.

With the above configuration, the control circuit of the first connector is able to determine whether or not a fault has occurred in (i) a communication path from the first connector to the second connector (the transmitter circuit and light emitting element of the first connector; the optical fiber cord connecting the first connector and the second connector; and the light receiving element and receiver circuit of the second connector) and (ii) a communication path from the second connector to the first connector (the transmitter circuit and light emitting element of the second connector; the optical fiber cord connecting the second connector and the first connector; and the light receiving element and receiver circuit of the first connector). Such a configuration is particularly useful in a case where the active optical cable in accordance with the foregoing embodiments is configured to carry out bidirectional communication between the first connector and the second connector.

An active optical cable in accordance with the foregoing embodiments is arranged such that: the control circuit of the first connector is configured to send to the second connector a first test signal for the fault test; the second connector includes (i) a dummy load and (ii) a control circuit configured to control, in accordance with receipt of the first test signal, whether or not to allow current to flow from the power supply line to the dummy load; and the control circuit of the first connector is configured to determine, after sending the first test signal, whether or not there has been a change in the current flowing through the power supply line.

With the above configuration, the control circuit of the first connector is able to determine whether or not a fault has occurred in a communication path from the first connector to the second connector (the transmitter circuit and light emitting element of the first connector; the optical fiber cord connecting the first connector and the second connector; and the light receiving element and receiver circuit of the second connector). Such a configuration is particularly useful in a case where the active optical cable in accordance with the foregoing embodiments is configured to carry out unidirectional communication from the first connector to the second connector.

An active optical cable in accordance with the foregoing embodiments is arranged such that the second connector includes a control circuit configured to determine, based on a level of current flowing from the power supply line, whether or not the second connector is in an unconnected state.

With the above configuration, in a case where power is supplied via the power supply line to a device to which the second connector is connected, the second connector can appropriately determine, based on whether or not the second connector is in an unconnected state, whether or not to carry out a process for the fault test (for example, sending a test signal).

An active optical cable in accordance with the foregoing embodiments further includes: a second auxiliary connector; and a second auxiliary power supply line which connects the second connector to the second auxiliary connector, the second auxiliary power supply line being for supplying power, the second connector including a control circuit configured to determine, based on a level of current flowing from the second auxiliary power supply line, whether or not the second connector is in an unconnected state.

With the above configuration, in a case where power is supplied via the second auxiliary power supply line to a device to which the second connector is connected, the second connector can appropriately determine, based on whether or not the second connector is in an unconnected state, whether or not to carry out a process for the fault test (for example, sending a test signal).

An active optical cable in accordance with the foregoing embodiments is arranged such that the second connector is configured to commence supply of power from the second auxiliary power supply line to a client device after the first connector has been connected to a host device and the second auxiliary connector has been connected to the client device.

With the above configuration, supply of power to a client device via the auxiliary power supply line is commenced after the first connector has been connected to a host device and the second connector has been connected to the client device. This makes it possible to carry out initialization operations regardless of the order of connection, even in a case where the client device is configured to carry out an initialization operation for establishing a link with the host device only once, immediately after the supply of power is commenced.

A method of wiring for active optical cables in accordance with the foregoing embodiments is a method which utilizes a plurality of active optical cables each having an indicator provided to a first connector or a second connector of that active optical cable, the method including: a first step of laying the plurality of active optical cables between a first area and a second area; a second step of commencing supply of power, in the first area, to one of the plurality of active optical cables; and a third step of identifying, in the second area, whichever one the plurality of active optical cables has a first connector or a second connector whose indicator is providing the notification, the second and third steps being repeated for each one of the plurality of active optical cables for which supply of power has not yet been commenced.

In a case where a plurality of active optical cables is being laid, the above method makes it possible for a user on a first connector side or a second connector side to (i) easily identify the active optical cable whose connector on the opposite end is operating, and (ii) easily select a connector which should be connected to a device.

Additional Remarks

The present invention is not limited to the foregoing embodiments, but can be altered by a skilled person in the art within the scope of the claims. The present invention also encompasses, in its technical scope, any embodiment derived by combining technical means disclosed in differing embodiments.

### REFERENCE SIGNS LIST

1, 2, 3, 7, 8, 9, A, B: Active optical cable
10, 20, 30, 70, 80, 90, A0, B0: Composite cable
10a1, 20a1, 70a1, 80a1, 90a1, A0a1, B0a1: First optical fiber cord
10a2, 20a2, 70a2, 80a2, 90a2, A0a2, B0a2: Second optical fiber cord
30a1, 30a2, 30a3, 30a4: Optical fiber cord
10b1, 20b1, 30b1, 70b1, 80b1, 90b1, A0b1, B0b1: Power supply line
10b2, 20b2, 30b2, 70b2, 80b2, 90b2, A0b2, B0b2: Ground line
11, 21, 31, 71, 81, A1, B1: First connector
111, 211, 711, 811, 911, A11, B11: Transmitter-receiver circuit
112, 212, 312, 712, 812, 912, A12, B12: Light emitting element
113, 213, 713, 813, 913, A13, B13: Light receiving element
114, 214: Current balance controller
115, 215, 313: Booster circuit
116, 216, 716, 816, 916, A16, B16: Step-down circuit
117, 217, 314, 717, 817, 917, A17, B17: Control circuit
118, 218, 315, 718, 818, 918, A18, B18: Indicator
119, 219, 316, 719, 819, 919: Current detecting circuit
210: Switch
12, 22, 32, 72, 82, 92, A2, B2: Second connector
121, 221, 721, 821, 921, A21, B21: Transmitter-receiver circuit
122, 222, 322, 722, 822, 922, A22, B22: Light receiving element
123, 223, 723, 823, 923, A23, B23: Light emitting element
124, 224, 323: Step-down circuit
125, 225: Current limiter
126, 226, 726, 826, 926, A26, B26: Step-down circuit
127, 227, 324, 727, 827, 927, A27, B27: Control circuit
128, 228, 325, 728, 828, 928, A28, B28: Indicator
220, 328, A2a, B2a: Switch
82a, 92a: First switch
82b, 92b: Second switch
311: Transmitter circuit
321: Receiver circuit
326: Voltage detecting circuit
327, 820, 920: Dummy load
13, 23: Auxiliary connector (first auxiliary connector)
83, 93: Auxiliary connector (second auxiliary connector)
A3, B3: Auxiliary connector
14, 24, 84, 94, A4, B4: Auxiliary cable
14b1, 24b1: Auxiliary power supply line (first auxiliary power supply line)
84b1, 94b1: Auxiliary power supply line (second auxiliary power supply line)
A4b1, B4b1: Auxiliary power supply line
14b2, 24b2, 84b2, 94b2, A4b2, B4b2: Auxiliary ground line

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

1. An active optical cable comprising:
a first connector;
a second connector;
an optical fiber cord that connects the first connector to the second connector; and
a power supply line that connects the first connector to the second connector, wherein
the first connector comprises a control circuit that carries out a fault test for the optical fiber cord when the first connector or the second connector is in an unconnected state at a time point of commencement of supply of power to the first connector and the second connector.

2. The active optical cable according to claim 1, further comprising:
a first auxiliary connector; and
a first auxiliary power supply line that connects the first connector to the first auxiliary connector, wherein
the supply of power to the first connector and the second connector is carried out from a device after the first connector or the first auxiliary connector has been connected to the device.

3. The active optical cable according to claim 2, wherein the control circuit carries out the fault test when the first connector is in the unconnected state at the time point of commencement of the supply of power from the device to the first connector and the second connector, after the first auxiliary connector has been connected to the device.

4. The active optical cable according to claim 3, wherein the control circuit determines, based on a voltage of a power supply terminal of the first connector, whether the first connector is in the unconnected state.

5. The active optical cable according to claim 2, wherein the control circuit carries out the fault test when the second connector is in the unconnected state at the time point of commencement of the supply of power from the device to the first connector and the second connector, after the first connector or the first auxiliary connector has been connected to the device.

6. The active optical cable according to claim 5, wherein the control circuit determines, based on a current flowing out from the first connector and through the power supply line, whether the second connector is in the unconnected state.

7. The active optical cable according to claim 1, wherein the control circuit, before the first connector begins sending a test signal for the fault test, changes a voltage applied to the power supply line.

8. The active optical cable according to claim 1, wherein the control circuit, after the first connector has finished sending a test signal for the fault test, changes a voltage applied to the power supply line.

9. The active optical cable according to claim 1, wherein the first connector comprises an indicator that provides notification of a result of the fault test.

10. The active optical cable according to claim 1, wherein the second connector comprises an indicator that provides notification of a status of the fault test.

11. The active optical cable according to claim 1, wherein:
the control circuit of the first connector sends to the second connector a first test signal for the fault test,
the second connector includes a control circuit that sends a second test signal to the first connector in response to receiving the first test signal, and
the control circuit of the first connector determines, after sending the first test signal, whether the control circuit of the first connector has received the second test signal.

12. The active optical cable according to claim 1, wherein:
the control circuit of the first connector sends to the second connector a first test signal for the fault test,
the second connector comprises:
a dummy load; and
a control circuit that controls, in accordance with receipt of the first test signal, whether to allow current to flow from the power supply line to the dummy load, and
the control circuit of the first connector determines, after sending the first test signal, whether there has been a change in the current flowing through the power supply line.

13. The active optical cable according to claim 1, wherein the second connector comprises a control circuit that determines, based on a level of current flowing from the power supply line, whether the second connector is in the unconnected state.

14. The active optical cable according to claim 1, further comprising:
a second auxiliary connector; and
a second auxiliary power supply line that connects the second connector to the second auxiliary connector, wherein
the second connector comprises a control circuit that determines, based on a level of current flowing from the second auxiliary power supply line, whether the second connector is in the unconnected state.

15. The active optical cable according to claim 14, wherein the second connector commences the supply of power from the second auxiliary power supply line to a client device after the first connector has been connected to a host device and the second auxiliary connector has been connected to the client device.

16. A method of controlling an active optical cable that comprises a first connector, a second connector, an optical fiber cord that connects the first connector to the second connector, and a power supply line that connects the first connector to the second connector, the method comprising:
controlling the first connector to carry out a fault test for the optical fiber cord when the first connector or the second connector is in an unconnected state at a time point of commencement of supply of power to the first connector and the second connector.

17. A method of wiring for active optical cables that utilizes a plurality of active optical cables each of which is the active optical cable according to claim 9, the method comprising:
a first step of laying the plurality of active optical cables between a first area and a second area;
a second step of commencing the supply of power, in the first area, to one of the plurality of active optical cables; and
a third step of identifying, in the second area, whichever one of the plurality of active optical cables that has a first connector or a second connector whose indicator is providing the notification, wherein
the second step and the third step are repeated for each one of the plurality of active optical cables for which the supply of power has not yet been commenced.

18. An active optical cable comprising:
a first connector;
a second connector;
an optical fiber cord that connects the first connector to the second connector;
a power supply line that connects the first connector to the second connector;
an auxiliary connector; and
an auxiliary power supply line that connects the second connector to the auxiliary connector, wherein
the second connector comprises a control circuit that commences supply of power to a client device via the auxiliary power supply line after the first connector has been connected to a host device and the second connector has been connected to the client device.
